(19) United States
(12) Patent Application Publication
(10) Pub. No.: US 2026/0216648 A1
(43) Pub. Date: Jul. 30, 2026

(54) REDUCING THE CONTENT OF NOX AND N2O IN THE OFFGAS FROM FIRING PLANTS OPERATED WITH NH3 FOR CATALYTIC DECOMPOSITION OF NH3

(71) Applicants: THYSSENKRUPP AG, Essen (DE); THYSSENKRUPP UHDE GMBH, Dortmund (DE)

(72) Inventors: Michael GROVES, Gevelsberg (DE); Meinhard SCHWEFER, Meschede (DE); Alexander KLEYENSTEIBER, Wickede (Ruhr) (DE); Stefan PINNOW, Elsdorf (DE); Rolf SIEFERT, Rheda-Wiedenbrück (DE)

(21) Appl. No.: 19/141,937

(22) PCT Filed: Dec. 22, 2023
(86) PCT No.: PCT/EP2023/087681

§ 371 Date: Jun. 20, 2025

(30) Foreign Application Priority Data
Dec. 23, 2022 (EP) 22216421.2
Mar. 29, 2023 (EP) 23165192.8
Jul. 13, 2023 (DE) 10 2023 118 563.2

(51) Int. Cl. B01D 53/86; B01D 53/90; C01B 3/047

(52) U.S. Cl. CPC B01D 53/869; B01D 53/8628; B01D 53/8631; B01D 53/8696; B01D 53/90; C01B 3/047; B01D 2251/204; B01D 2251/2062; B01D 2251/208; B01D 2255/50; B01D 2256/10; B01D 2256/16; B01D 2257/402; B01D 2257/404; B01D 2258/0283; B01D 2259/122; C01B 2203/0277; C01B 2203/0883; C01B 2203/1058; C01B 2203/1082

(57) ABSTRACT

The invention relates to reduction of the content of NO_{X} and N₂O in the offgas (flue gas) of an NH₃-operated firing system integrated into a system for catalytic decomposition of NH₃ to N₂ and H₂. For this purpose, the firing system preferably comprises a combustion device in which NH₃ is combusted to generate heat of combustion, and an NH₃ decomposition device which is in heat exchange with the combustion device and in which NH₃ is decomposed catalytically to N₂ and H₂. The heat required for the catalytic decomposition of NH₃ in the NH₃ decomposition device is provided by the combustion of NH₃ in the combustion device. The combustion device preferably comprises at least a burner and a combustion chamber. The firing system is preferably configured analogously to a primary reformer.

Priorities are claimed from European patent application No. 22 216 421.2, filed Dec. 23, 2022, from European patent application No. 23 165 192.8, filed Mar. 29, 2023, and from German patent application No. 10 2023 118 563.2, filed Jul. 13, 2023.

The invention relates to reduction of the content of NO_{X} and N₂O in the offgas (flue gas) of an NH₃-operated firing system integrated into a system for catalytic decomposition of NH₃ to N₂ and H₂. For this purpose, the firing system preferably comprises a combustion device in which NH₃ is combusted to generate heat of combustion, and an NH₃ decomposition device which is in heat exchange with the combustion device and in which NH₃ is decomposed catalytically to N₂ and H₂. The heat required for the catalytic decomposition of NH₃ in the NH₃ decomposition device is provided by the combustion of NH₃ in the combustion device. The combustion device preferably comprises at least a burner and a combustion chamber. The firing system is preferably configured analogously to a primary reformer.

H₂ can be obtained from H₂O by means of renewable energies and then converted with N₂ to NH₃. NH₃ can be stored and transported much more safely than H₂. NH₃ can then be broken down again to H₂ and N₂. After being separated from N₂, H₂ finds a wide range of industrial applications.

The decomposition of NH₃ to N₂ and H₂ is an endothermic reaction (ΔH°=45.9 kJ·mol⁻¹) in which the molar amount is doubled (2 NH₃↔N₂+3 H₂), and so the reaction is fundamentally favored by high temperatures and low pressures. The higher the pressure, the higher the temperature must be in order to achieve satisfactory reaction yields. A multitude of materials have been proposed as catalysts for the decomposition of NH₃, which are active at different temperatures (cf, for example, Il. Lucentini et al., Ind. Eng. Chem. Res. 2021, 60, 18560-18611).

The catalytic decomposition of NH₃ affords a product gas containing H₂ in a mixture with N₂ and possibly other gaseous components, e.g. undecomposed NH₃. However, many industrial applications require H₂ in high purity, and so purification of the product gas is required before H₂ can be delivered to industrial applications. While the cleaning of H₂ is fundamentally possible via various methods, e.g. cryogenic methods of membrane methods, cleaning by pressure swing adsorption is particularly economically viable on an industrial scale.

The catalytic decomposition of NH₃ to N₂ and H₂ takes place at high temperature and moderate pressure in the gas phase. Stored NH₃ is in liquid form in refrigerated tanks, at atmospheric pressure and −32.8° C. A pump is used to feed NH₃ into the system at system pressure. The elevated system pressure causes the boiling point of the NH₃ to rise, for example to about 62.2° C. at 27.8 bara. In order to convert NH₃ to the gas phase, evaporation of the NH₃ requires the supply of heat.

Conventional processes for catalytic decomposition of NH₃ generate considerable amounts of heat, which can be used to evaporate NH₃.

U.S. Pat. No. 4,704,267 A relates to the production of high-purity H₂ from liquid anhydrous NH₃. NH₃ is evaporated and then split into its constituents. The resulting dissociated gas stream is fed to an adiabatic metal hydride cleaning unit in order to absorb the H₂ present in the stream. The adsorbed H₂ is then recovered as a high-purity product.

FR 1 469 045 A relates to an apparatus consisting of a preheater fed with NH₃, a shell-and-tube system enclosing a catalyst for cracking of NH₃, and optionally a cell for cleaning of H₂ by diffusion, which are connected to each other and are present in a single housing that contains heating means.

CN 111 957 270 A relates to an NH₃ decomposition apparatus comprising an NH₃ decomposition unit and a combustion unit that acts on the NH₃ decomposition unit. NH₃ enters the NH₃ decomposition unit via a first inlet for purified gas in order to perform a decomposition reaction of the NH₃.

Mixed gas produced is discharged via a second outlet for purified gas and then enters the combustion unit via a second inlet for purified gas. The mixed gas comprises N₂, H₂ and undecomposed NH₃. The mixed gas enters the combustion unit in order to provide heat for the decomposition reaction of the NH₃ in the NH₃ decomposition unit, so as to achieve self-sufficiency with heat in the H₂ production system by NH₃ decomposition. No additional fuel is required for energy supply, and the costs of the H₂ production system by NH₃ decomposition are reduced.

CN 113 896 168 A relates to a process for producing H₂ or reducing gas by cracking NH₃ by a two-stage process comprising the following steps: The liquid NH₃ in the raw material is fully gasified and heated by a heat exchange gasification system, and then enters a heat-exchanging NH₃ cracking reaction system in the first stage, in order to generate a partial NH₃ cracking reaction. The reaction gas from the heat-exchanging NH₃ cracking reaction system in the first stage enters a high-temperature NH₃ cracking reaction system in the second stage, in order to perform a residual NH₃ cracking reaction. The high-temperature NH₃ cracking reaction gas from the second stage successively enters the heat-exchanging NH₃ cracking reaction system from the first stage and the heat-exchanging gasification system in order to recover heat gradually such that the reduction gas is obtained.

WO 2001/087770 A1 concerns the autothermal decomposition of NH₃ for production of high-purity H₂.

WO 2011/107279 A1 relates to an NH₃-based H₂ production reactor comprising an NH₃ cracking chamber with an NH₃ cracking catalyst, an internal combustion chamber with a combustion or oxidation catalyst which is in thermal contact with the NH₃ cracking chamber, an NH₃ gas preheating chamber and an outer shell ring for heat recovery from the combustion products leaving the combustion chamber, wherein the cracking chamber, the internal combustion chamber, the preheating chamber and the heat recovery shell ring are in a concentric arrangement.

WO 2017/160154 A1 relates to a method of generating energy with a gas turbine, comprising the following steps: (i) evaporating and preheating liquid NH₃ in order to produce preheated NH₃ gas; (ii) introducing the preheated NH₃ gas into an NH₃ cracking apparatus suitable for converting NH₃ gas to a mixture of H₂ and N₂; (iii) converting the preheated NH₃ gas into a mixture of H₂ and N₂ in the apparatus; (iv) cooling the mixture of H₂ and N₂ to obtain a cooled H₂ and N₂ mixture; (v) introducing the cooled H₂ and N₂ mixture into a gas turbine; and (vi) combusting the cooled H₂ and N₂ mixture in the gas turbine for energy generation.

WO 2019/038251 A1 relates to a process for producing an N₂- and H₂-containing product gas from NH₃, comprising the steps of noncatalytic partial oxidation of NH₃ with an O₂-containing gas to give a process gas containing N₂, water, amounts of nitrogen oxides and residual amounts of NH₃; cracking at least a portion of the residual amounts of NH₃ to H₂ and N₂ in the process gas by contact with a nickel-containing catalyst and simultaneously reducing the amounts of nitrogen oxides to N₂ and water by reaction with a portion of the H₂ formed during the cracking of the process gas by contact of the process gas with the nickel-containing catalyst; and drawing off the H₂- and N₂-containing product gas.

WO 2012/039183 A1 relates to an NH₃ decomposition apparatus that produces H₂ as a combustion improver, and to an NH₃ oxidation apparatus which reacts a portion of the NH₃ introduced with O₂ using an oxidation catalyst, which brings about combustion in order to provide the heat required for an NH₃ decomposition reaction.

WO 2012/090739 A1 relates to an H₂ generator comprising a decomposition apparatus which decomposes a compound containing a hydrogen atom and a nitrogen atom and generates H₂; a compound feed apparatus which feeds the compound to the decomposition apparatus; and an O₂ feed apparatus that feeds O₂ to the decomposition apparatus.

WO 2020/095467 A relates to an apparatus for producing H₂gas, comprising: an NH₃ evaporation device that heats liquid NH₃ in order to produce NH₃ gas; a main apparatus for thermal decomposition, which brings about the combustion of a fuel gas, whereby the NH₃ gas produced by the NH₃ evaporation apparatus is heated and decomposed to N₂ gas and H₂ gas; a cooler which cools a gas produced by the decomposition that contains the N₂ gas and the H₂ gas produced by the decomposition by the main apparatus for thermal decomposition; and a separator that separates the H₂ gas from the cooled gas produced by the decomposition.

WO 2021/257944 A1 relates to the recovery of H₂ from an NH₃ cracking process in which the cracking gas is cleaned in a PSA apparatus. The use of a membrane separator for the PSA offgas improves the recovery.

WO 2022/096529 A1 relates to a method of cracking of NH₃, for generating H₂ and for generating electric current, comprising electrolysis of water in supplied NH₃, evaporation, preheating and cracking of NH₃ using NH₃ synthesis catalysts at low temperatures.

WO 2022/243410 A1 relates to a method of synthesizing H₂ via the catalytic cracking of NH₃; wherein an NH₃-containing stream is subjected to a catalytic cracking step in the presence of heat in order to obtain a combusted gas and a thermally cracked stream containing N₂, H₂ and possibly residual NH₃, with or without water; wherein the thermally cracked stream is subjected to an H₂ recovery step in order to obtain a high-purity H₂ stream.

WO 2022/265647 A1 relates to the recovery of a renewable H₂ product from an NH₃ cracking method, in which the cracked gas is purified in a first PSA apparatus and at least some of the first PSA tail gas is recycled as fuel, in order to reduce the carbon intensity of the renewable H₂ product.

WO 2022/265648 A1 relates to the removal of NO_{X} impurities by selective catalytic reduction (SCR) from a flue gas produced in an NH₃ cracking method using an aqueous NH₃ solution which is produced by cooling the compressed offgas from an H₂ PSA apparatus for cleaning the cracked gas.

WO 2022/265649 A1 relates to the reduction of the water content of the NH₃ used in an NH₃ cracking process, which enables the use of water-incompatible cracking catalysts. The process of water removal can also be used for recovery and recycling of NH₃ from the cracking gas.

WO 2022/265650 A1 relates to an NH₃ cracking process in which cracking gas is purified in a PSA system. Residual NH₃ in a first cracking gas is converted to further H₂ and N₂ by supplying PSA tail gas or a gas derived therefrom to a secondary cracking reactor and further processing a second cracking gas.

WO 2022/265651 A1 relates to a process in which residual NH₃ in an H₂ PSA system is removed from NH₃ cracking gas with a nonzeolitic adsorbent such as activated carbon, activated alumina or silica gel.

US 2003/0143142 A1 and US 2017/0334722 A1 describe methods of reducing the NO_{X} concentration and the N₂O concentration of the tail gas from nitric acid production.

CN 114 412 668 A relates to ammonia-fuel engines, in particular an ammonia-hydrogen fusion-type hybrid energy system and an engine.

JP 2023 026798A, published Mar. 1, 2023, relates to an offgas processing system of an ammonia engine comprising, as the first catalyst, an oxidation catalyst comprising a catalyst layer containing Pt and zeolite, and, as the second catalyst, a denitration catalyst comprising a catalyst layer containing zeolite that has been ion-exchanged with Cu, Co or Fe ions.

Y. K. Park, Chemical Engineering Journal, Volume 461, 141958, published Apr. 1, 2023, is a review of the catalytic removal of nitrogen oxides (NO, NO₂, N₂O) from offgas formed when ammonia is used as fuel.

KR 2023 095308 A, published Jun. 29, 2023, relates to a plant having a catalytic reactor; a storage tank for liquid ammonia; a first distributor for supplying at least some of the ammonia supplied from the storage tank to a catalytic reactor as decomposition ammonia; wherein the ammonia supplied to the catalytic reactor is contacted with an ammonia cleavage catalyst to produce nitrogen and hydrogen. A second distributor supplies residual ammonia that has passed through the first distributor to a denitrification reactor and a mixer.

NH₃ has a comparatively low calorific value and a low flame propagation speed, and harbors the risk of flame extinction with the result of incomplete combustion. In addition, the combustion of NH₃ harbors the risk of elevated emissions of nitrogen oxides (in particular NO, NO₂, N₂O), which affects its suitability as a combustion gas. There have been proposals of gaseous ammonia/hydrogen/air mixtures in which a certain hydrogen content is used as a combustion accelerator, which could be produced, for example, by catalytic or heat-assisted NH₃ dissociation.

The focal points of research to date have concentrated on the optimization of the combustion of ammonia as such, in particular with regard to energy yield and economic viability, but also with regard to the formation of undesirable nitrogen oxides. However, it can be assumed that it will not be possible to fully suppress the formation of NO_{X} (i.e. NO and NO₂) and of N₂O in the combustion process.

Emissions of NO_{X}, N₂O and possibly of other constituents that may be present in combustion gases (e.g. CO, HCN or even NH₃) should, however, be avoided or at least reduced as far as possible for protection of health, the environment and the climate. Many industrialized countries have therefore imposed corresponding regulations.

In addition, the combustion of hydrocarbons (CH₄, natural gas, etc.) in the presence of NH₃ gives rise to offgases that can contain hydrogen cyanide (HCN, hydrocyanic acid). Even small amounts of HCN are problematic since it is classified as highly toxic, and correspondingly low limits for emissions of HCN into the environment have to be observed. HCN-contaminated offgases can in principle be purified by various measures. Alkaline scrubbing operations can form and separate off cyanides, but these in turn have to be disposed of as highly toxic compounds. Specific oxidation catalysts based on precious metals can be used to convert HCN to CO₂, H₂O, N₂ and various nitrogen oxides. However, this means not inconsiderable procedural complexity and costs. For instance, the nitrogen oxides formed have to be broken down in a further process step, for example by means of SCR. Also described is passage over specific catalysts, for example based on TiO₂, for hydrolysis of the HCN as follows: HCN+H₂O→CO+NH₃. In this case too, subsequent further oxidation over corresponding separate oxidation catalysts is then likewise necessary. There is therefore a need for cleaning processes for HCN-contaminated offgases that feature simple and inexpensive modes of operation and low apparatus expenditure. In addition, the processes should convert HCN to nontoxic substances that do not require further treatment.

A further problem is the incomplete combustion of ammonia, which has the effect that the offgases from firing systems operated with ammonia as a fuel can contain considerable amounts of uncombusted ammonia (called NH₃ slip, NH₃ breakthrough). Acceptable limits for ammonia for release to the atmosphere are comparatively strict. Therefore, in such cases, it is necessary to ensure that ammonia is oxidized to nitrogen before the offgas may be released to the atmosphere. For this purpose, what are called ammonia slip catalysts (ASC) have been developed, which are typically based on precious metals from the platinum group (i.e. Ru, Rh, Pd, Os, Ir, Pt). Such catalysts are not only costly but also not very selective (i.e. they can form NO_{X} or N₂O from NH₃) and are susceptible to chlorine and chlorine compounds.

There is therefore a need for measures that are capable of at least partly eliminating
nitrogen oxides (in particular N₂O and NO_{X} (i.e. NO and NO₂)),
any excess NH₃, and
any other environmentally harmful components of the offgases (for example CO or HCN), which are present in the offgas of NH₃-operated firing systems for combustion-related reasons, such that the offgas can then be discharged into the ambient air in compliance with all environmental regulations.

These firing systems preferably comprise a combustion device in which NH₃ is combusted to generate heat of combustion, and an NH₃ decomposition device which is in heat exchange with the combustion device and in which NH₃ is decomposed catalytically to N₂ and H₂.

It is necessary here to take account of the particular circumstances that arise from maximum efficiency of combustion of NH₃ for operation of firing systems, preferably comprising a combustion device for combustion of NH₃ and an NH₃ decomposition device for cracking of NH₃ to N₂ and H₂.

Important parameters are not only the different composition of the offgas, but also in particular the pressure and temperature of the offgas. These parameters may differ considerably from those of other offgases for which measures for elimination of NO_{X} and N₂O have been developed to date.

For example, in the industrial production of nitric acid NH₃, oxidation is conducted deliberately up to NO_{X} in order subsequently to obtain nitric acid therefrom by reacting with water in an absorption tower. Special catalysts made from precious metals are used for the oxidation, and the reaction is frequently effected at elevated pressure. The aim of the combustion of NH₃ here is to achieve a maximum yield of NO_{X}, and typical water contents in the offgas are in the range from about 1% to 3% by volume.

By contrast, NH₃ is oxidized in the combustion preferably only as far as the stage of N₂ for operation of firing systems, preferably comprising a combustion device for combustion of NH₃ and an NH₃ decomposition device for cracking of NH₃ to N₂ and H₂, for which no catalysts are typically necessary, and this reaction usually takes place at atmospheric pressure. Typical water contents in the offgas are well above 3% by volume. For example, the combustion of pure NH₃ in air with a residual oxygen content of 3 mol % affords more than 28 mol % of water. The main aim of the combustion of NH₃ is to generate the energy required in the catalytic decomposition reaction of NH₃ to N₂ and H₂. Low levels of nitrogen oxides in the offgas formed in the combustion are advantageous here because in that case only a comparatively small offgas treatment system is required in order to reduce the level of nitrogen oxides in the flue gas and hence comply with regulatory requirements with regard to permissible emissions or because only in that case can sufficiently low residual concentration be achieved at all with known methods for nitrogen oxide reduction.

By contrast with conventional offgas treatment systems as used, for instance, in the case of offgases from plants for production of HNO₃, the inventive combustion of NH₃, preferably in a mixture with H₂, combined with the catalytic decomposition of NH₃ to H₂ and, provides special features entailing special measures.

Essential features are firstly the ambient pressure conditions and secondly the very high water content. What is meant by “ambient pressure” is that, in the case of use of conventional catalyst beds based on beds of particulate shaped bodies etc., pressure drops could possibly be too great. The high water content, because of the hydrothermal load on the catalysts in the offgas treatment system, especially in the case of zeolite material, with simultaneously high temperature can possibly lead to progressive deactivation of the catalysts. The maximum temperature should therefore be limited. Aside from the aging, the chemical reduction of NO_{X} is barely impaired by the high water content, while the breakdown of N₂O by decomposition and/or chemical reduction is significantly impaired by the high water content.

A further difference in the offgases to be treated in accordance with the invention by comparison to the production of HNO₃ is the relatively high NO_{X} content, which can be several thousand ppmv. The NO_{X} content depends on the conditions in the combustion of NH₃, in particular on the NH₃ content, any other combustible gases present (H₂ and/or CH₄ (natural gas)) and the air ratio λ. Because of the high temperatures in the combustion of up to 1000° C. or more, the NO_{X} is also present almost exclusively as NO at first, i.e. with a very high proportion of NO and a very low proportion of NO₂. As a result of the preferred cooling in the downstream heat exchanger too, because of the slow formation kinetics of NO₂ at high temperatures, only a small proportion of the NO is converted to NO₂. This means that the degree of oxidation (β) of NO_{X}, i.e. the molar proportion of NO₂ in the total NO_{X} (β=n (NO₂)/(n (NO)+n (NO₂)), is small when the offgas enters the offgas treatment system, typically <5% by volume. This in turn means that the desired selective catalytic NO_{X} reduction can actually proceed very poorly or slowly, in accordance with normal SCR that takes place at a slow rate.

These are fundamental differences from the established offgas cleaning in HNO₃ systems in which the N₂O- and NO_{X}-containing tail gas is heated stepwise under a positive pressure of usually 4-10 bar after leaving the absorption tower from a “cold” state (the thermodynamic NO_{X} equilibrium is virtually completely to the NO₂ side). For instance, the NO_{X} oxidation level of tail gases in HNO₃ production before entry into a corresponding offgas treatment system is typically between 30% and 70% by volume, i.e. close to the ideal stoichiometric ratio for NO_{X} reduction in very fast SCR.

The high NO_{X} content, combined with a very low NO_{X} oxidation level and high water content with simultaneously low operating pressure (close to atmospheric pressure) thus poses particular challenges in the present case to the effectiveness of the offgas treatment system of the invention. In addition, there is the challenge or need to eliminate N₂O which is likewise present in the offgas and is not reducible by conventional SCR methods based on V₂O₅/TiO₂ catalysts.

The objectives and the resultant reaction products in the combustion of NH₃ therefore sometimes differ considerably from one another.

In conventional plants for production of nitric acid, the offgas frequently has, at comparatively high pressure,
a comparatively low content of NO_{X};
a comparatively high proportion of NO₂;
a comparatively high content of N₂O;
a comparatively low content of water; and
a zero proportion of uncombusted NH₃ (NH₃ slip).

In contrast, in firing systems, preferably comprising combustion devices and NH₃ decomposition devices for cracking of NH₃ to N₂ and H₂, the offgas frequently has, at comparatively low pressure,
a comparatively high content of NO_{X};
a comparatively small proportion of NO₂;
a comparatively low content of N₂O;
a significantly higher content of water;
possibly a not inconsiderable proportion of uncombusted NH₃ (NH₃ slip); and
possibly a non-negligible proportion of HCN, if NH₃ is combusted together with CH₄ (natural gas).

These special circumstances have to be taken into account in the elimination of NO_{X} and N₂O from the offgases, which constitutes a particular challenge.

It is an object of the invention to reduce the content of NO_{X} (i.e. NO and NO₂), N₂O and, if necessary, NH₃, CO and/or HCN in offgases that are obtained in NH₃-operated firing systems, preferably comprising a combustion device for combustion of NH₃ and an NH₃ decomposition device for cracking of NH₃ to N₂ and H₂. It should be possible here, if necessary, to degrade a very large amount of NO_{X} and additionally also N₂O in order to reduce the respective content.

This object is achieved by the subject matter of the claims.

A first aspect of the invention relates to a method of reducing the content of NO_{X} and N₂O in the offgas of an NH₃-operated firing system, preferably comprising a combustion device for combustion of NH₃ and an NH₃ decomposition device for cracking of NH₃ to N₂ and H₂, wherein the method comprises the following steps:
(a) combusting NH₃ (optionally in mixture with one or more other combustible gases, for example H₂, CH₄, etc.) to operate the firing system, preferably comprising a combustion device for combustion of NH₃ (preferably comprising at least one burner and a combustion chamber) and an NH₃ decomposition device for cracking of NH₃ to N₂ and H₂, to produce an offgas which comprises N₂, H₂O, NO_{X} and N₂O, with or without HCN, and which leaves the firing system, preferably comprising a combustion device for combustion of NH₃ and an NH₃ decomposition device for cracking of NH₃ to N₂ and H₂;
(b) optionally and preferably cooling the offgas in at least one heat exchanger disposed downstream of the firing system in flow direction of the offgas;
(c) transferring the optionally cooled offgas into an offgas treatment system;
(d) reducing the N₂O content in the offgas by
   (d₁) decomposing N₂O over an N₂O decomposition catalyst and/or
   (d₂) chemically reducing N₂O with reducing agent over an N₂O reduction catalyst;
(e) reducing the NO_{X} content in the offgas by chemical reduction of NO_{X} with reducing agent over an NO_{X} reduction catalyst; and
(f) optionally and preferably cooling the offgas in at least one heat exchanger disposed downstream of the offgas treatment system in flow direction of the offgas.

The sequence of steps (d) and (e) is as desired; all options are included in accordance with the invention, from successively in time in any sequence to simultaneously, or mixed forms thereof.

The invention preferably relates to a method of reducing the content of NO_{X} and N₂O in the offgas of an NH₃- and H₂-operated firing system, preferably comprising a combustion device for combustion of NH₃ and an NH₃ decomposition device for cracking of NH₃ to N₂ and H₂, wherein the method comprises the following steps:
(a) combusting NH₃ and H₂ to operate the firing system, preferably comprising a combustion device for combustion of NH₃ (preferably comprising at least one burner and a combustion chamber) and an NH₃ decomposition device for cracking of NH₃ to N₂ and H₂, to produce an offgas which comprises N₂, H₂O, NO_{X} and N₂O and which leaves the firing system, preferably comprising a combustion device for combustion of NH₃ and an NH₃ decomposition device for cracking of NH₃ to N₂ and H₂;
(b) optionally and preferably cooling the offgas in at least one heat exchanger disposed downstream of the firing system in flow direction of the offgas;
(c) transferring the optionally cooled offgas to an offgas treatment system disposed downstream of the firing system and, if appropriate, of the at least one heat exchanger in flow direction of the offgas;
(d) reducing the N₂O content in the offgas by
   (d₁) decomposing N₂O over an N₂O decomposition catalyst and/or
   (d₂) chemically reducing N₂O with reducing agent over an N₂O reduction catalyst;
(e) reducing the NO_{X} content in the offgas by chemical reduction of NO_{X} with reducing agent over an NO_{X} reduction catalyst; and
(f) optionally and preferably cooling the offgas in at least one heat exchanger disposed downstream of the offgas treatment system in flow direction of the offgas.

It has been found that the NO_{X} content in the flue gas can be utilized advantageously. Thus, in the offgas treatment system, the chemical reduction of NO_{X} with a reducing agent, preferably with NH₃, generates a considerable amount of heat which can be released to a suitable heat transfer medium with the aid of one or more heat exchangers. The heat transfer medium used here is preferably water or water vapor, which has advantages in terms of safety inter alia. The heat absorbed by the heat transfer medium is then preferably used for the heating of NH₃, which is supplied as feed stream to the NH₃ decomposition device. Alternatively or additionally, the heat can also be utilized for preheating of combustion air.

Experimental findings or simulation calculations indicate that the heat released in the chemical reduction of NO_{X} with a reducing agent, preferably with NH₃, heats the offgas, in relative terms, by up to 70 K, preferably up to 50 K, i.e. the gas temperature on departure from the offgas treatment system is up to 70 K, preferably up to 50 K, higher than on entry into the offgas treatment system.

It has also been found that the amount of nitrogen oxides formed in the combustion of NH₃ in the offgas can depend on numerous factors, including the mixing ratio of H₂:NH₃, the air ratio λ, the preheating of the combustion air, the design of the burner, etc.

The catalytic decomposition of NH₃ serves to form H₂ as product. A further aspect of the invention therefore relates to a method of producing H₂ by catalytic decomposition of NH₃, comprising the method of the invention for reducing the content of NO_{X} and N₂O in the offgas of an NH₃-operated firing system, preferably comprising a combustion device for combustion of NH₃ and an NH₃ decomposition device for cracking of NH₃ to N₂ and H₂. This aspect preferably relates to a method of producing H₂ by catalytic decomposition of NH₃, comprising the method of the invention for reducing the content of NO_{X} and N₂O in the offgas of an NH₃- and H₂-operated firing system, preferably comprising a combustion device for combustion of NH₃ and an NH₃ decomposition device for cracking of NH₃ to N₂ and H₂.

The offgas treatment system of the invention comprises at least
an N₂O reduction catalyst and/or an N₂O decomposition catalyst; and
an NO_{X} reduction catalyst;
   which may be the same or different according to the given functionality or multifunctionality and may be present in common or separate reaction zones (catalyst beds).

In preferred embodiments, the offgas treatment apparatus of the invention comprises
an N₂O reduction catalyst;
an N₂O decomposition catalyst; and
an NO_{X} reduction catalyst;
   which may be the same or different according to the given functionality or multifunctionality and may be present in common or separate reaction zones (catalyst beds).

In preferred embodiments, the offgas treatment system of the invention additionally comprises at least one further catalyst, or one of the aforementioned N₂O reduction, N₂O decomposition or NO_{X} reduction catalyst fulfills at least one further functionality selected from
NH₃ oxidation catalyst;
HCN breakdown catalyst; and
CO oxidation catalyst.

The NH₃ oxidation catalyst is preferably used when the proportion of uncombusted NH₃ in the offgas (NH₃ slip) is greater than the demand for NH₃ as reducing agent for NO_{X} and/or N₂O in the offgas treatment system, such that the offgas, after passing through steps (d₁) and/or (d₂) and (e), still contains residual amounts of NH₃ that should not or must not be released to the environment. These residual amounts of NH₃ can then be broken down by oxidation of NH₃ using the downstream NH₃ oxidation catalyst.

The HCN breakdown catalyst is preferably used when the fuel, in addition to NH₃, contains hydrocarbons (CH₄, natural gas, etc.), and the offgas formed in the combustion contains certain amounts of HCN. The resulting HCN can then be broken down (eliminated) with the aid of the HCN breakdown catalyst by hydrolysis of the HCN and oxidation of the hydrolysis products (hydrolyzates) formed, i.e. of NH₃ and CO, preferably with NO_{X} and N₂O present in the offgas.

It has been found that, surprisingly, HCN in water-containing offgases which simultaneously contain NO_{X} and N₂O, each in a molar amount greater than or equal to the molar amount of HCN, can be broken down to N₂, H₂O and CO₂ by passing the offgas over a zeolitic catalyst laden with transition metals, for example a package of catalyst pellets containing an iron-laden zeolitic material of the BEA structure type, at temperatures of 300 to 600° C. (preferably 350 to 550° C.).

By contrast to known processes, complete elimination of HCN, i.e. a conversion to nontoxic substances, can thus be brought about in a one-stage process, i.e. in one process step without costly precious metal catalysts. In order to eliminate excess levels of NO_{X} and N₂O, it is additionally possible to add NH₃ for reduction of NO_{X} and N₂O, and optionally CO or hydrocarbons, for example CH₄ or propane, for reduction of N₂O to the HCN-, NO_{X}- and N₂O-containing offgas. The amount of reducing agent in this case should be in accordance with the molar starting amounts of N₂O and NO_{X}, in each case reduced by the molar amount of HCN present in the offgas. If excess amounts of N₂O are present in the offgas and are to be reduced with NH₃ or CO or hydrocarbon, the NO_{X} content should be reduced by means of NH₃ in each case to zero (or close to zero). If CO or hydrocarbons are used as additional reducing agents, any emissions of CO may possibly be eliminated by using an additional CO oxidation catalyst downstream of the zeolite catalyst.

The CO oxidation catalyst is preferably used when (i) hydrocarbons (CH₄, natural gas, etc.) are used as reducing agents for N₂O; and/or (ii) an HCN breakdown catalyst is used to break down HCN, with CO present in the degradation products thereof. Any CO obtained in each case can then be broken down by oxidation to CO₂ with the aid of the downstream CO oxidation catalyst.

If the offgas treatment system of the invention comprises an NH₃ oxidation catalyst, it may be preferable in accordance with the invention to cool the offgas firstly with a heat exchanger within the offgas treatment system to a lower temperature than on entry into the offgas treatment system, such that the NH₃ oxidation catalyst can display its effect in an optimized manner. In preferred embodiments, the offgas treatment system of the invention therefore additionally comprises one or more heat exchangers.

For the purposes of the description “and or” means either “or” or “and”, such that, for example, “A and or B” has the following three meanings: (i) only A but not B, (ii) only B but not A, and (iii) both A and B.

For the purposes of the description, “NO_{X}” includes nitrogen monoxide (NO) and nitrogen d₁-oxide (NO₂), but not nitrous oxide (N₂O).

Catalysts accelerate certain chemical reactions by lowering their activation energies.

Unless explicitly stated otherwise, all figures in ppm are based on volume, i.e. ppmv. Unless explicitly stated otherwise, all percentages are based on volume with regard to gas composition, i.e. % by volume. Unless explicitly stated otherwise, all other percentages are based on weight, i.e. % by weight.

Steps (b) and (f) of the method of the invention are independently optional and preferred.

Steps (a), optionally (b), and (c) of the method of the invention are performed successively in alphabetical sequence, followed by steps (d) and (e) in fundamentally any sequence. Step (d) can accordingly be performed before step (e) or after step (e) or simultaneously with step (e). Also possible are mixed forms of partial simultaneousness. This may be relevant particularly when one and the same catalyst material is capable of catalyzing multiple reactions. Such embodiments are particularly preferred in accordance with the invention. According to the invention, these reactions then possibly take place simultaneously, although the kinetics of the respective reactions may vary, such that a first reaction may have ended earlier or may have reached a higher conversion than a second reaction proceeding in parallel. The optional step (f) follows after steps (d) and (e).

Steps (d₁) and (d₂) are considered separately for the purposes of the description, but both serve the common purpose of reducing the N₂O content in the offgas.

Steps (d₁), (d₂) and (e) can likewise be performed in any sequence, although mixed forms of partial simultaneousness are also possible in this regard.

In preferred embodiments, the method of the invention comprises steps (a), optionally (b), (c), (d₁), (e) and optionally (f); steps (a), optionally (b), (c), (d₂), (e) and optionally (f); or steps (a), optionally (b), (c), (d₁), (d₂), (e) and optionally (f).

In preferred embodiments, the offgas undergoes the steps of the method of the invention in one of the following sequences:

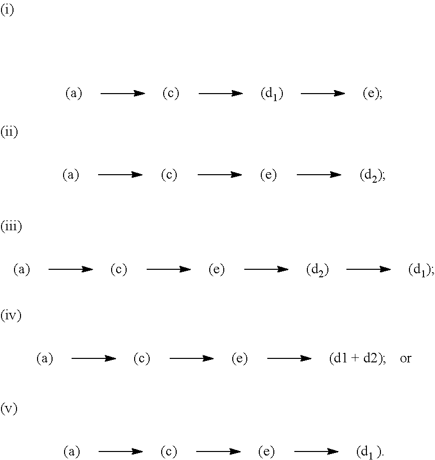

In preferred embodiments, the offgas undergoes the steps of the method of the invention in one of the following sequences:

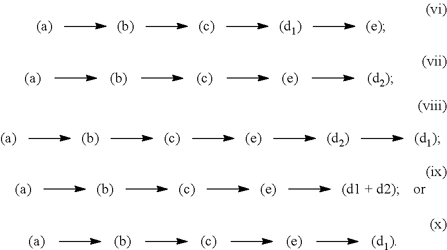

In preferred embodiments, the offgas undergoes the steps of the method of the invention in one of the following sequences:

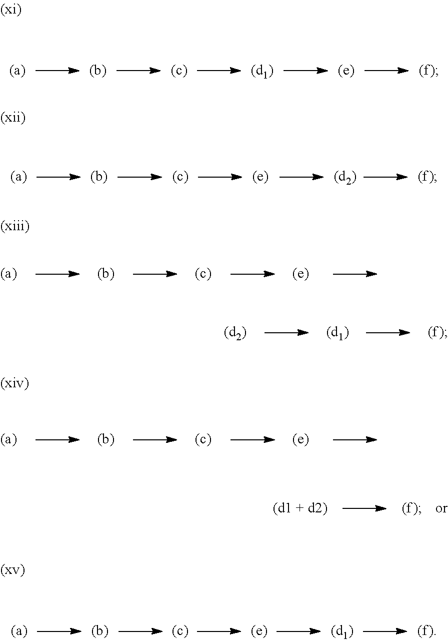

What is meant by (d1+d2) is that both step (d₁) and step (d₂) are performed, although the performance of these two steps (d₁) and (d₂) is at least partly simultaneous, i.e. both steps proceed in parallel.

Between these steps, there may be further steps that are not specified explicitly.

### Streams of Matter:

For the purposes of the description, the following streams of matter inter alia are distinguished:
NH₃ (reactant), which is used as the starting material for the catalytic decomposition and is preferably supplied to the NH₃ decomposition device;
intermediate product gas which, in the case of series-connected NH₃ decomposition devices, leaves an upstream NH₃ decomposition device (preliminary reactor) and is supplied to a downstream NH₃ decomposition device (main reactor); in the case of several preliminary reactors, several intermediate product gases may be distinguished; the intermediate product gas contains the products of a partial catalytic decomposition of NH₃, typically H₂, N₂ and comparatively large amounts of undecomposed NH₃;
product gas obtained by the catalytic decomposition of NH₃, typically H₂, N₂ and comparatively small amounts of undecomposed NH₃; in the case of multiple series-connected NH₃ decomposition devices, the product gas is the gas mixture leaving the last of the series-connected NH₃ decomposition devices;
combustion gas which is combusted in the firing system of the invention, preferably in the combustion device, for generation of heat of combustion; the combustion gas contains NH₃ and H₂, and optionally additionally N₂;
combustion air which is supplied to the firing system of the invention, preferably to the combustion device, such that the combustion gas can burn in a mixture with the combustion air; the combustion air contains O₂ and N₂;
offgas formed in the combustion of the combustion gas in a mixture with the combustion air; the offgas contains N₂, H₂O, NO_{X} and N₂O.

It is a main object of the invention to reduce the content of NO_{X} and N₂O in this offgas.

### Step (a):

In step (a) of the method of the invention, the combustion of NH₃ is effected for operation of a firing system. Preferably, in step (a) of the method of the invention, NH₃ is combusted, optionally in a mixture with other components (e.g. H₂ or CH₄). These firing systems preferably comprise a combustion device in which NH₃ is combusted to generate heat of combustion, and an NH₃ decomposition device which is in heat exchange with the combustion device and in which NH₃ is decomposed catalytically to N₂ and H₂. The combustion generates an offgas comprising N₂, H₂O, NO_{X} and N₂O. Residues of uncombusted NH₃ may likewise be present. The offgas leaves the firing system, preferably the combustion device, and is then supplied to the optional step (b) or directly to step (c) of the method of the invention.

“Firing systems” in the context of the invention generate heat through combustion processes. The firing systems preferably comprise a combustion device for combustion of NH₃ and an NH₃ decomposition device for cracking NH₃ to N₂ and H₂. Firing of combustion gases generates heat. “Firing systems” or the “combustion devices” encompassed therein, in the context of the invention, are any plants in which NH₃ or an NH₃-containing fuel is oxidized with O₂ (preferably from combustion air) with the aim of producing N₂ and H₂O in particular as the main products. Systems in which NH₃ is oxidized with O₂ with the aim of producing nitrogen compounds with higher oxidation numbers (e.g. NO_{X}) as the main products, as is the case, for example, in the production of nitric acid, are neither firing systems nor combustion devices in the context of the invention. Production of such nitrogen compounds with higher oxidation numbers than main products typically requires catalysts. Preferably in accordance with the invention, the firing system of the invention is not equipped with a catalyst, i.e. the inventive combustion of NH₃ and H₂, preferably in accordance with the invention, is uncatalyzed.

The combusting of NH₃ means the oxidation of NH₃ with O₂, where this reaction, in accordance with the invention, does not have to be complete, such that the offgas may contain residual uncombusted (unoxidized, unconverted) NH₃ (NH₃ slip, NH₃ breakthrough). The same applies if NH₃ is combusted not in pure form but together with other combustible gases, in particular H₂ and/or CH₄ (natural gas). The O₂ used for combustion can be used in the form of combustion air, where the combustion air may optionally be enriched with O₂.

In preferred embodiments, in step (a) of the method of the invention, NH₃ is combusted in a firing system comprising a combustion device for combustion of NH₃ and an NH₃ decomposition device for cracking of NH₃ to N₂ and H₂. The combustion of NH₃ in the combustion device serves to heat the NH₃ decomposition device, preferably a catalyst-filled reactor, for cracking of NH₃ to N₂ and H₂. The cracking of NH₃ to N₂ and H₂ is effected in accordance with the invention as a catalytic decomposition of NH₃ over an NH₃ decomposition catalyst.

According to the invention, the catalytic decomposition of NH₃ means the formation of N₂ and H₂, occasionally also referred to in the prior art as “cracking”. The terms “catalytic decomposition”, “decomposition”, “catalytic cracking” and “cracking” of NH₃ are used as interchangeable synonyms for the purposes of the description. Preferably in accordance with the invention, the catalytic decomposition of NH₃ is preferably effected in the absence of O₂.

The firing system of the invention preferably comprises a combustion device and an NH₃ decomposition device that exchange heat with one another. In the combustion device, a combustion gas containing NH₃ and preferably H₂ is combusted together with combustion air containing O₂, generating heat of combustion. The heat of combustion thus generated is at least partly supplied as a heat flow to the NH₃ decomposition device (or transferred to the NH₃ decomposition device), in order to provide the heat required for the endothermic catalytic decomposition of NH₃ to H₂ and N₂. In addition, the heat of combustion, in accordance with the invention, is preferably utilized to preheat the NH₃ to be decomposed, the combustion gas and the combustion air to elevated temperature.

“Combustion device” and “furnace” are used as interchangeable synonyms for the purposes of the description.

The NH₃ decomposition device is preferably a tubular reactor configured analogously to a primary reformer for production of synthesis gas or hydrogen from natural gas. The basic construction of such a fired tubular reactor, constructed analogously to a primary reformer, comprises one or more tubes containing the NH₃ decomposition catalyst, which are arranged in a combustion chamber and project into the flames of burners, and in which the radiant heat and convection heat from the flames and the hot offgas transfer heat to the NH₃ (process gas) flowing through the NH₃ decomposition catalyst. The combustion device thus preferably comprises a combustion chamber and one or more burners, preferably several burners. The NH₃ decomposition device (tubes arranged in parallel) is then disposed within the combustion device (combustion chamber, burning chamber). In order to ensure a uniform energy input and to be able to define the flame shape, the offgas is removed from the combustion device by virtue of an imposed pressure gradient, for instance through the use of compressors in the supply of the combustion air or the removal of the offgas. In order to ensure sufficient heat transfer over the length of the NH₃ decomposition catalyst bed within the tubes, the offgas must still have a sufficiently high temperature at the end of the NH₃ decomposition catalyst bed, i.e. at the end of the tubes, which allows a significant release of radiant heat. The offgas therefore leaves the combustion device (combustion chamber, burning chamber) at high temperatures which may be above 1000 C in the case of a tubular reactor configured analogously to a primary reformer. Typically, the proportion of the heat transferred to the endothermic catalytic decomposition of NH₃ is about 40-60% of the total energy generated by the combustion of the combustion gas. The remaining heat can be used for other purposes.

After it has been drawn off from the combustion device (combustion chamber, burning chamber), the offgas is preferably passed through an offgas duct, which preferably fulfils three main tasks:
1. Utilization of heat not utilized by the endothermic catalytic decomposition of NH₃ to N₂ and H₂ from the combustion of NH₃ with the aim of avoiding energy wastage or increasing energy efficiency;
2. Preheating of material streams (e.g. NH₃, combustion gas, combustion air) with the aim of improving energy integration and increasing hydrogen yield; and
3. Reduction of the content of nitrogen oxides (in particular NO, NO₂ and N₂O) by a suitable reaction regime with the aim of minimizing emission or compliance with regulatory limits.

Step (a) of the method of the invention, i.e. the combusting of NH₃ and preferably H₂ to operate the firing system while producing an offgas which leaves the firing system, preferably comprises the following component steps:
(a₁) optionally and preferably heating and evaporation of (liquid) NH₃;
(a₂) optionally and preferably heating of combustion air (preferably comprising N₂ and O₂);
(a₃) combustion of combustion gas (comprising NH₃ and preferably H₂) and combustion air (comprising O₂) in a firing system, preferably a combustion device, to produce an offgas (comprising N₂, H₂O, NO_{X} and N₂O) and release heat of combustion, with flow of at least some of the heat of combustion into an NH₃ decomposition device; and
(a₄) catalytic decomposition of NH₃ in the NH₃ decomposition device over an NH₃ decomposition catalyst, with absorption of heat of combustion from component step (a₃) and production of a product gas (comprising H₂ and N₂).

### Combustion of Combustion Gas and Combustion Air:

In preferred embodiments, NH₃ is combusted as the sole fuel, meaning that preferably no other gas is combusted aside from the NH₃. In other preferred embodiments, NH₃ is combusted in a mixture with H₂. In further preferred embodiments, NH₃ is combusted in a mixture with CH₄ (natural gas). These gases or mixtures are also referred to as “combustion gas” for the purposes of the description. As well as NH₃ and optionally H₂ and/or CH₄, the combustion gas may optionally contain further constituents, e.g. N₂.

According to the invention, heat is provided by combustion of a combustion gas in a firing system, preferably in a combustion device. For this purpose, the combustion device preferably comprises one or more burners, preferably at least two burners, more preferably at least three burners.

The combustion gas contains a mixture of H₂ and NH₃, one reason being that this mixture generates a moderate flame temperature and has better combustion properties than pure NH₃. A suitable mixing ratio of H₂ and NH₃ can additionally also affect the content of nitrogen oxides.

The combustion of NH₃, i.e. the oxidation of NH₃ with O₂ (or the mixture of NH₃ with another combustible gas, for example H₂, CH₄, etc.), is preferably not effected over a catalyst, i.e. combustion is not performed in the presence of a heterogeneous catalyst.

More preferably, the H₂ present in the combustion gas in the mixture with the NH₃ to be combusted is formed by thermal and/or catalytic decomposition of NH₃ (component step (a₄)). The integrated combustion of NH₃ with O₂ preferably provides the energy for the catalytic decomposition (cracking). Preferably, in step (a), the combustion of NH₃ is therefore preferably integrated in a process for thermal and/or catalytic catalytic decomposition of NH₃ to N₂ and H₂.

The composition of the offgas formed in the combustion depends on the combustion gas used. In preferred embodiments, sufficient H₂ is added to NH₃ in order to alter the combustion properties of the combustion gas to the effect that a largely quantitative conversion is achieved during combustion.

In other preferred embodiments, the combustion gas used is a mixture of the output from a separation unit for purification of the H₂, preferably from the offgas of a pressure swing adsorption apparatus or the retentate of a membrane unit, preferably a pressure swing adsorption apparatus, and a proportion of the NH₃ or of the H₂ produced as a product.

If the catalytic decomposition of NH₃ does not proceed to completion, the product gas (i.e. the product of the catalytic decomposition) will still contain residual unconverted NH₃ in addition to N₂ and H₂. Preferably, the H₂ present in the combustion gas in a mixture with the NH₃ to be combusted is formed by catalytic decomposition of NH₃ and subsequently separated off, possibly in a mixture with residual NH₃ and/or N₂, from the product gas formed in the catalytic decomposition of NH₃, preferably by pressure swing adsorption (PSA). Thus, the product gas obtained in the catalytic decomposition of NH₃ and an NH₃ decomposition catalyst, preferably in accordance with the invention, is separated by pressure swing adsorption
into a high-purity H₂ on the one hand (product hydrogen) and
into a gas mixture (offgas from the pressure swing adsorption) on the other hand.

In addition to N₂, the gas mixture separated from the H₂ (offgas from the pressure swing adsorption) may contains residual NH₃ that has not been catalytically decomposed and a certain amount of H₂. Thus, the separation efficiency of the apparatus for purifying the H₂ determines how much H₂ is present in the offgas of the pressure swing adsorption apparatus or in the retentate of the membrane unit, and therefore likewise affects the composition of the offgas formed therefrom in the combustion. The quantitative separation of the total amount of H₂ is not possible for production reasons or economical in terms of production, and therefore separated gas mixture (offgas of the pressure swing adsorption) often contains a certain amount of H₂. In this way, a mixture of NH₃ and H₂ is then already obtained, which can either be directly combusted as such or first enriched with further NH₃ (or H₂).

This gas mixture separated from the product gas by pressure swing adsorption is therefore preferably used in accordance with the invention as a combustion gas. Depending on the content of NH₃ and H₂, the separated gas mixture can be used as such in unchanged form as combustion gas, or an appropriate amount of NH₃ or H₂ is metered in in order to set the desired ratio of NH₃ to H₂. If the catalytic decomposition proceeds to completion or virtually to completion, the NH₃ content in the separated gas mixture (offgas of the pressure swing adsorption) may still be too low and the required amount of NH₃ may need to be added.

The exact composition of the offgas formed in the combustion of the combustion gas depends on the composition of the combustion gas and the combustion air. An essential parameter in the description of the combustion properties of the combustion gas, the emission of pollutants and the composition of the offgas is the mixing ratio of NH₃ to H₂.

The table below shows, on the basis of simulation calculations for five different process regimes #1 to #5, the composition of the combustion gas and of the offgas formed for the same composition of the combustion air. The molar streams are standardized to a calorific value flow of 1 MW, so that they are comparable. For process regimes #1 to #3 (comparative examples), pure CH₄, pure NH₃ and pure H₂ are used as combustion gas. For process regimes #4 and #5 (inventive examples), mixtures of H₂ and NH₃ (process regime #4) or H₂, NH₃, N₂ and H₂O are used as combustion gas (process regime #5; offgas of a pressure swing adsorption apparatus (PSA)):

| | | | | |
|---|---|---|---|---|
| | | | #4 | #5 |
| #1 | #2 | #3 | Startup | Normal |
| CH₄ | NH₃ | H₂ | operation | operation |

Combustion gas:

| | | | | | | |
|---|---|---|---|---|---|---|
| CH₄ | mol % | 100.00 | 0 | 0 | 0 | 0 |
| H₂ | mol % | 0 | 0 | 100.00 | 10.00 | 26.4 |
| N₂ | mol % | 0 | 0 | 0 | 0 | 62.7 |
| NH₃ | mol % | 0 | 100.00 | 0 | 90.00 | 10.6 |
| H₂O | mol % | 0 | 0 | 0 | 0 | 0.2 |
| Molar | kmol/h | 4.49 | 11.36 | 14.89 | 11.64 | 36.95 |
| flow rate | | | | | | |

Combustion air:

| | | | | | | |
|---|---|---|---|---|---|---|
| N₂ | mol % | 77.48 | 77.48 | 77.48 | 77.48 | 77.48 |
| O₂ | mol % | 20.78 | 20.78 | 20.78 | 20.78 | 20.78 |
| Ar | mol % | 0.91 | 0.91 | 0.91 | 0.91 | 0.91 |
| CO₂ | mol % | 0.03 | 0.03 | 0.03 | 0.03 | 0.03 |
| H₂O | mol % | 0.80 | 0.80 | 0.80 | 0.80 | 0.80 |
| Molar | kmol/h | 49.63 | 47.40 | 40.56 | 46.86 | 50.72 |
| flow rate | | | | | | |
| Air ratio | | 1.15 | 1.16 | 1.13 | 1.15 | 1.35 |

Offgas:

| | | | | | | |
|---|---|---|---|---|---|---|
| N₂ | mol % | 71.06 | 68.84 | 65.47 | 68.63 | 80.93 |
| O₂ | mol % | 2.48 | 2.15 | 2.05 | 2.15 | 2.52 |
| Ar | mol % | 0.83 | 0.70 | 0.77 | 0.70 | 0.43 |
| CO₂ | mol % | 8.32 | 0.03 | 0.03 | 0.03 | 0.02 |
| H₂O | mol % | 17.31 | 28.29 | 31.69 | 28.50 | 16.11 |
| Molar | kmol/h | 54.12 | 61.60 | 48.00 | 60.54 | 108.24 |
| flow rate | | | | | | |

As the data in the table above illustrate, in inventive process regime #5 (offgas of the PSA), almost twice as much offgas flows through the offgas duct as in the case of a hydrogen-fired reformer (process regime #3), and only slightly less than twice as much compared to a methane-fired reformer (process regime #1).

Therefore, inventive process regime #5 has a much flatter temperature profile in the offgas duct than the other process regimes and can therefore include more steps for heat integration, including those that are possible at low flue gas temperature. As illustrated by process regimes #5 to #7, this enables (nearly) full energy integration.

In the case of hydrogen- or methane-fired reformers, the temperature profile in the offgas duct would have to be much steeper because a small volume of offgas is available. Since the heat exchangers in the offgas duct require a minimum temperature differential in order to be designed economically, the risk of leaving untransferable residual heat unutilized is significantly greater in the case of steep temperature profiles because of the required temperature differential. In any case, the offgas entering the offgas duct is much hotter in these cases and requires the use of costlier materials.

Preference is given to establishing a mixing ratio of NH₃ and H₂ in the combustion gas, which is optimized with regard to the subsequent combustion. The proportion of H₂ is preferably at most 80 mol %, more preferably at most 70 mol %, even more preferably at most 60 mol %, most preferably at most 50 mol %, and in particular at most 40 mol %. The proportion of H₂ is preferably at most 30 mol %, more preferably at most 20 mol %, even more preferably at most 15 mol %, most preferably at most 10 mol %, and in particular at most 5 mol %.

The proportion of H₂ is preferably at least 1 mol %, more preferably at least 2 mol %, even more preferably at least 3 mol %, most preferably at least 4 mol %, and in particular at least 5 mol %. The proportion of H₂ is preferably at least 10 mol %, more preferably at least 20 mol %, even more preferably at least 30 mol %, most preferably at least 40 mol %, and in particular at least 50 mol %.

In particularly preferred embodiments, the molar ratio of H₂:NH₃ in the mixture is in the range from 45:55 to 90:10, preferably 50:50 to 85:15, more preferably 55:45 to 80:20, even more preferably 60:40 to 75:25, most preferably 65:35 to 70:30 or 70:30 to 75:25. Since, preferably in accordance with the invention, the combustion gas used is the separated gas mixture from a gas swing adsorption system, the molar ratio of H₂:NH₃ depends mainly on its hydrogen yield and can be about 15:1 in extreme cases.

In the combustion of the mixture of combustion gas and combustion air, the air ratio, for combustion is preferably in the range from 0.9 to 1.7, more preferably 1.0 to 1.6, even more preferably 1.1 to 1.5, most preferably 1.2 to 1.4. A further very particularly preferred range for the air ratio, is between 1.0 and 1.2.

In particularly preferred embodiments, the air ratio is in the range of 1.06±0.06, preferably 1.06±0.05, more preferably 1.06±0.04, even more preferably 1.06±0.03, most preferably 1.06±0.02, and in particular 1.06±0.01.

The air ratio, (i.e. the combustion air ratio) indicates the mass ratio of combustion air to combustion gas relative to the stoichiometrically ideal ratio for a theoretically complete combustion process.

It is defined as that ratio of air to fuel which contains a sufficient mass of oxygen to achieve complete combustion of a given mass of fuel (cf. e.g. K. Soman, Thermal Engineering, PHI, 2011, page 224, no. 5.4.2). In principle, the ratio can be expressed in terms of mass or molar amount (cf. e.g. P. Majumdar, Design of Thermal Energy Systems, Wiley 2021, page 66, No. 2.13.5.2). For the purposes of the description, the ratio is based on mass. If not air but another oxygen-containing gas is used for a combustion operation, “air” should, strictly speaking, be replaced by “oxygen carrier”. However, the, parameter is still used in the above definition.

In preferred embodiments, the equivalence ratio NH₃/H₂ (Φ) (not to be confused with the reciprocal of the air ratio 1/λ) is in the range from 0.55 to 1.40, more preferably 1.05 to 1.20. The formation of nitrogen oxides depends upon factors including the residual oxygen content in the offgas, which may, for example, be 3 mol % or 1 mol %. In order, for example, to achieve a residual oxygen content of 1 mol %, an air ratio of about 1.1 is required.

The concentration of nitrogen oxides (especially NO, NO₂ and N₂O) and the dewpoints of condensable components are two parameters of great significance for the technical implementation and fitout of the offgas duct. These parameters are likewise determined to a crucial degree by the composition of the offgas. The offgas from tubular reactors, which are of analogous design to a primary reformer, contains nitrogen oxides that are formed in the combustion reaction. In many countries, emission of nitrogen oxides is regulated and, if permissible limits are exceeded, has to be reduced by use of suitable technologies.

Nitrogen oxides (especially NO, NO₂ and N₂O) are formed in combustion reactions by various mechanisms. In tubular reactors, which are of analogous design to a primary reformer, a combustion gas that does not contain NH₃ produces exclusively what are called “thermal nitrogen oxides”, through recombination of nitrogen radicals with oxygen, the formation of which is preferred at high temperatures.

A combustion gas containing NH₃ can form nitrogen oxides via various reaction pathways in the complex kinetics of the combustion of NH₃, called “kinetic nitrogen oxides”.

In plants for production of H₂ from NH₃, both thermal nitrogen oxides and kinetic nitrogen oxides can be formed. The presence of H₂ in the combustion gas increases the flame temperature, and the admixing of NH₃ increases the tendency to form kinetic nitrogen oxides. The literature describes numerous cases in which the combustion of mixtures of NH₃ and H₂ leads to distinctly greater emissions of nitrogen oxides than is the case in conventional primary reformers. The emission of nitrogen oxides depends not only on the composition of the combustion gas, specifically on the mixing ratio of NH₃ and H₂, but also on various other parameters, in particular
the preheating temperature of the combustion air and the combustion gas;
the excess of combustion air in the combustion; and
the design and geometry of the burner used.

The exact emissions of nitrogen oxides are therefore much more strongly dependent on the individual case than is the case with conventional primary reformers. Typical emissions of NO_{X} (i.e. NO and NO₂) are in the range of 100-10 000 ppmv. An example of an offgas with a comparatively low nitrogen oxide content contains 500 ppmv of NO, 10 ppmv of NO₂ and 10 ppmv of N₂O (case A). An example of an offgas with a comparatively high nitrogen oxide content contains 5000 ppmv of NO, 10 ppmv of NO₂ and 50 ppmv of N₂O (case B).

During the startup of the system with a combustion gas rich in NH₃ would lead to comparatively low emissions of NO, but to comparatively high emissions of N₂O. This case has to be taken into account in the design of the fitout even if it is of no major importance for the mass balance of the plant in normal operation, i.e. after conclusion of the startup operation.

In addition, two dewpoints are of interest in the consideration at the offgas duct of a system for producing H₂ from NH₃: the dewpoint of H₂O and the dewpoint of NH₄NO₃.

The dewpoint of H₂O depends on the partial pressure of H₂O in the offgas. In process variants in which the offgas of the pressure swing adsorption apparatus (PSA) or the retentate of a membrane unit is fed into the combustion gas system, the offgas contains mainly N₂, and only comparatively little H₂O, which leads to generally comparatively low dewpoints.

The table below shows the water content of the offgas and the dewpoint of water for the process variants that have already been introduced:

| | Molar proportion | Partial pressure | |
|---|---|---|---|
| | of H₂O | of H₂O | Dewpoint |
| | [mol %] | [bar] | [° C.] |
| CH₄ | 17.31 | 0.16 | 54.78 |
| NH₃ | 28.29 | 0.25 | 65.40 |
| H₂ | 31.69 | 0.29 | 67.97 |
| 90 mol % NH₃ 10 | 28.5 | 0.26 | 65.57 |
| mol % H₂ | | | |
| PSA offgas + NH₃ | 16.11 | 0.14 | 53.29 |

If this dewpoint of H₂O is attained in the operation of the system, there will be droplet formation. Since a change in temperature in the offgas is caused by the outflow of heat in a heat exchanger, the condensed water can precipitate on the surface of the tubes and cause worsening of the heat transfer. If droplets enter an offgas fan, the rotor may be damaged. The condensation of liquid H₂O is therefore undesirable. In order to avoid influencing the operation of the system and damage thereto, a margin of the minimum offgas temperature from the dewpoint of 25 K should be observed in the offgas duct.

Preferably in accordance with the invention, the offgas is therefore not cooled below about 81-88° C. in the offgas duct, depending on the respective given conditions. This temperature is consequently the technically achievable minimum, and the internal energy of the offgas cannot be utilized any further. This is therefore an unavoidable loss of energy.

The dewpoint of NH₄NO₃ is relevant because devices for removal of nitrogen oxides from offgases (offgas treatment systems) can have a slip of incompletely degraded nitrogen oxides, usually NO. The NH₃ which is metered into the offgas treatment system as reducing agent is likewise frequently incompletely converted, resulting in slippage of small amounts of NO and NH₃. By virtue of the cooling of the offgas in the offgas duct, the temperature may go below the dewpoint of NH₄NO₃, which can precipitate on the tubes of a heat exchanger. This precipitation constitutes a risk to the safe operation of the system since it is shock-sensitive and can react explosively. The table shows the dewpoints of NH₄NO₃ at various typical residual contents of NO and NH₃ in the offgas:

| | | | | | |
|---|---|---|---|---|---|
| Pressure | [bar a] | 1.00 | 1.00 | 1.00 | 1.00 |
| Residual NH₃ | [ppmv v] | 10 | 10 | 50 | 10 |
| Residual NOₓ | [ppmv v] | 10 | 10 | 10 | 50 |
| NO₂/NO ratio | | 1 | 9 | 1 | 1 |
| Dewpoint of NH₄NO₃ | [° C.] | 71 | 79 | 79 | 79 |

In order to attain the critical temperature for precipitation of NH₄NO₃, the gas flow does not necessarily have to attain or fall below this temperature; even the wall temperature of the tube of a heat exchanger can be sufficient and lead to precipitation of NH₄NO₃. Since the combustion device requires combustion air, which is typically sucked in at ambient temperature, there is a risk of precipitation of NH₄NO₃ on the tubes of a heat exchanger for preheating of combustion air under customary operating conditions.

In contrast to the dewpoint of H₂O, observation of a minimum temperature for the offgas is therefore not an adequate solution. In order to avoid the risk of precipitation of NH₄NO₃, the apparatus for removing nitrogen oxides (offgas treatment system) should be operated in accordance with the invention such that the slip either of NO_{X} or NH₃, or ideally both, is reduced to a maximum of 1 ppmv.

This can be achieved in accordance with the invention by a suitable reaction regime in the chemical reduction of NO_{X} with NH₃, and preferably with a reactor for postoxidation of NH₃ with residual oxygen from the offgas.

Catalytic Decomposition of NH₃ to H₂ and N₂:

The catalytic decomposition of NH₃ proceeds thermally in principle, but is accelerated by the use of an NH₃ decomposition catalyst. According to the invention, the catalytic decomposition of NH₃ can be conducted under various conditions using various NH₃ decomposition catalysts and with various interconnections with different reactor types.

According to the invention, the catalytic decomposition of NH₃ is preferably effected by supplying heat in the presence of an NH₃ decomposition catalyst. Important parameters for the catalytic decomposition of NH₃ are the type of NH₃ decomposition catalyst, the reaction temperature and the reaction pressure.

Useful NH₃ decomposition catalysts in accordance with the invention include various materials. The reaction temperature at which the catalytic decomposition of NH₃ proceeds is determined in particular by the choice of the NH₃ decomposition catalyst.

Suitable methods of thermal and/or catalytic decomposition of NH₃ to N₂ and H₂ are known to a person skilled in the art. Suitable catalysts for the catalytic decomposition of NH₃ to N₂ and H₂ are, for example, Al₂O₃- or SiO₂-supported Ru, MgAl₂O₄-supported Fe, Co, Ni, Cu or Ru, or Co₃Mo₃N (A. Boisen et al., Journal of Catalysis 230 (2005) 309-312; I. Lucentini et al., Ind. Eng. Chem. Res. 2021, 60, 18560-18611; H. J. Lee et al., Catalysts 2022, 12, 1203).

In preferred embodiments of the invention, a nickel-based NH₃ decomposition catalyst is used. The reaction temperature and the reaction pressure determine the equilibrium conversion. At 900° C. and a pressure of 20 bar, the decomposition of NH₃ proceeds nearly quantitatively. At 650° C., the conversion of NH₃ is about 98.5%, and at 500° C. only about 95%.

In preferred embodiments, reaction temperatures in the range from about 550° C. to about 900° C., preferably about 550° C. to about 700° C. are established, so as to achieve a high conversion.

In other preferred embodiments, reaction temperatures in the range from about 600° C. to about 900° C., preferably about 600° C. to about 700° C. are established, so as to achieve a high conversion.

In terms of energy balance and conversion, optimum reaction temperatures are in the range from about 630° C. to 640° C. Nickel-based NH₃ decomposition catalysts are advantageous in spite of the comparatively high reaction temperature. Because of the high conversion, the remaining residual content of undecomposed NH₃ in the product gas is comparatively low, and so it is preferable to dispense with any separate separation of undecomposed NH₃ for recovery thereof. Instead, the combined separation of N₂ and undecomposed NH₃ from the product gas is then combined by pressure swing adsorption in the course of purification of H₂.

The NH₃ decomposition catalyst preferably comprises supported nickel. Preferred support materials are selected from the group consisting of Al₂O₃, MgO, SiO₂, mesoporous SiO₂ (e.g. MCF-17, MCM-41, SBA-15), zeolite (e.g. HY, H-ZSM-5), BaMnO₃, BaTiO₃, BaZrO₃, CaMnO₃, CaTiO₃, CaZrO₃, CeO₂, Gd₂O₃, GdAlO₃, KNbO₃, La₂O₃, LaAlO₃, MnO₂, NaNbO₃, Nb₂O₅, Sm₂O₃, SmAlO₃, SrMnO₃, SrTiO₃, SrZrO₃, TiO₂, Y₂O₃, ZrO₂, carbon (e.g. CNTs, SWCNTs, AX-21, MSC-30, MESO-C, GNP, activated carbon, graphene, graphene oxide), attapulgite, hydrocalumite, sepiolite, and mixtures thereof.

In other preferred embodiments of the invention, a ruthenium-based NH₃ decomposition catalyst is used. For this purpose, preference is given in accordance with the invention to reaction temperatures in the range from about 450° C. to about 500° C., although somewhat lower conversions of about 95%, for example, can be achieved, such that the remaining residual content of undecomposed NH₃ in the product gas is greater.

Alternatively, it is optionally also possible to use other NH₃ decomposition catalysts at even lower reaction temperatures. The lower the reaction temperature, the lower the conversion and the more undecomposed NH₃ has to be separated from the product gas and recycled.

According to the invention, the reaction pressure is preferably about 15 bara to about 25 bara. The stoichiometry of the reaction (2 NH₃→N₂+3 H₂) increases the volume, and therefore an elevated reaction pressure fundamentally has an adverse effect on conversion. On the other hand, it is advisable to operate the entire process at higher pressures in order to limit the container volume and hence capital costs. At a reaction pressure of only 1 bar, conversions of more than 99% would be achievable at reaction temperatures above 400° C. However, since a reaction pressure of 1 bar is useful only for the smallest systems, the system of the invention is preferably operated at a higher reaction pressure, even if a certain loss in conversion must be accepted as a result.

The reaction pressure is defined in particular by the execution of the purification of H₂. The pressure swing absorption (PSA) preferred in accordance with the invention for purification of H₂ can preferably be operated effectively in accordance with the invention at a pressure in the range of about 15 bar to about 25 bar. The pressure of the product gas on departure from the NH₃ decomposition device is preferably in the range of about 15 to about 25 bara, more preferably about 18 bara to about 22 bara, even more preferably about 19 bara to about 21 bara. In this way, a good balance is found between the requirements of pressure swing adsorption on the one hand and the conversion achieved on the other hand.

The catalytic decomposition of NH₃ can in principle proceed in different reactor types.

In an adiabatic reaction regime, the internal heat of the reaction gas is used as energy source for the reaction. Suitable reactors for this purpose are autothermal reformers and secondary reformers which work with internal energy generation. Combustion air is added to the process gas and a portion of the reaction gas is combusted in order to increase the temperature such the temperature at the reactor exit is that desired. A disadvantage is the presence of the water formed in the combustion in the process gas, which has to be removed by condensation. A portion of the undecomposed NH₃ then dissolves in the condensed water and is lost. Moreover, the high temperatures lead to formation of significant amounts of nitrogen oxides.

According to the invention, these disadvantages are avoided in that the product gas is preferably physically separated from the combustion gas and the offgas formed therefrom. The product gas is formed in the NH₃ decomposition device of the invention in the firing system by decomposition of NH₃ and leaves the NH₃ decomposition device, preferably via a dedicated outlet. The combustion gas is combusted together with combustion air in the combustion device of the firing system, and the offgas formed leaves the combustion device preferably also via a dedicated outlet, preferably into an offgas duct. Product gas and offgas are preferably not mixed with each other, but remain physically separated from one another. Heat of combustion formed in the combustion of the combustion gas flows into the NH₃ decomposition device as a heat flow, hence providing the heat required for the maintenance of the endothermic catalytic decomposition of NH₃.

Preferably, the catalytic decomposition of NH₃ is performed isothermally, quasi-isothermally or in a mixed isothermal and adiabatic process regime. In an isothermal reaction regime, the temperature of the gas remains largely unchanged.

In preferred embodiments of the invention, the catalytic decomposition of NH₃ is effected in a reactor analogous to a primary reformer. For this purpose, the reactor comprises both the NH₃ decomposition device of the invention and the combustion device of the invention.

For this purpose, the NH₃ decomposition catalyst is preferably disposed in at least one tube through which NH₃ flows, more preferably at least two tubes, even more preferably at least three tubes. The at least one tube contains the NH₃ decomposition catalyst. NH₃ preferably passes through the at least one tube from the top downward. In a physically separated combustion chamber, the combustion gas combusted is preferably a mixture of NH₃ and H₂ together with combustion air (combustion device). The N₂ formed in addition to H₂ in the catalytic decomposition of NH₃ is inert and serves as an additional heat carrier. The heat of combustion generated by the combustion process in the combustion chamber of the combustion device is used to heat up the NH₃ decomposition device, preferably the tube(s) through which the NH₃ to be decomposed is passed. For this purpose, a heat flow is directed from the combustion device into the NH₃ decomposition device.

In particularly preferred embodiments of the invention, NH₃ is preheated prior to entry into the NH₃ decomposition device of the invention. As a result of this preheating, the temperature of the NH₃ prior to entry into the NH₃ decomposition device of the invention is preferably at least about 600° C., preferably at least about 630° C. The temperature of the NH₃ is preferably at most about 850° C., preferably at most about 820° C. More preferably, the temperature of the NH₃ on entry into the NH₃ decomposition device of the invention is about 780° C. to 820° C., preferably about 800° C. In this case, the NH₃ decomposition device of the invention and the combustion device of the invention preferably form a reactor designed analogously to a primary reformer. The NH₃ decomposition catalyst is preferably nickel-based. In preferred embodiments, the reaction temperature in the NH₃ decomposition device, preferably in the at least one tube containing the NH₃ decomposition catalyst and through which the NH₃ is conducted, is preferably about 630° C. to about 670° C., preferably about 650° C. In other preferred embodiments, this temperature is about 660° C. to 700° C., preferably about 680° C. The product gas leaves the reactor (the NH₃ decomposition device) preferably at a pressure of about 15 bara to about 25 bara, preferably about 20 bara.

In further particularly preferred embodiments of the invention, the decomposition of NH₃ is effected in two stages in two NH₃ decomposition devices through which the flow passes successively. In a preliminary reactor (first NH₃ decomposition device), only a portion of the NH₃ is decomposed at first. The remaining decomposition of NH₃ up to the maximum conversion obtained is then effected in a second NH₃ decomposition device. Preferably, for this purpose, the second NH₃ decomposition device together with the combustion device of the invention forms a reactor described in detail above, of analogous design to a primary reformer.

The NH₃ is preferably preheated before being introduced into the preliminary reactor (first NH₃ decomposition device). The temperature of the NH₃ after heating and on entry into the preliminary reactor (first NH₃ decomposition device) is about 620° C. to about 680° C., preferably about 650° C. The preheated NH₃ then enters the preliminary reactor which contains NH₃ decomposition catalyst and in which some degree of catalytic decomposition of NH₃ to N₂ and H₂ takes place. An intermediate product gas is formed, which still contains considerable residual amounts of undecomposed NH₃, but also N₂ and H₂ that have already formed. As a result of the endothermic decomposition of NH₃, the intermediate product gas preferably cools down.

Preferably, the conversion of decomposed NH₃ in the preliminary reactor is at most 30%, more preferably at most 25%, even more preferably at most 20%, of the overall conversion achieved.

Preferably, the conversion of decomposed NH₃ in the preliminary reactor is at least 10%, more preferably at least 15%, of the overall conversion achieved.

After leaving the preliminary reactor, the intermediate product gas is preferably reheated before it enters the downstream, second NH₃ decomposition device.

In preferred embodiments, the temperature of the intermediate product gas after reheating and on entry into the second NH₃ decomposition device is about 550° C. to about 680° C., more preferably about 580° C.

In other preferred embodiments, the temperature of the intermediate product gas after reheating and on entry into the second NH₃ decomposition device is about 620° C. to about 680° C., more preferably about 650° C.

In the second NH₃ decomposition device, the residual decomposition of NH₃ then proceeds up to the overall conversion achieved.

In this preferred embodiment of the invention, for the same overall conversion, the temperature of the intermediate product gas on entry into the preliminary reactor (first NH₃ decomposition device) and on entry into the second NH₃ decomposition device may each be lower than the temperature of the NH₃ in the case of single-stage decomposition of NH₃, i.e. in the case of passage through only a single NH₃ decomposition device. Because of the lower temperature, there is a lower degree of nitriding of the pipelines, which increases the service life of the steel that comes into contact with NH₃.

The NH₃ decomposition catalyst in the first NH₃ decomposition device (preliminary reactor) is preferably the same as in the second NH₃ decomposition device.

Properties of the Offgas on Departure from the Firing System:

The combustion of combustion gas with combustion air generates an offgas in the firing system, preferably the combustion device, and the offgas leaves the firing system, preferably into an offgas duct.

In preferred embodiments, the offgas on departure from the firing system, preferably the combustion device, and on entry into the offgas duct has one or more of the following properties:

In preferred embodiments, the offgas has an NO_{X} content greater than the N₂O content. The NO_{X} content is preferably at least twice as high, more preferably at least three times as high, even more preferably at least four times as high, most preferably at least seven times as high and in particular at least ten times as high as the N₂O content. Preferably, the molar ratio of NO_{X}:N₂O is more than 10:1, more preferably at least 20:1, even more preferably at least 30:1, most preferably at least 40:1, and in particular at least 50:1.

In preferred embodiments, the offgas has an NO content greater than the N₂O content. The NO content is preferably at least twice as high, more preferably at least three times as high, even more preferably at least four times as high, most preferably at least seven times as high and in particular at least ten times as high as the N₂O content.

In preferred embodiments, the offgas has an NO₂ content greater than the N₂O content. The NO₂ content is preferably at least twice as high, more preferably at least three times as high, even more preferably at least four times as high, most preferably at least seven times as high and in particular at least ten times as high as the N₂O content.

Preferably, the offgas has an NO_{X} content of at least 10 ppmv, preferably at least 20 ppmv, more preferably at least 30 ppmv, even more preferably at least 40 ppmv, and in particular at least 50 ppmv.

Preferably, the offgas has an NO_{X} content of at least 75 ppmv, preferably at least 100 ppmv, more preferably at least 150 ppmv, even more preferably at least 200 ppmv, and in particular at least 250 ppmv.

Preferably, the offgas has an NO_{X} content of at least 500 ppmv, preferably at least 1000 ppmv, more preferably at least 2000 ppmv, even more preferably at least 3000 ppmv, and in particular at least 3500 ppmv.

Preferably, the offgas has an N₂O content of at least 10 ppmv, preferably at least 20 ppmv, more preferably at least 30 ppmv, even more preferably at least 40 ppmv, and in particular at least 50 ppmv.

Preferably, the offgas has an N₂O content of at least 75 ppmv, preferably at least 100 ppmv, more preferably at least 150 ppmv, even more preferably at least 200 ppmv, and in particular at least 250 ppmv.

Preferred offgases have an NO_{X} content in the range from 1500 to 3000 ppmv, preferably 2000 to 3000 ppmv, and an N₂O content in the range from 20 to 100 ppmv.

In preferred embodiments, the offgas has an H₂O content of more than 4.0% by volume; preferably at least 5.0% by volume, more preferably at least 6.0% by volume, even more preferably at least 7.0% by volume, most preferably at least 8.0% by volume, and in particular at least 9.0% by volume.

In further preferred embodiments, the offgas has an H₂O content of at least 10% by volume; preferably at least 12% by volume, more preferably at least 14% by volume, even more preferably at least 16% by volume, most preferably at least 18% by volume, and in particular at least 20% by volume.

In preferred embodiments, the offgas has an H₂O content in the region of 10±8% by volume; preferably in the region of 10±7% by volume, more preferably in the region of 10±6% by volume, even more preferably in the region of 10±5% by volume, most preferably in the region of 10±4% by volume, and especially in the region of 10±3% by volume.

In preferred embodiments, the offgas has an H₂O content in the region of 15±8% by volume; preferably in the region of 15±7% by volume, more preferably in the region of 15±6% by volume, even more preferably in the region of 15±5% by volume, most preferably in the region of 15±4% by volume, and especially in the region of 15±3% by volume.

In preferred embodiments, the offgas has an H₂O content in the region of 20±8% by volume; preferably in the region of 20±7% by volume, more preferably in the region of 20±6% by volume, even more preferably in the region of 20±5% by volume, most preferably in the region of 20±4% by volume, and especially in the region of 20±3% by volume.

In preferred embodiments, the offgas has an H₂O content in the region of 25±8% by volume; preferably in the region of 25±7% by volume, more preferably in the region of 25±6% by volume, even more preferably in the region of 25±5% by volume, most preferably in the region of 25±4% by volume, and especially in the region of 25±3% by volume.

In preferred embodiments, the offgas has an H₂O content in the region of 30±8% by volume; preferably in the region of 30±7% by volume, more preferably in the region of 30±6% by volume, even more preferably in the region of 30±5% by volume, most preferably in the region of 30±4% by volume, and especially in the region of 30±3% by volume.

Preferably, the offgas has an N₂ content of at most 950% by volume, preferably at most 90% by volume, more preferably at most 85% by volume, even more preferably at most 80% by volume, most preferably at most 75% by volume, and in particular at most 70% by volume.

Preferably, the offgas has an N₂ content of at least 40% by volume; preferably at least 50% by volume, more preferably at least 60% by volume, even more preferably at least 70% by volume, most preferably at least 80% by volume, and in particular at least 90% by volume.

Preferably, the offgas on departure from the firing system, preferably the combustion device, is at a temperature T₁ of at least 500° C., more preferably at least 600° C., even more preferably at least 700° C., most preferably at least 800° C., and in particular at least 900° C.

Preferably, the offgas on departure from the firing system, preferably the combustion device, is at a temperature T₁ of at most 1100° C., more preferably at most 1000° C., even more preferably at most 900° C., most preferably at most 800° C., and in particular at most 700° C.

Preferably, the offgas on departure from the firing system, preferably the combustion device, is at a pressure of at most 1.5 bar; preferably atmospheric pressure.

Preferably, the offgas on departure from the firing system, preferably the combustion device, has a degree of oxidation of NO_{X} of at least 10%, more preferably at least 20%, even more preferably at least 30%, most preferably at least 40%, and in particular at least 50%.

Preferably, the offgas on departure from the firing system, preferably the combustion device, has a degree of oxidation of NO_{X} of at most 90%, more preferably at most 80%, even more preferably at most 70%, most preferably at most 60%, and in particular at most 50%.

Preferably, the offgas on departure from the firing system, preferably the combustion device, has an O₂ content of less than 2.0% by volume.

### Step (b):

In the optional and preferred step (b) of the method of the invention, the temperature T₁ of the offgas is preferably measured on departure from the firing system, preferably of the combustion device, and altered with suitable devices, in order that the offgas on entry into the offgas treatment system is at a temperature T₂ optimized under the given conditions for performance of steps (d) and (e) of the method of the invention within the offgas treatment system. The optimized temperature depends on the chosen configuration of steps (d) and (e), i.e. the type and sequence of the individual process steps for N₂O reduction and NO_{X} reduction and in particular the type of catalyst materials used for the N₂O decomposition catalyst and/or N₂O reduction catalyst and the NO_{X} reduction catalyst.

Suitable devices for altering the temperature of the offgas are known to a skilled person and include in particular heat exchangers, which may be configured, for example, as plate heat exchangers or tube heat exchangers.

In the optional and preferred step (b) of the method of the invention, the offgas is preferably cooled in at least one heat exchanger disposed downstream of the firing system in flow direction of the offgas.

The offgas of a tubular reactor of analogous design to a primary reformer contains considerable amounts of internal energy. The process for generating H₂ from NH₃ requires the supply of process streams at high temperatures. According to the invention, the offgas is used for preheating of these process streams, while being cooled. This has the advantage of reducing the demand of the plant for combustion gas and increasing the yield of hydrogen product.

The effectiveness of different variants of the process regime can be measured by the hydrogen yield. This is defined as follows:

$${Y}_{{H}_{2}} = \frac{{\dot{n}}_{{H}_{2} , product}}{1.5 \times {\dot{n}}_{N {H}_{3} , feed}}$$

The hydrogen yield of the plant refers to the ratio of the molar flow rate of H₂ that leaves the plant as product compared to the molar flow rate of NH₃ that enters the plant in the feed stream, including any branch for the combustion gas.

A number of process streams can be used for absorption of heat from the offgas:
preheating and evaporation of NH₃ (also possible indirectly);
further heating of evaporated NH₃ and of intermediate product gas;
heating of combustion air;
preheating of boiler feed water;
heating of water;
heating of combustion gas;
evaporation of boiler feed water to produce water vapor;
superheating of water vapor;
auxiliary streams (heat transfer medium for preheating of NH₃ or for the evaporator of an NH₃ desorption unit).

The target temperature of the process streams to be heated generally defines the sequence in which they are heated. High temperature differentials between offgas and heat-absorbing process stream reduce the required size of the heat exchangers.

However, it is advantageous to maintain a minimum degree of temperature differential across all components. This prevents the increase in the temperature differential in a heat exchanger, and hence the reduction in its size is “paid for” with an increase in size of all other heat exchangers. In order to enable an economical design of the heat exchangers in the offgas duct, preferably in accordance with the invention, there is a minimum temperature differential of 45 K between the entry of the hot stream and the exit of the cold stream, or the entry of the cold stream and the exit of the hot stream, depending on which pair of values is smaller.

A further essential factor in the development of an effective solution for the offgas duct of a tubular reactor of analogous design to a primary reformer is the setting of the required temperatures for the unit for removing nitrogen oxides from the offgas.

It is theoretically possible to use the heat of the offgas in numerous different configurations. In a plant for the production of H₂ from NH₃, a further significant heat source is available with the stream of the product gas generated in the NH₃ decomposition device. It is advantageous and preferable in accordance with the invention to use the heat present in the product gas for the following measures for heat integration:
generation of water vapor;
preheating of NH₃;
preheating of H₂O for the production of water vapor; and/or
cooling of the product gas with later thermal integration of the cooling water.

It is also advantageous and preferable in accordance with the invention to use the heat present in the offgas for the following measures for heat integration:
preheating of the NH₃ to the inlet temperature for the NH₃ decomposition device;
preheating of boiler feed water; and/or
preheating of combustion air.

Because of the mechanical limitations of the heat exchangers used in the offgas duct, the required amounts of energy and the temperature profiles of the offgas and process streams to be heated, residual heat that is utilizable but not integratable often remains in the offgas in such configurations.

This is expressed in a high inlet temperature of the offgas into the chimney of the offgas duct. Internal energy present in this stream is lost to the process, and ultimately lowers the yield of H₂.

For reduction of the loss of heat via the offgas and for an increase in the yield of H₂, according to the invention, further integration steps in the offgas duct are possible and preferable:
preheating of NH₃ to the inlet temperature for a first preliminary reactor (preferably adiabatic fixed bed reactor);
preheating of NH₃ to the inlet temperature for a second preliminary reactor (preferably adiabatic fixed bed reactor);
two-stage pre-heating of the combustion air;
preheating of the combustion gas (preferably output from the purification plant for H₂, more preferably offgas from a pressure swing adsorption apparatus or retentate from a membrane unit); and/or
preheating of an auxiliary stream for integration of utilizable residual heat.

Heat exchangers of the invention serve for transfer of heat from one medium to another medium without commixing of the media. For the purposes of the description, in relation to an “A B heat exchanger”, the heat-releasing medium A is mentioned first, followed by the heat-absorbing medium B.

Accordingly, for example, an “offgas NH₃ heat exchanger” is used to release heat present in the offgas to NH₃. For this purpose, the offgas/NH₃ heat exchanger is interconnected correspondingly, i.e. offgas flows through its warmer side, while NH₃ flows through its cooler side. For reasons of simplicity, the nomenclature “NH₃” is used for starting material and for any intermediate product gas which still contains significant amounts of NH₃. Heat exchangers of the same functionality may be numbered for distinguishability, although a particular number does not necessarily mean that all heat exchangers of the same functionality with a lower number must necessarily indeed be present simultaneously. It is accordingly possible, for example, that a second offgas/combustion air heat exchanger is present, while a first offgas/combustion air heat exchanger is not.

Each heat exchanger of the invention may be present independently, possibly as a single heat exchanger of the described design or interconnection, or else optionally as part of a plurality of several, e.g. two or three, directly series-connected heat exchangers of the same functionality of the described design or interconnection. The heat-releasing medium and the heat-absorbing medium are then each the same in the plurality of several heat exchangers of the same functionality. This division of a single heat exchanger into, for example, two series-connected heat exchangers of the same functionality can have structural and/or design advantages.

The offgas leaves the firing system, preferably the combustion device, at a temperature T₁ and is preferably cooled down in step (b) to a temperature T₂ at which the offgas is then transferred into the offgas treatment system. Preferably both the at least one heat exchanger and the offgas treatment system are disposed in an offgas duct.

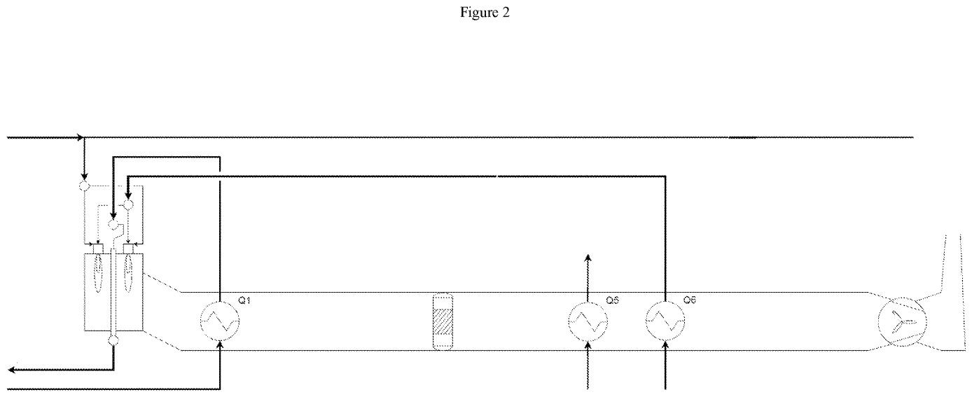

In preferred embodiments, the offgas is cooled in a single heat exchanger disposed downstream of the firing system in flow direction of the offgas (cf. FIG. 2).

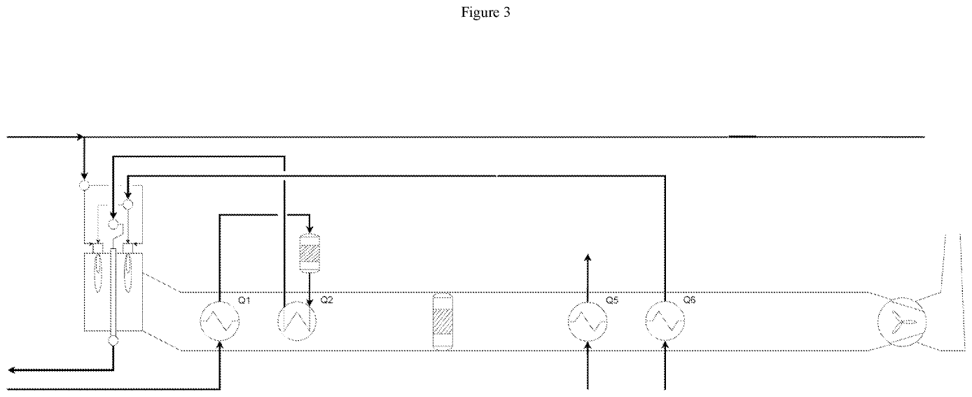

In other preferred embodiments, the offgas is cooled successively in at least two heat exchangers disposed downstream of the firing system in flow direction of the offgas (cf. FIGS. 3, 5 and 6).

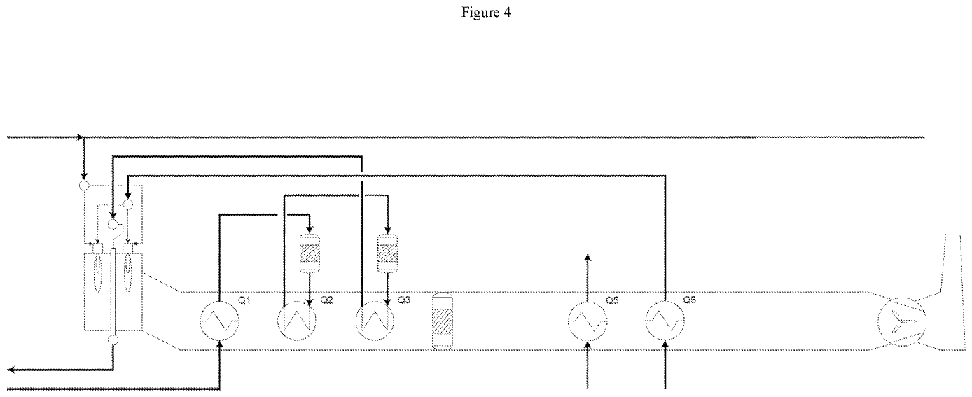

In further preferred embodiments, the offgas is cooled successively in at least three heat exchangers disposed downstream of the firing system in flow direction of the offgas (cf. FIG. 4).

The offgas is cooled in the at least one heat exchanger by release of heat from the offgas to a heat transfer medium.

Preferably in accordance with the invention, the heat transfer medium used is NH₃, which is then supplied to the catalytic decomposition in an NH₃ decomposition device over an NH₃ decomposition catalyst.

In preferred embodiments, in step (b) of the method of the invention, the offgas is cooled in at least one first offgas/NH₃ heat exchanger disposed downstream of the firing system in flow direction of the offgas. In an NH₃ decomposition device which is preferably disposed downstream of the first offgas/NH₃ heat exchanger in flow direction of the NH₃, a catalytic decomposition of the heated NH₃ is effected over an NH₃ decomposition catalyst to produce a product gas. The NH₃ is heated in the first offgas/NH₃ heat exchanger by absorbing heat from the offgas (cf FIG. 2).

In other preferred embodiments, the offgas is cooled in step (b) of the method of the invention
in a first offgas/NH₃ heat exchanger disposed downstream of the firing system in flow direction of the offgas, and
in a second offgas/NH₃ heat exchanger disposed downstream of the first offgas/NH₃ heat exchanger in flow direction of the offgas.

In a first NH₃ decomposition device (preliminary reactor) which is preferably disposed downstream of the first offgas/NH₃ heat exchanger in flow direction of the NH₃, a partial catalytic decomposition of the heated NH₃ is effected over an NH₃ decomposition catalyst to produce an intermediate product gas. The second offgas/NH₃ heat exchanger is preferably disposed downstream of the first NH₃ decomposition device (preliminary reactor) in flow direction of the NH₃.

In a second NH₃ decomposition device (main reactor) which is preferably disposed downstream of the second offgas/NH₃ heat exchanger in flow direction of the NH₃, a catalytic decomposition of the heated NH₃ is effected over an NH₃ decomposition catalyst to produce a product gas.

The NH₃ (or intermediate product gas) is heated in the first offgas/NH₃ heat exchanger and in the second offgas/NH₃ heat exchanger by absorption of heat from the offgas.

The offgas flows first through the first offgas/NH₃ heat exchanger and then through the second offgas/NH₃ heat exchanger.

The NH₃ (or intermediate product gas) first flows through the first offgas/NH₃ heat exchanger and absorbs heat from the offgas therein. Thereafter, the heated NH₃ flows into the first NH₃ decomposition device, in which a partial catalytic decomposition of the heated NH₃ is effected over an NH₃ decomposition catalyst to produce an intermediate product gas. The intermediate product gas thus formed, which still contains considerable amounts of undecomposed NH₃, then flows through the second offgas/NH₃ heat exchanger and absorbs heat from the offgas again therein. Finally, the heated intermediate product gas flows into the second NH₃ decomposition device, in which a catalytic decomposition of the heated NH₃ is effected over an NH₃ decomposition catalyst to produce a product gas (cf FIGS. 3, 5 and 6).

In further preferred embodiments, the offgas is cooled in step (b) of the method of the invention
in a first offgas/NH₃ heat exchanger disposed downstream of the firing system in flow direction of the offgas,
in a second offgas/NH₃ heat exchanger disposed downstream of the first offgas/NH₃ heat exchanger in flow direction of the offgas, and
in a third offgas/NH₃ heat exchanger disposed downstream of the second offgas/NH₃ heat exchanger in flow direction of the offgas.

In a first NH₃ decomposition device (first preliminary reactor) which is preferably disposed downstream of the first offgas/NH₃ heat exchanger in flow direction of the NH₃, a partial catalytic decomposition of the heated NH₃ is effected over an NH₃ decomposition catalyst to produce a first intermediate product gas. The second offgas/NH₃ heat exchanger is preferably disposed downstream of the first NH₃ decomposition device (first preliminary reactor) in flow direction of the NH₃.

In a second NH₃ decomposition device (second preliminary reactor) which is preferably disposed downstream of the second offgas/NH₃ heat exchanger in flow direction of the NH₃, a further partial catalytic decomposition of the heated NH₃ (first intermediate product gas) is effected over an NH₃ decomposition catalyst to produce a second intermediate product gas. The third offgas/NH₃ heat exchanger is preferably disposed downstream of the second NH₃ decomposition device (second preliminary reactor) in flow direction of the NH₃.

In a third NH₃ decomposition device (main reactor) which is preferably disposed downstream of the third offgas/NH₃ heat exchanger in flow direction of the NH₃, a catalytic decomposition of the heated NH₃ (second intermediate product gas) is effected over an NH₃ decomposition catalyst to produce a product gas.

The NH₃ (or the first intermediate product gas or the second intermediate product gas) is heated in the first offgas/NH₃ heat exchanger, in the second offgas/NH₃ heat exchanger and in the third offgas/NH₃ heat exchanger by absorption of heat from the offgas.

The offgas flows first through the first offgas/NH₃ heat exchanger, then through the second offgas/NH₃ heat exchanger, and then through the third offgas/NH₃ heat exchanger.

The NH₃ (or the first intermediate product gas or the second intermediate product gas) first flows through the first offgas/NH₃ heat exchanger and absorbs heat from the offgas therein. Thereafter, the heated NH₃ flows into the first NH₃ decomposition device, in which a partial catalytic decomposition of the heated NH₃ is effected over an NH₃ decomposition catalyst to produce a first intermediate product gas. The first intermediate product gas thus formed, which still contains considerable amounts of undecomposed NH₃, then flows through the second offgas/NH₃ heat exchanger and absorbs heat from the offgas again therein. Thereafter, the heated first intermediate product gas flows into the second NH₃ decomposition device, in which a further partial catalytic decomposition of the heated NH₃ is effected over an NH₃ decomposition catalyst to produce a second intermediate product gas. The second intermediate product gas thus formed, which still contains considerable amounts of undecomposed NH₃, then flows through the third offgas/NH₃ heat exchanger and absorbs heat from the offgas again therein. Finally, the heated second intermediate product gas flows into the third NH₃ decomposition device, in which a catalytic decomposition of the heated NH₃ is effected over an NH₃ decomposition catalyst to produce a product gas (cf FIG. 4).

The offgas is preferably cooled down in step (b) to a temperature T₂ at which the offgas is then transferred into the offgas treatment system.

Preferably, the temperature T₂ is at least 360° C., more preferably at least 370° C., even more preferably at least 380° C., most preferably at least 390° C., and in particular at least 400° C.

Preferably, the temperature T₂ is at most 500° C., more preferably at most 480° C., even more preferably at most 460° C., most preferably at most 440° C., and in particular at most 420° C.

The temperature T₂ is preferably in the range from 400 to 450° C., more preferably 400 to 420° C. The ideal temperature T₂ depends on the NO_{X} inlet concentration and the associated exothermicity. For every 1000 ppmv of NO_{X}, a ΔT of around 12 K is to be expected. If the offgas contains, for example, 7000 ppmv of NO_{X}, this would correspond to around 80-90 K. The outlet temperature should not be too high because the stability of the catalysts in the offgas treatment system is a critical factor owing to the high water content of the offgas.

In the case of very high NO_{X} concentrations, preference is given in accordance with the invention to providing a multistage arrangement of catalyst beds with multistage NH₃ feeding and intermediate heat exchangers. In this way, excessive temperatures are avoided. Moreover, this enables (for the same catalyst volume) distinctly higher breakdown of NO_{X} and N₂O.

Preferably, the offgas on entry into the offgas treatment system is at a temperature T₂ which, in relative terms, is at least 20° C., preferably at least 40° C., more preferably at least 60° C., even more preferably at least 80° C., most preferably at least 100° C., and in particular at least 120° C., below the temperature T₁ of the offgas on departure from the firing system, preferably the combustion device.

Preferably, the temperature T₂, in relative terms, is at least 50° C. lower than the temperature T₁, more preferably at least 100° C., even more preferably at least 150° C., most preferably at least 200° C. and in particular at least 250° C.

### Step (c):

In step (c) of the method of the invention, the optionally cooled offgas is transferred to an offgas treatment system, i.e. from the firing system from step (a) or from the at least one heat exchanger from the optional and preferred step (b) to an offgas treatment system.

In step (c) of the method of the invention, the offgas which has left the firing system, preferably the combustion device, and optionally been cooled in step (b) is transferred to an offgas treatment system.

This can be effected, for example, by means of pipelines connecting the outlet of the firing system, preferably the combustion device, to the inlet of the offgas treatment system. This connection is preferably established via an offgas duct. Since the method of the invention is preferably performed at atmospheric pressure, no special requirements are typically placed on such pipelines or on the walls of the offgas duct with regard to possible compressive stress.

However, the pipelines or walls of the offgas duct should be able to withstand the temperatures of the offgas on departure from the firing system, preferably the combustion device, or on entry into the offgas treatment system.

Steps (d) and (e) of the method of the invention are effected in the offgas treatment system of the invention. For this purpose, the offgas treatment system is equipped with the N₂O decomposition catalyst for step (d₁) and/or with the N₂O reduction catalyst for step (d₂), and with the NO_{X} reduction catalyst for step (e).

If the offgas treatment system of the invention additionally comprises at least one further catalyst, or one of the aforementioned N₂O reduction, N₂O decomposition or NO_{X} reduction catalysts fulfills at least one further functionality, at least one of the following steps (g₁) to (g₄) is preferably additionally effected in the offgas treatment system of the invention:
(g₁) cooling the offgas in at least one heat exchanger which is preferably disposed within the offgas treatment system; preferably upstream of the NH₃ oxidation catalyst in flow direction of the offgas;
(g₂) reducing the NH₃ content in the offgas by oxidation with an oxidizing agent over an NH₃ oxidation catalyst; where the oxidizing agent preferably comprises O₂;
(g₃) reducing the HCN content in the offgas by hydrolysis and oxidation of the hydrolyzates with an oxidizing agent over an HCN breakdown catalyst; where the oxidizing agent preferably comprises NO_{X} and/or N₂O; and
(g₄) reducing the CO content in the offgas by chemical oxidation with an oxidizing agent over a CO oxidation catalyst; where the oxidizing agent preferably comprises 02.

### Step (d):

In step (d) of the method of the invention, the N₂O content in the offgas is reduced. This can be effected by (d₁) decomposition of N₂O over an N₂O decomposition catalyst and/or (d₂) chemical reduction of N₂O with reducing agent over an N₂O reduction catalyst.

The decomposition of N₂O forms N₂ and O₂ according to the following empirical reaction:

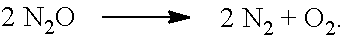

Decomposition of N₂O therefore means breakdown to N₂ and O₂. An “N₂O decomposition catalyst” in the context of the invention catalyzes the decomposition of N₂O. The achievable breakdown of N₂O by catalytic decomposition depends not only on the type, i.e. the chemical nature and physical configuration, of the N₂O decomposition catalyst and the pressure and temperature conditions that exist, but also in particular on the chosen space velocity, i.e. the ratio of offgas volume flow rate to catalyst volume. However, the catalytic activity of an N₂O decomposition catalyst need not be restricted exclusively to this reaction. For instance, it is quite possible and indeed preferred in accordance with the invention that the N₂O decomposition catalyst can additionally also catalyze further reactions, for example the chemical reduction of N₂O and/or the chemical reduction of NO_{X}. Whether such further reactions do indeed take place depends on the conditions of the individual case, in particular the type of catalyst, and the kinetics of any processes that take place in parallel, for example on the presence or amount of the reducing agent and the presence or amount of other coreactants.

The chemical reduction of N₂O with reducing agent forms different reaction products depending on the reducing agent.

In the case of the NH₃ reducing agent that is preferred in accordance with the invention, the chemical reduction of N₂O forms N₂ and H₂O in particular, for example as follows:

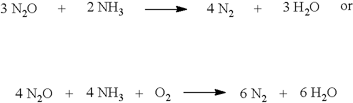

or else in joint reduction with NO as follows:

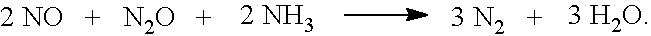

In the case of hydrocarbons, which are likewise preferred in accordance with the invention as reducing agent, the chemical reduction of N₂O forms CO and H₂O in particular, for example as follows:

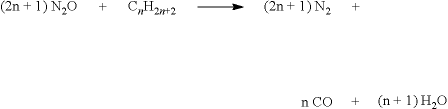

or else CO₂ and H₂O as follows:

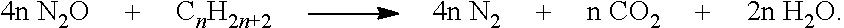

CO is likewise preferred in accordance with the invention as reducing agent. It can react further with N₂O to give CO₂, for example according to:

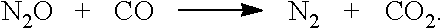

An “N₂O reduction catalyst” in the context of the invention catalyzes the chemical reduction of N₂O with reducing agent. However, the catalytic activity of an N₂O reduction catalyst need not be restricted exclusively to this reaction. For instance, it is quite possible and indeed preferred in accordance with the invention that the N₂O reduction catalyst can additionally also catalyze further reactions, for example the decomposition of N₂O and/or the chemical reduction of NO_{X}. Whether such further reactions do indeed take place depends on the conditions of the individual case, in particular the type of catalyst, and the kinetics of any processes that take place in parallel, for example on the presence or amount of the reducing agent and the presence or amount of other coreactants.

### Step (e):

In step (e) of the method of the invention, the NO_{X} content in the offgas is reduced by chemical reduction of NO_{X} with reducing agent over an NO_{X} reduction catalyst.

Preference is given here to those NO_{X} reduction catalysts which as far as possible enable the selective catalytic reduction (SCR) of the nitrogen oxides present in the offgas, in particular of NO_{X}, meaning that the NO_{X} reduction catalysts primarily catalyze the oxidation of NH₃ with NO_{X} and do not catalyze, or only secondarily catalyze, the oxidation of NH₃ with any free oxygen (O₂) present in the offgas.

The chemical reduction of NO_{X} with reducing agent forms different reaction products depending on the reducing agent. In the case of the NH₃ reducing agent that is preferred in accordance with the invention, the chemical reduction of NO_{X} forms N₂ and H₂O in particular, depending on the type of NO_{X} reduction catalyst and the ratio of NO to NO₂, for example as follows:

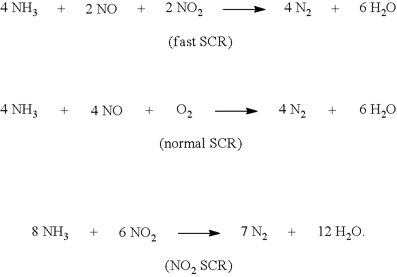

Common selective catalytic reduction is referred to as fast SCR and is generally much faster than normal SCR or NO₂ SCR.

An “NO_{X} reduction catalyst” in the context of the invention catalyzes the chemical reduction of NO_{X} with reducing agent. However, the catalytic activity of an NO_{X} reduction catalyst need not be restricted exclusively to this reaction. For instance, it is quite possible and indeed preferred in accordance with the invention that the NO_{X} reduction catalyst can additionally also catalyze further reactions, for example the decomposition of N₂O, the chemical reduction of N₂O and/or the establishment of the NO_{X} equilibrium or else the selective oxidation of excess NH₃ with free O₂. Whether such further reactions do indeed take place depends on the conditions of the individual case and the kinetics of any processes that take place in parallel, for example on the presence or amount of the reducing agent and the presence or amount of other coreactants.

### Catalysts

N₂O decomposition catalysts are known per se, and it is possible to use a wide variety of substance classes. Preference is given to N₂O decomposition catalysts which have a high catalytic activity, for example, in the temperature range from 350 to 600° C. for decomposition of N₂O to N₂ and O₂.

Examples of N₂O decomposition catalysts that are preferred in accordance with the invention are metal-laden zeolite catalysts, for example copper- or cobalt- or in particular iron-laden zeolite catalysts, precious metal catalysts or else transition metal oxide catalysts, for example cobalt oxide-containing catalysts. Examples of suitable catalysts are described inter alia by Kapteijn et al. in Appl. Cat. B: Environmental 9 (1996), 25-64, in U.S. Pat. No. 5,171,553, in Actes du 2ieme Congres International sur la Catalyse, Technip, Paris 1961, 1937-1953, and in WO-A-01/58,570. When iron-laden zeolite catalysts are used in the first catalyst bed, the NO_{X} still present in the gas, as expected, accelerates the desired N₂O decomposition by an activating effect (cocatalytic effect), as described for different N₂O/NO_{X} ratios by Kogel et al. in Catal. Comm. 2 (2001) 273-276.

Further examples of N₂O decomposition catalysts that are preferred in accordance with the invention are catalysts having activity for N₂O decomposition which is distinctly limited by the presence of NO_{X}. Such N₂O decomposition catalysts are also referred to as “NO_{X}-sensitive N₂O decomposition catalysts” for the purposes of the description. These catalysts contain one or more catalytically active compounds of elements selected from groups 5 to 11 of the Periodic Table of Elements (PTE). Especially preferred are compounds of the elements of group 9 to 11 of the PTE. Among these, preference is given in turn to the compounds of the elements Co, Pt, Pd, Ir, Rh, Ni and/or Cu, preferably Co, Rh, Ni and/or Cu, and here in particular Co or Rh. Preference is given to an N₂O decomposition catalyst based on precious metals, which are preferably supported on refractory oxides, or based on mixtures of transition metal oxides, in particular mixed oxides or simple transition metal oxides, in each case either in supported form or preferably as unsupported catalysts.

The catalytically active compounds themselves may be metallic and/or oxidic compounds, the latter either in the form of singular oxides or in the form of binary, ternary or polynary mixed oxides of different structure types, for example perovskites or spinels. These are described, for example, in Catalysis Letters 35 (1995) 372-382, Applied Catalysis 73 (1991) 165-171, Catal. Rev.-Sci. Eng.; 34(4), 409-425 (1992) or Actes du 2ieme Congres International sur la Catalyse 97 (1961) 1937-1953. Mixtures of different catalytically active compounds may also be used. Examples of particularly preferred catalytically active compounds are metallic rhodium, rhodium oxides, such as RhO₂, or Rh₂O₃, CoO, Co₂O₃, Co-containing spinels, such as Co₃O₄, CuₓCo₃₋ₓO₄, or Co-containing perovskites such as LaCoO₃ or Co-containing perovskites substituted at A and B sites.

The catalytically active compounds may be present in the catalysts in pure form or may be applied to or mixed with suitable support materials. In the former case, they are what are called unsupported catalysts which, in addition to active compounds, may contain additives known to the skilled person, such as binders or other production-related additives such as plasticizers, pore formers, fiber reinforcements or compression aids.

The methods of producing such catalysts are known to the skilled person. In the case of “supported catalysts”, the catalytically active compounds have been applied to the support material. As a result, the catalytically active compound undergoes dispersion and stabilization against both mechanical and thermal stress. The methods of producing such catalysts are likewise known to the skilled person.

The support materials are preferably refractory oxides, such as SiO₂, TiO₂, ZrO₂ or Al₂O₃, or mixtures of two or more of these, or materials which themselves have a certain catalytic activity for N₂O decomposition, such as MgO, zeolites, hydrotalcites or mixtures of two or more of these. Preference is given to using catalysts which contain essentially no zeolites, if any, preferably less than 15% by weight of zeolites, in particular less than 5% by weight of zeolites.

Preferred support materials for Rh-containing compounds are ZrO₂, TiO₂, Al₂O₃, hydrotalcites or zeolites, for example of the MFI structure type. These are described, for example, in Chemical Engineering and Technology 24 (2001) 281-285 or in Catalysis Today 35 (1997) 113-120. Particularly preferred supports for Rh-containing compounds are ZrO₂, TiO₂ and hydrotalcites. The Rh content of these catalysts is preferably 0.10% to 10% by weight, preferably 0.5% to 5% by weight. In addition to Rh, Rh-containing catalysts more preferably also contain CeO₂. The proportion of CeO₂ is preferably 5% to 50% by weight, in particular 10% to 30% by weight.

Preferred supports for Co-containing compounds are zeolites, or the preferred supports contain magnesium oxide. In the case of zeolites, particular preference is given to Si-rich structure types such as MFI, BEA, FER, MEL or MOR. The production of such Co-doped zeolites is known to the skilled person. Magnesium oxide supports may be pure MgO or MgO-containing compounds, for example hydrotalcites. Such catalysts are described, for example, in Appl. Catal. B: Environmental 7 (1996) 397-406 or Appl. Catal. B: Environmental 13 (1997) 69-79.

Particular preference is given to catalysts consisting essentially of at least one oxidic magnesium compound and at least one oxidic cobalt compound, where the content of oxidic cobalt compounds is in the range from 0.10% to 50% by weight and the content of oxidic magnesium compounds is in the range from 50% to 99.9% by weight, based in each case on the total mass of the catalyst, and at least 30% by weight of the Co atoms present in the catalyst are in the chemically trivalent state. Such catalysts and the preparation thereof are described in EP 1 257 347 Bi. Also particularly preferred in the case of use of oxidic Co compounds as active component are catalysts having a support consisting of at least 50% by weight of MgO or of a mixed oxide consisting of at least 50% by weight of MgO, and where a cerium oxide functional layer has been applied to the support. Such catalysts and the preparation thereof are described in DE 10 2007 038 711 A1.

The N₂O decomposition catalyst may take the form of shaped bodies of any size and geometry, preferably geometries having a high ratio of surface area to volume, with generation of a minimum pressure drop as they are traversed. All geometries known in catalysis are typical, for example cylinders, hollow cylinders, multi-hole cylinders, rings, crushed granulate, trilobes or honeycomb structures.

N₂O reduction catalysts and NO_{X} reduction catalysts are likewise known per se, and a wide variety of substance classes can likewise be used. Examples of these are metal-laden zeolite catalysts, such as copper- or cobalt-laden zeolite catalysts, or in particular iron-laden zeolite catalysts, or precious metal catalysts or catalysts that are used in the known SCR (selective catalytic reduction) processes.

Preferably, the N₂O decomposition catalyst and/or the N₂O reduction catalyst and/or the NO_{X} reduction catalyst independently comprise a zeolitic material; preferably a zeolite laden with transition metal (including lanthanide), in particular with iron, cobalt or copper; more preferably an iron-laden zeolite; even more preferably independently an iron-laden zeolite of the MFI, BEA, FER, MOR, FAU and/or MEL structure type.

Preferably, both the N₂O decomposition catalyst and/or the N₂O reduction catalyst and the NO_{X} reduction catalyst independently comprise a zeolitic material; preferably a zeolite laden with transition metal (including lanthanide), in particular with iron, cobalt or copper; more preferably an iron-laden zeolite; even more preferably independently an iron-laden zeolite of the MFI, BEA, FER, MOR, FAU and/or MEL structure type.

These may be different catalysts or the same catalysts. Iron-laden zeolite catalysts that are used with particular preference in accordance with the invention essentially contain preferably >50% by weight, in particular >70% by weight, of one or more iron-laden zeolites. For example, in addition to a Fe-ZSM-5 zeolite, a further iron-containing zeolite such as an iron-containing zeolite of the FER type, may be present in the catalyst used in accordance with the invention.

In addition, the catalyst used in accordance with the invention may contain further additives known to the skilled person, for example binders.

The iron content of the zeolites used with preference may be up to 25% based on the mass of zeolite, but preferably 0.1% to 10%.

The method of the invention also includes the use of zeolites in which the lattice aluminum has been partly isomorphically substituted by one or more elements, for example replaced by one or more elements selected from B, Be, Ga, Fe, Cr, V, As, Sb, and Bi. Likewise included is the use of zeolites in which the lattice silicon is isomorphically substituted by one or more elements, for example by one or more elements selected from Ge, Ti, Zr and Hf. Exact details of the formation or structure of the zeolites preferably used in accordance with the invention is given in the Atlas of Zeolite Structure Types, Elsevier, 4th revised edition 1996, which is hereby explicitly incorporated by reference.

Very particular preference is given in the method of the invention to zeolite catalysts that have been treated with water vapor (“steamed” catalysts). Such a treatment dealuminates the lattice of the zeolite; this treatment is known per se to the skilled person. These hydrothermally treated zeolite catalysts are notable for particularly high activity in the method of the invention. Preference is given to using hydrothermally treated zeolite catalysts that have been laden with iron and in which the ratio of extra-lattice aluminum to lattice aluminum is at least 1:2, preferably 1:2 to 20:1.

The N₂O decomposition catalyst and/or the N₂O reduction catalyst and the NO_{X} reduction catalyst preferably each independently comprise transition metal-laden zeolites, preferably respectively iron-laden zeolites (Fe zeolites), even more preferably respectively iron-laden zeolites of the same structure type, most preferably with the same outer shape (e.g. honeycomb or pellet).

In preferred embodiments, the N₂O decomposition catalyst and the N₂O reduction catalyst are made from the same material.

In preferred embodiments, the N₂O decomposition catalyst and the NO_{X} reduction catalyst are made from the same material.

In preferred embodiments, the N₂O reduction catalyst and the NO_{X} reduction catalyst are made from the same material.

In preferred embodiments, the N₂O decomposition catalyst, the N₂O reduction catalyst and the NO_{X} reduction catalyst are made from the same material.

The offgas is preferably cooled after leaving the firing system, preferably the combustion device, in the course of the optional and preferred step (b) of the method of the invention, where steps (d₁) and/or (d₂) and/or (e) can introduce new heat.

Preferred Catalysts for the Breakdown of N₂O and NO_{X}

The N₂O decomposition catalysts, N₂O reduction catalysts, and NO_{X} reduction catalysts of the invention preferably independently contain zeolitic materials (for the purpose of the description also “zeolites”) laden with at least one transition metal (atomic numbers 21-30, 39-48, 57-80, 89-112) and/or at least one lanthanoid (also called “lanthanide”; atomic numbers 57-71). For the purposes of the description, transition metals and lanthanoids are collectively referred to as “transition metals” for the sake of simplicity. The transition metals are preferably iron (“Fe zeolites”), copper (“Cu zeolites”) and cobalt (“Co zeolites”). Iron-laden zeolitic materials (i.e. Fe zeolites) are particularly preferred and may be laden with or contain not only iron but also other transition metals, for example manganese, vanadium, chromium, nickel or mixtures.

The zeolitic materials of the invention preferably have high hydrothermal stability. Particular preference is given to SiO₂-rich zeolites, called “high-silica zeolites”, which have a molar ratio of [SiO₂] to [AlO₂⁻] units, and hence a molar Si/Al ratio of at least 8, preferably at least 9, more preferably at least 10, even more preferably at least 11, most preferably at least 12, and in particular at least 13.

Zeolitic materials that are preferred in accordance with the invention essentially have a zeolite structure of the BEA, MFI, MOR, MEL or FER structure type, more preferably of the MFI and BEA structure type, even more preferably of the BEA structure type. In the case of the MFI structure type, the ZSM-5 type in particular is preferred. Further details of the naming of the structure types of zeolitic materials and their structure can be found in the Atlas of Zeolite Structure Types, Elsevier, 4th revised edition 1996.

N₂O decomposition, N₂O reduction or NO_{X} reduction catalysts that are particularly preferred in accordance with the invention independently contain at least 50% by weight of Fe zeolite in relation to the total weight of the zeolitic material, preferably at least 70% by weight of Fe zeolite, where a single structure type or else several structure types may be present. In preferred embodiments, in addition to Fe-BEA zeolite, another Fe zeolite of a different structure type is present, preferably Fe-MOR zeolite.

The loading (doping) of the zeolitic materials with the transition metals/lanthanoids can be effected by relevant methods of loading or doping zeolites with transition metals/lanthanoids that are known to the skilled person. The loading preferably proceeds from the commercially available H form or preferably NH₄ form of the zeolitic materials by ion exchange with appropriate salts of the transition metals, in an aqueous phase or by solid-state reaction. The laden zeolitic materials thus obtained are then calcined, preferably under air in a furnace at temperatures in the range of 400 to 650° C. After calcination, the laden zeolitic materials are vigorously washed in distilled water, and the laden zeolitic materials are filtered off and then dried. Suitable binders, for example aluminosilicates, boehmite or silica sol, and optionally auxiliaries for plasticization or for production of slips, are preferably added to and mixed with the laden zeolitic materials thus obtained. In preferred embodiments, the mixtures thus obtained are extruded to catalyst bodies (unsupported catalysts) and finally calcined. In other preferred embodiments, the mixtures thus obtained are applied to catalyst supports (supported catalysts) and finally calcined. These methods are also well known to the skilled person and established in many technical applications.

The N₂O decomposition, N₂O reduction, NO_{X} reduction, NH₃ oxidation, HCN breakdown and CO oxidation catalysts of the invention may independently take the form of shaped bodies of any size and geometry, preferably in geometries that have a large surface-to-volume ratio and generate a minimum pressure drop as the stream flows through them. Typical geometries are all of those known in catalysis, for example cylinders, hollow cylinders, multihole cylinders, rings, trilobes or star-shaped extrudates. Particular preference is given to monolithic catalyst elements permeated by parallel channels, for example monolithic honeycombs, known as “catalyst honeycombs”, which are known, for example, from the cleaning or denoxing of power plant offgases or automotive exhaust gases.

### Catalyst Honeycombs, Honeycomb Bodies and Honeycomb Body Modules

The offgas treatment system of the invention or the catalyst beds encompassed therein preferably comprise catalyst honeycombs, preferably a plurality of catalyst honeycombs, arranged parallel to one another with honeycomb channels in the offgas duct that are aligned longitudinally to the flow direction of the offgas. The geometry of the cross-sectional area of the catalyst honeycombs (perpendicular to the flow direction of the offgas) can in in principle be chosen freely. The catalyst honeycombs preferably have a rectangular or, in particular, square cross-sectional area, but other cross-sectional areas are also possible, in particular hexagonal, triangular, trapezoidal, etc. Suitable geometries are known to those skilled in the art. Accordingly, the term “honeycomb”, according to the invention, is not limited to a rectangular or square cross-sectional area.

If the offgas treatment system of the invention comprises a first reaction zone (first catalyst bed) and a second reaction zone (second catalyst bed) downstream in flow direction of the offgas, which is preferred in accordance with the invention, the first and second reaction zones (the first and second catalyst beds) preferably have several catalyst honeycombs that are arranged parallel to one another with honeycomb channels in the offgas duct that are aligned longitudinally to the flow direction of the offgas.

In preferred embodiments, several catalyst honeycombs, i.e. several monolithic honeycomb bodies, are combined to form a honeycomb body module, preferably by means of a metal frame which is open in flow direction of the offgas. Preferably, two, four or six honeycomb bodies, preferably monolithic honeycomb bodies, in each case are combined to form a honeycomb body module. This modular construction allows good utilization of the available cross-sectional area of the offgas duct and simple exchange of defective or deactivated honeycomb bodies.

The honeycomb bodies preferably have a rectangular cross section. The rectangular cross section preferably has a first edge length (perpendicular to the flow direction of the offgas) in the range of 5 to 20 cm, more preferably 10 to 15 cm, and a second edge length (also perpendicular to the flow direction of the offgas) in the range of 5 to 20 cm, preferably 10 to 15 cm. The height of a honeycomb body (flow direction of the offgas) is preferably in the range from 5 to 25 cm, preferably in the range from 7.5 to 15 cm.

What is called the cell density, i.e. density of the channels of a single catalyst honeycomb, is preferably 150 to 500 cpsi, preferably 180 to 450 cpsi (cells per square inch). 100 cpsi, i.e. 100 cells or honeycomb channels per square inch, corresponds to about 15.5 catalyst channels per cm².

Preferably, the individual honeycomb body modules are stacked on top of one another and alongside one another in flow direction and fixed by appropriate mount devices in such a way as to achieve maximum exploitation of the inflow area, i.e. cross-sectional area of the offgas duct. Bypass flows between each honeycomb body module or in the outer edge area between the outer margin of the honeycomb body module and the inner wall of the offgas duct should be avoided. For this purpose, suitable sealing materials are preferably applied between the individual honeycomb body modules and between the outer honeycomb body modules and the inner wall and, in the case of greater wall separations, cover plates are used, which are mounted on the inner wall of the offgas duct in flow direction in front and/or behind the packing of the honeycomb body modules. The cover plates are preferably covered with seals at the contact points with the honeycomb body modules. The honeycomb body modules are preferably arranged and selected in terms of size in such a way that the usable inflow area of catalyst is preferably at least 60% of the inner cross-sectional area of the offgas duct, more preferably at least 70%, even more preferably at least 80%.

In the case of circular offgas ducts or offgas pipelines, the gaps that arise in the edge region of the packing of the honeycomb body modules, unless they can be easily occupied with rectangular honeycomb body modules, are preferably not filled with specially tailored honeycomb bodies, but closed by blind plates. This has the advantage that, when exchanging spent honeycomb bodies, only standardized honeycomb bodies have to be exchanged and no special adjustments are required.

When using offgas pipelines, it is preferably also possible to use individual larger honeycomb bodies adapted to the pipeline cross section with a circular inflow cross section, several of which may also be arranged in succession in flow direction in a preferred configuration. In this case, it is then unnecessary to combine several honeycomb bodies parallel to one another to form honeycomb body modules.

In preferred embodiments, the honeycomb bodies or honeycomb body modules are arranged in several layers offset along the longitudinal axis in flow direction of the offgas. The honeycomb bodies or honeycomb body modules are preferably arranged in 2 to 5 layers, more preferably in 2 to 3 layers.

A margin is preferably provided between the layers, i.e. between the end faces of the honeycomb bodies or honeycomb body modules, preferably in the range from 3 to 30 mm, preferably 4 to 20 mm. The margin can enable intermediate, in particular radial, mixing of the gas flow emerging from a first layer of the honeycomb bodies or honeycomb body modules. Furthermore, it is possible to prevent any possible slip of unreacted reducing agent and/or of the as yet incompletely oxidized reaction products thereof from propagating from the first layer of the honeycomb bodies into a subsequent, second layer of the honeycomb bodies.

The reducing agents for NO_{X} and optionally N₂O are preferably supplied and distributed via a manifold pipeline system having a multitude of openings or nozzles, disposed in the offgas duct or in the offgas conduit upstream of the respective catalyst bed in flow direction, preferably upstream of the packing of the catalyst honeycombs as honeycomb bodies or honeycomb body modules.

The distributor tubes are preferably designed in the form of grids, or in the form of concentrically connected circles, which extend as far as possible over the cross-sectional area of the offgas duct or the inflow area of the catalyst bed.

The specific design and dimensioning of these distributors, including suitable exit nozzles, is part of specialist knowledge in catalytic offgas cleaning technology and is widely employed, for example, in offgas treatment for coal-fired power plants.

### NH₃ Oxidation Catalyst

NH₃ oxidation catalysts are known to those skilled in the art.

The NH₃ oxidation catalyst is preferably free of platinum group metals, preferably free of precious metals.

What is meant by “free of platinum group metals” for the purposes of the description is that essentially no metal of the platinum group (i.e. Ru, Rh, Pd, Os, Ir, Pt) is present. However, analytically detectable minimal traces of platinum group metals are possible. What is meant by “free of precious metals” for the purposes of the description is that essentially no precious metal is present. However, analytically detectable minimal traces of precious metal are possible.

The NH₃ oxidation catalyst is preferably an iron- or copper-laden zeolite; preferably an iron- or copper-laden zeolite of the MFI, BEA, FER, MOR, FAU, AEI and/or MEL structure type (referred to hereinafter as “NH₃ oxidation-active iron- or copper-laden zeolite catalyst”).

Preferred platinum group metal-free NH₃ oxidation catalysts are selected from transition metal oxides (for example of Fe, Mn, Cu, Cr, Co, Ni . . . ), metal-laden zeolites, described, for example, in Handbook of Heterogeneous Catalysis, Wiley-VCH, edited by Ertl, Knotzinger, Schith, Weitkamp, 2nd Ed. 2008, Volume 5, Chapter 11.5 “Solid Catalysts for the Oxidation of Volatile Organic Compounds”.

Preferred NH₃ oxidation catalysts include
cobalt catalysts; especially Co₃O₄; Co₃O₄-derived mixed oxides (Co_{3-y}M_{y}O₄) that preferably crystallize like Co₃O₄ in the spinel structure, where M is preferably selected from Zn, Cu, Fe, Mn and V; cobalt-laden zeolites, preferably of the MFI, BEA, FER, MOR, FAU, CHA or AFI structure type;
manganese catalysts; especially MnO_{X} with x=1-2; MnO_{X}-derived mixed oxides (Mn_{x-y}M_{y}Oₓ) where M is preferably selected from Zn, Cu, Fe and Mn; manganese-laden zeolites, preferably of the MFI, BEA, FER, MOR, FAU, CHA or AFI structure type;
copper catalysts; especially CuO_{X} with x=0.5-1; CuO_{X}-derived mixed oxides (Cu_{x-y}M_{y}Oₓ) where M is preferably selected from Zn, Co, Fe and Mn; copper-laden zeolites, preferably of the MFI, BEA, FER, MOR, FAU, CHA, AFI structure type;
silver catalysts; especially in supported form, preferably supported on Al₂O₃, TiO₂, or SiO₂, more preferably, for example, X % Ag/TiO₂, X % Ag/Al₂O₃, or X % Ag/SiO₂, in each case with X=1-10.

In preferred embodiments, the apparatus of the invention contains no further NH₃ oxidation catalyst aside from the iron- or copper-laden zeolite.

In preferred embodiments, the NH₃ oxidation catalyst, preferably the NH₃ oxidation-active, iron-laden zeolite catalyst, has a molar ratio of iron to zeolitic aluminum n(Fe)/n(Al) of less than 0.50 to greater than 0.05; preferably less than 0.40 to greater than 0.05, more preferably less than 0.25 to greater than 0.05, even more preferably less than 0.15 to greater than 0.05.

In preferred embodiments, the NH₃ oxidation catalyst, preferably the NH₃ oxidation-active, copper-laden zeolite catalyst, has a molar ratio of copper to zeolitic aluminum n(Cu)/n(Al) of less than 1.00 to greater than 0.10; preferably less than 0.80 to greater than 0.10, more preferably less than 0.50 to greater than 0.10, even more preferably less than 0.30 to greater than 0.10.

It has thus been found that, surprisingly, iron- or copper-laden zeolites in which only some of the potentially available cation sites are occupied with Fe or Cu ions, such that the residual cation sites are essentially satisfied by protons, have a significantly increased activity for the oxidation of NH₃ with free oxygen.

The ratio of iron or copper to zeolitic aluminum can be adjusted by selecting the Al content in the synthesis of the zeolitic material, in particular via the proportions of the chosen Si and Al starting materials, and also by later loading with iron or copper ions.

In the synthesis of zeolites, the chosen Si and Al starting materials are usually heated in alkaline solution, often under elevated pressure, which results in occurrence of crystallization to give the microporous aluminosilicates formed from three-dimensionally catenated AlO₂⁻ and SiO₂ units, the zeolites. By controlled choice of the synthesis conditions, for example also by adding structure-directing reagents, e.g. organic cations, not only the Si/Al ratio and hence the Al content but also the structure type of the zeolite can be specifically adjusted or controlled. The synthesis methods are industrially established. Zeolites of different structure type with different Si/Al ratios and laden with different cations, for example in Na or NH₄ form, are commercially available.

Suitable methods known to those skilled in the art, for example liquid phase or solid-state ion exchange, can result in controlled exchange of the cations present in the zeolite, for example NH₄⁺, for other cations, e.g. iron or copper ions (J. Weitkamp, L. Puppe Catalysis and Zeolites—Fundamentals and Applications, Springer-Verlag Berlin Heidelberg New York, 1999 or Kucherov, A. V. Slinkin, A. A.: Solid state reactions as method of introducing transition metal cations into high-silica zeolites, Russ. Chem. Rev. 1992, vol. 61, no. 9, p. 925-943). If all negative charges generated by the AlO₂ units have been compensated for by cations, what is called the exchange level is 100%.

The exact Al content of the present zeolitic material or of the shaped catalyst bodies produced therefrom, and likewise the Fe content, as is well known, can be determined by X-ray fluorescence analysis (XRF). This is appropriately done in accordance with DIN EN 169-2 (section 5) after determination of ignition loss and after a lithium tetraborate digestion.

If the intention is to determine the Al content of the parent zeolitic material subsequently on the finished shaped body, it should be noted that the shaped body may also contain Al-based binder components which cannot be distinguished from zeolitic Al by XRF. In this case, an additional study of the shaped bodies is required, for example by means of ²⁷Al solid-state NMR which allows a distinction between the Al bound in the zeolite structure and extra-lattice Al. Those skilled in the art will be familiar with details of the fundamentals, implementation and evaluation of such studies (J. Weitkamp, L. Puppe Catalysis and Zeolites—Fundamentals and Applications, Springer-Verlag Berlin Heidelberg New York, 1999, Chapter 4.2 (NMR Spectroscopy; especially sections 4.2.4.1 (²⁹Si MAS NMR Spectroscopy of SiO₄ Tetrahedra in the Zeolite Framework) and 4.3.4.2 (²⁷Al NMR Spectroscopy of Framework and Non Framework Aluminum in Zeolites)).

The NH₃ oxidation catalyst, preferably the NH₃ oxidation-active iron-laden zeolite catalyst, preferably has a total iron content (reported as mass content of Fe₂O₃) of less than 10.0% by weight to greater than 2.0% by weight, preferably of less than 7.0% by weight to greater than 2.0% by weight, more preferably of less than 5.0% by weight to greater than 2.0% by weight, and even more preferably of less than 4.0% by weight to greater than 2.0% by weight.

The NH₃ oxidation catalyst, preferably the NH₃ oxidation-active copper-laden zeolite catalyst, preferably has a total copper content (reported as mass content of Cu₂O) of less than 9.0% by weight to greater than 1.5% by weight, preferably of less than 6.5% by weight to greater than 1.5% by weight, more preferably of less than 4.5% by weight to greater than 1.5% by weight, and even more preferably of less than 3.5% by weight to greater than 1.5% by weight.

In preferred embodiments, the NH₃ oxidation catalyst, preferably the NH₃ oxidation-active iron- or copper-laden zeolite catalyst, is configured for selective oxidation of NH₃ with O₂ to N₂ and H₂O, and, introduced in the form of a particulate bed, the particles of which have an equivalent diameter of 3.5 to 5.5 mm, which is defined as the diameter of a spherical particle of equal volume, and where the ratio of the outer geometrically detectable surface area of the particles to the volume of the particulate bed is 1000 m²/m³ to 1500 m²/m³, in an amount of 8.0±0.5 ml in an isothermally operated tubular reactor with axial flow having an internal diameter of 20±3 mm, contacted with a volume flow rate of a gas mixture consisting of 500±50 ppmv of NH₃, 2.5±0.1% by volume of O₂ and 0.30±0.05% by volume of H₂O in N₂ at a space velocity based on standard conditions (0° C.; 1.01325 bara) of 10 000±500 h⁻¹, a total pressure of 6±0.5 bara and a temperature of 380 C±5 K, brings about an NH₃ conversion of at least 50%, preferably at least 60%, more preferably at least 70%, even more preferably at least 80%, in particular at least 90%.

In preferred embodiments, the N₂O decomposition catalyst and/or the N₂O reduction catalyst and/or the NO_{X} reduction catalyst and/or the NH₃ oxidation catalyst independently have a honeycomb monolithic structure.

In preferred embodiments, the N₂O decomposition catalyst and/or the N₂O reduction catalyst and/or the NO_{X} reduction catalyst and/or the NH₃ oxidation catalyst independently have a honeycomb monolithic structure.

In preferred embodiments, the NH₃ oxidation catalyst and the N₂O decomposition catalyst are made from the same material.

In preferred embodiments, the NH₃ oxidation catalyst and the N₂O reduction catalyst are made from the same material.

In preferred embodiments, the NH₃ oxidation catalyst and the NO_{X} reduction catalyst are made from the same material.

In preferred embodiments, the NH₃ oxidation catalyst, the NO_{X} reduction catalyst and the N₂O decomposition catalyst are made from the same material.

Preferred variants of combinations of steps (d) and (e):

In preferred embodiments, steps (d₁) and/or (d₂) and/or (e) of the method of the invention are performed at different temperatures, i.e. at different temperature levels, where a step conducted earlier or upstream in flow direction of the offgas preferably proceeds at a higher temperature than a step performed subsequently or downstream in flow direction of the offgas.

However, depending on the nature of the catalysts used, the steps may not be completely separable from each other, either locally or in time. If a catalyst used is simultaneously suitable for catalysis of two or more of steps (d₁), (d₂) and (e), these steps may proceed simultaneously and/or sequentially. In flow direction of the offgas, it is possible for that purpose to consider individual segments of one and the same catalyst through which the offgas flows successively and in which different reactions may dominate. Which reaction is dominant in which section depends in particular on the respective reaction kinetics, the local temperature and the local concentrations of the reactants, possibly including the concentration of reducing agent and possibly including the concentration of cocatalytically active species.

The offgas treatment system of the invention is used in particular for performance of steps (d) and (e) of the method of the invention. However, it is also possible that further steps and chemical reactions are conducted within the offgas treatment system in addition to steps (d) and (e).

This preferably relates to the installation of a catalyst bed disposed downstream in flow direction of the offgas for oxidation of incompletely converted reducing agents or the as yet incompletely oxidized reaction products thereof, i.e., for example, for oxidation of NH₃ (NH₃ oxidation catalyst) or CO (CO oxidation catalyst; when hydrocarbons are used as reducing agents). In such embodiments, the offgas is preferably cooled before it is introduced into the downstream catalyst bed, i.e. the oxidation of NH₃ and/or CO is preferably effected at a lower temperature than steps (d) and (e).

In the performance of the steps (d) and (e) of the method of the invention, according to the invention, there are different preferred variants of the process regime, which can differ from each other with regard to the sequence of the reactions that proceed, the catalysts used, the reducing agents used, the space velocities and other reaction conditions.

In preferred embodiments, these reactions are conducted in a common reaction zone (catalyst bed), which is equipped upstream with an apparatus for metering reducing agent into the offgas.

In other preferred embodiments, these reactions are conducted in two separate reaction zones (catalyst beds) arranged in succession, of which preferably at least one reaction zone, preferably both reaction zones, is/are independently equipped upstream with an apparatus for metering reducing agent into the offgas. In that case, the offgas flows first through the first reaction zone and subsequently through the second reaction zone.

Particularly preferred variants/embodiments include
[a] (d₂) the chemical reduction of N₂O with NH₃ and (e) the chemical reduction of NO_{X} with NH₃, preferably collectively in one reaction zone;
[b] (d₂) the chemical reduction of N₂O with hydrocarbon (CH₄, natural gas, etc.) and (e) the chemical reduction of NO_{X} with NH₃, preferably collectively in one reaction zone;
[c] (d₁) the decomposition of N₂O and (e) the chemical reduction of NO_{X} with NH₃, preferably collectively in one reaction zone;
[d] (d₁) the decomposition of N₂O and (d₂) the chemical reduction of N₂O with NH₃ and (e) the chemical reduction of NO_{X} with NH₃, preferably collectively in one reaction zone;
[e] (d₁) the decomposition of N₂O and (d₂) the chemical reduction of N₂O with hydrocarbon (CH₄, natural gas, etc.) and (e) the chemical reduction of NO_{X} with NH₃, preferably collectively in one reaction zone;
[f] (d₁) the decomposition of N₂O, preferably in a first reaction zone; and subsequently (e) the chemical reduction of NO_{X} with NH₃, preferably in a second reaction zone;
[g] (d₁) the incomplete decomposition of N₂O, preferably in a first reaction zone; and subsequently (d₂) the chemical reduction of residual N₂O with NH₃ and (e) the chemical reduction of NO_{X} with NH₃, preferably in a second reaction zone;
[h] (d₁) the incomplete decomposition of N₂O, preferably in a first reaction zone; and subsequently (d₂) the chemical reduction of residual N₂O with hydrocarbon (CH₄, natural gas, etc.) and (e) the chemical reduction of NO_{X} with NH₃, preferably in a second reaction zone;
[i] (d₁) the incomplete decomposition of N₂O, preferably in a first reaction zone; and subsequently (d1*) the decomposition of residual N₂O and (e) the chemical reduction of NO_{X} with NH₃, preferably in a second reaction zone;
[j] (d₁) the incomplete decomposition of N₂O, preferably in a first reaction zone; and then (d1*) the decomposition of residual N₂O and (d₂) the chemical reduction of residual N₂O with NH₃ and (e) the chemical reduction of NO_{X} with NH₃, preferably in a second reaction zone;
[k] (d₁) the incomplete decomposition of N₂O, preferably in a first reaction zone; and then (d1*) the decomposition of residual N₂O and (d₂) the chemical reduction of residual N₂O with hydrocarbon (CH₄, natural gas, etc.) and (e) the chemical reduction of NO_{X} with NH₃, preferably in a second reaction zone;
[l] (e) the incomplete chemical reduction of NO_{X}, preferably in a first reaction zone; and subsequently (d₁) the decomposition of N₂O and (e*) the chemical reduction of residual NO_{X} with NH₃, preferably in a second reaction zone;
[m] (e) the incomplete chemical reduction of NO_{X}, preferably in a first reaction zone; and subsequently (d₁) the decomposition of N₂O and (d₂) the chemical reduction of N₂O with NH₃ and (e*) the chemical reduction of residual NO_{X} with NH₃, preferably in a second reaction zone; or [n] (e) the incomplete chemical reduction of NO_{X}, preferably in a first reaction zone; and subsequently (d₁) the decomposition of N₂O and (d₂) the chemical reduction of N₂O with hydrocarbon (CH₄, natural gas, etc.) and (e*) the chemical reduction of residual NO_{X} with NH₃, preferably in a second reaction zone.

This does not mean, however, that the reactions explicitly mentioned must be the only reactions that take place in the respective reaction zone. Depending on the catalyst used, it is instead preferred in accordance with the invention that, in addition, further reactions also take place simultaneously, which are not explicitly mentioned but can proceed in parallel. The reactions explicitly mentioned are therefore only those reactions that at least take place in the respective variant/embodiment.

If NO_{X}, N₂O and NH₃ are present in a mixture and the catalyst used catalyzes both the chemical reduction of NO_{X} with NH₃ and the chemical reduction of N₂O with NH₃, the chemical reduction of NO_{X} with NH₃ is typically much faster than the chemical reduction of N₂O with NH₃. If the catalyst used additionally catalyzes the decomposition of N₂O, the decomposition of N₂O typically overlaps with the chemical reduction of N₂O with NH₃, where the extent of the chemical reduction of N₂O can be increased by increasing the amount of NH₃ metered in.

For the purposes of the description, “*” denotes a component method step that has previously been conducted only partially in a component method step of the same type, where the component method step identified by “*” then continues the component method step that has previously been conducted only partially, but possibly in a different reaction zone or a different catalyst bed. As with all other method steps, unless explicitly stated otherwise, the result achieved at the end of all component method steps is not quantified. If, for example, NO_{X} is incompletely chemically reduced in a first component method step (e), the fact that component method step (e*) is subsequently conducted does not necessarily mean that, at the end of component method step (e*), the total amount of NO_{X} must have been completely chemically reduced, i.e. to 0.0 ppmv. Instead, it is entirely possible that, at the end of component method step (e*), there is still a residual amount of NO_{X}.

The offgas treatment system comprises at least one injection site for reducing agents. The offgas treatment system may comprise several injection sites for reducing agents.

The mode of introduction of the reducing agents into the stream of the offgas to be treated is freely configurable in accordance with the invention, provided that this is done upstream of the N₂O reduction catalyst or NO_{X} reduction catalyst in flow direction. The reducing agent can be introduced in the form of a gas or else a liquid or aqueous solution that evaporates in the stream of the offgas to be treated. The feeding is effected by a suitable apparatus, for example an appropriate pressure valve or appropriately designed nozzles, which leads into a mixer for the stream of the offgas to be treated and the reducing agent supplied. When different reducing agents for NO_{X} and N₂O are used, the supply and introduction into the offgas can be effected separately or together.

In the case of configuration of the catalyst beds as a packing of catalyst honeycombs or honeycomb body modules, the supply and distribution of the reducing agents for NO_{X} and optionally N₂O to the one or more reaction zones (catalyst beds) is preferably effected via a manifold pipeline system having a multitude of openings or nozzles, disposed upstream of the respective reaction zone (catalyst bed) in flow direction of the offgas, i.e. upstream of the packing of the catalyst honeycombs or honeycomb modules.

The distributors are preferably designed in the form of grids, or concentrically connected circles, which extend as far as possible over the cross-sectional area of the offgas duct or the inflow area of the reaction zone (catalyst bed).

The specific design and dimensioning of these distributors, including suitable exit nozzles, is part of specialist knowledge in catalytic offgas cleaning technology and is widely employed, for example, in offgas treatment for coal-fired power plants.

The offgas treatment system of the invention may comprise a single reaction zone. In this case, the catalyst used in this single reaction zone serves as N₂O decomposition catalyst and/or N₂O reduction catalyst and as NO_{X} reduction catalyst. In this case, the steps (d) and (e) of the method of the invention are effected essentially simultaneously within this reaction zone. However, it should be noted that the kinetics of the individual conversions can be quite different. For instance, depending on the catalyst material used, the chemical reduction of NO_{X} with NH₃ as reducing agent can proceed much more quickly than the chemical reduction of N₂O with NH₃. Thus, if NO_{X} and N₂O are in a mixture and NH₃ is fed in as reducing agent, different reactions will take place in the front section of the single reaction zone than in the rear section of the single reaction zone. In the front section, owing to the faster kinetics, the chemical reduction of NO_{X} proceeds predominantly, and it is only in the rear section, once the majority of the NO_{X} has been broken down, that the chemical reduction of N₂O proceeds.

Alternatively, the offgas treatment system may comprise several reaction zones, which is preferred in accordance with the invention. If several reaction zones are included, they are preferably in succession, such that the offgas flows through them one after another: first the first reaction zone and then the second reaction zone and, if appropriate, then the third reaction zone.

In preferred embodiments, the reaction zones are each spatially separated catalyst beds.

In preferred embodiments, the offgas undergoes the steps of the method of the invention in one of the following sequences:
(i) (a)→(b)→(c)→(d₁)→(e); where step (d₁) preferably proceeds in a first reaction zone; and step (e) proceeds in a second reaction zone;
(ii) (a)→(b)→(c)→(e)→(d₂); where step (e) preferably proceeds in a first reaction zone; and step (d₂) proceeds in a second reaction zone;
(iii) (a)→(b)→(c)→(e)→d₂)→(d₁); where step (e) preferably proceeds in a first reaction zone; step (d₂) proceeds in a second reaction zone; and step (d₁) proceeds in a third reaction zone;
(iv) (a)→(b)→(c)→(e)→(d₁)+(d₂); where step (e) preferably proceeds in a first reaction zone; and step (d₁) and step (d₂) proceed in a second reaction zone;
(v) (a)→(b)→(c)→(e)→(d₁); where step (e) preferably proceeds in a first reaction zone; and step (d₁) proceeds in a second reaction zone;
(vi) (a)→(b)→(c)→(d₁)+(e)→(e*); preferably, step (d₁) and step (e) (incompletely) proceed in a first reaction zone; and the remainder of step (e*) proceeds in a second reaction zone;
(vii) (a)→(b)→(c)→(d₁)+(e)→(e*)+(d₂); where step (d₁) and step (e) (incompletely) preferably proceed in a first reaction zone; and step (d₂) and the remainder of step (e*) proceed in a second reaction zone;
(viii) (a)→(b)→(c)→(d₁)+(d₂)+(e)→(d1*)+(d2*)+(e*); wherein step (d₁) (incompletely) and step (d₂) (incompletely) and step (e) (incompletely) preferably proceed in a first reaction zone which preferably does not contain a zeolitic material as catalyst; and the remainder of step (d1*) and the remainder of step (d2*) and the remainder of step (e*) proceed in a second reaction zone which preferably contains zeolitic material as catalyst;
(ix) (a)→(b)→(c)→(d₁)+(d₂)+(e)→(d1*)+(d2*)+(e*); wherein step (d₁) (incompletely) and step (d₂) (incompletely) and step (e) (incompletely) preferably proceed in a first reaction zone which preferably contains a zeolitic material as catalyst; and the remainder of step (d1*) and the remainder of step (d2*) and the remainder of step (e*) proceed in a second reaction zone which preferably contains an NO_{X}-sensitive N₂O decomposition catalyst as catalyst;
(x) (a)→(b)→(c)→(d₁)→(d₁*)+(d₂)+(e); where step (d₁) (incompletely) preferably proceeds in a first reaction zone which preferably contains zeolitic material as catalyst; and the remainder of step (d1*) and step (d₂) and step (e) proceed in a second reaction zone which preferably contains zeolitic material as catalyst;
(xi) (a)→(b)→(c)→(d₁)→(d₁*)+(d₂)+(e); where step (d₁) (incompletely) preferably proceeds in a first reaction zone which preferably contains an NO_{X}-sensitive N₂O decomposition catalyst as catalyst; and the remainder of step (d1*) and step (d₂) and step (e) proceed in a second reaction zone which preferably contains zeolitic material as catalyst.

However, it is also possible that two or more reaction zones are implemented by a single catalyst bed. Two reaction zones on a shared catalyst bed can be formed in particular by a feed of reducing agent in the middle (or another position along the longitudinal extent) of the catalyst bed. There is then no reducing agent upstream of the feed point, such that steps (d₂) and (e) of the method of the invention cannot take place for lack of reducing agent. What then takes place upstream is then essentially the decomposition of N₂O in step (d₁) (first reaction zone). Downstream of the feed point, reducing agent is present, and so steps (d₂) and (e) of the method of the invention can take place, possibly overlapping with step (d₁) of the method of the invention (second reaction zone). In this case too, different reactions may occur in the front section of each reaction zone than in the rear section of each reaction zone, because of the different reaction kinetics; however, the first reaction zone and the second reaction zone will in any case differ from one another in that no chemical reduction of N₂O and also no chemical reduction of NO_{X} takes place in the first reaction zone for lack of reducing agent.

In particularly preferred embodiments, the offgas treatment system comprises a first reaction zone and a second reaction zone. It is possible that further reaction zones are present.

In preferred embodiments, the first reaction zone and the second reaction zone are spatially separated from each other. In this case, they are preferably separate catalyst beds. In the case of spatial separation of the catalyst beds, it is possible to adjust the temperature of the second catalyst bed or the gas stream entering it by removal or supply of heat such that it is lower or higher than that of the first catalyst bed. The temperature of a single catalyst bed can appropriately be determined as the arithmetic mean of the temperature of the gas stream at the inlet and outlet from the catalyst bed.

In preferred embodiments, the temperature in the first reaction zone (in the first catalyst bed) is higher than the temperature in the second reaction zone (in the second catalyst bed).

Preferably, the temperature in the first reaction zone is at least 450° C., more preferably at least 500° C., even more preferably at least 550° C., most preferably at least 600° C., and in particular at least 650° C.

Preferably, the temperature in the second reaction zone (in the second catalyst bed) is at most 600° C., more preferably at most 550° C., even more preferably at most 500° C., most preferably at most 450° C., and in particular at most 400° C.

In preferred embodiments, the temperature in the first reaction zone (in the first catalyst bed), in relative terms, is at least 20° C., more preferably at least 40° C., even more preferably at least 60° C., most preferably at least 80° C. and in particular at least 100° C. higher than the temperature in the second reaction zone (in the second catalyst bed).

In other preferred embodiments, the temperature in the second reaction zone (in the second catalyst bed), in relative terms, is at least 20° C., more preferably at least 40° C., even more preferably at least 60° C., most preferably at least 80° C. and in particular at least 100° C. higher than the temperature in the first reaction zone (in the first catalyst bed).

In preferred embodiments, the temperature in the first reaction zone (in the first catalyst bed), in relative terms, is at least 120° C., more preferably at least 140° C., even more preferably at least 160° C., most preferably at least 180° C. and in particular at least 200° C. higher than the temperature in the second reaction zone (in the second catalyst bed).

In other preferred embodiments, the temperature in the second reaction zone (in the second catalyst bed), in relative terms, is at least 120° C., more preferably at least 140° C., even more preferably at least 160° C., most preferably at least 180° C. and in particular at least 200° C. higher than the temperature in the first reaction zone (in the first catalyst bed).

Preferably, the temperature of the offgas on entry into the first reaction zone (into the first catalyst bed) is at least 400° C., more preferably at least 425° C., even more preferably at least 450° C., most preferably at least 500° C.

Preferably, the temperature of the offgas on departure from the second reaction zone (from the second catalyst bed) is at most 600° C., more preferably at most 550° C., even more preferably at most 500° C.

In preferred embodiments, the temperature of the offgas on entry into the first reaction zone (into the first catalyst bed), in relative terms, is at least 20 K, more preferably at least 40 K, even more preferably at least 60 K, most preferably at least 80 K and in particular at least 100 K higher than the temperature of the offgas on entry into the second reaction zone (into the second catalyst bed).

In preferred embodiments, the temperature of the offgas on entry into the second reaction zone (into the second catalyst bed), in relative terms, is at least 10 K, more preferably at least 20 K, even more preferably at least 30 K, most preferably at least 40 K and in particular at least 50 K higher than the temperature of the offgas on entry into the first reaction zone (into the first catalyst bed).

In preferred embodiments, the temperature in the first reaction zone (in the first catalyst bed), in relative terms, is at least 120 K, more preferably at least 140 K, even more preferably at least 160 K, most preferably at least 180 K and in particular at least 200 K higher than the temperature in the second reaction zone (in the first catalyst bed).

In preferred embodiments, the temperature in the second reaction zone (in the second catalyst bed), in relative terms, is at least 120 K, more preferably at least 140 K, even more preferably at least 160 K, most preferably at least 180 K and in particular at least 200 K higher than the temperature in the first reaction zone (in the first catalyst bed).

In other preferred embodiments, the first reaction zone and the second reaction zone are spatially connected to one another. In this case, the catalyst bed is preferably a shared catalyst bed, wherein outside influences result in a division into reaction zones, in particular by the site of injection of reducing agent, such that reducing agent is not present uniformly across the catalyst bed.

Preferably, the first reaction zone and the second reaction zone are disposed in a shared vessel.

Preferably, the offgas temperature in the first reaction zone and in the second reaction zone is in each case independently at most 500° C., preferably in each case independently in the range from 350 to 450° C.

In preferred embodiments, the space velocity in the first reaction zone is greater than the space velocity in the second reaction zone. Preferably, the space velocity in the first reaction zone is greater at least by a factor of 1.2, more preferably at least a factor of 1.4, even more preferably at least a factor of 1.6, most preferably at least a factor of 1.8 and in particular at least a factor of 2.0 than the space velocity in the second reaction zone.

In other preferred embodiments, the space velocity in the second reaction zone is greater than the space velocity in the first reaction zone. Preferably, the space velocity in the second reaction zone is greater at least by a factor of 1.5, more preferably at least a factor of 2.0, even more preferably at least a factor of 3.0, most preferably at least a factor of 5.0 and in particular at least a factor of 10.0 than the space velocity in the first reaction zone.

In the context of the invention, “space velocity” means the quotient of the volume flow rate of the gas mixture conducted through the catalyst bed (measured at 0° C. and 1.014 bara and typically reported in standard m³·h⁻¹), based on the volume of the catalyst or catalyst bed. The space velocity can thus be adjusted via the volume flow rate of the gas and/or the amount of catalyst.

Preferably, the offgas on entry into the offgas treatment system is at a temperature of at least 300° C., more preferably at least 350° C., even more preferably at least 400° C., most preferably at least 425° C., and in particular at least 450° C.

Preferably, the offgas on entry into the offgas treatment system is at a temperature of at least 500° C., more preferably at least 550° C., even more preferably at least 600° C., most preferably at least 625° C., and in particular at least 650° C.

Preferably, the offgas on entry into the offgas treatment system is at a temperature of at most 825° C., more preferably at most 800° C., even more preferably at most 775° C., most preferably at most 750° C., and in particular at most 725° C.

Preferably, the offgas on entry into the offgas treatment system is at a temperature of at most 700° C., more preferably at most 650° C., even more preferably at most 600° C., most preferably at most 550° C., and in particular at most 500° C.

In preferred embodiments, the offgas on entry into the offgas treatment system is at a pressure of at most 1.4 bara, preferably of at most 1.3 bara, more preferably of at most 1.2 bara.

In other preferred embodiments, the offgas is at a reduced pressure on entry into the offgas treatment system, preferably of about −5 mbar. This has the advantage that no gas is released to the environment in the event of possible leaks.

Preferably, the offgas on entry into the offgas treatment system has a degree of oxidation of NO_{X} of at least 10%, more preferably at least 20%, even more preferably at least 30%, most preferably at least 40%, and in particular at least 50%.

Preferably, the offgas on entry into the offgas treatment system has a degree of oxidation of NO_{X} of at most 90%, more preferably at most 80%, even more preferably at most 70%, most preferably at most 60%, and in particular at most 50%.

Depending on the combustion temperature, the degree of oxidation may also be significantly lower, and the degree of oxidation decreases with increasing combustion temperature. Preferably, the offgas on entry into the offgas treatment system has a degree of oxidation of NO_{X} of at most 15%, more preferably at most 12.5%, even more preferably at most 10%, most preferably at most 7.5%, and in particular at most 5.0%.

Preferably, the offgas on entry into the offgas treatment system has an O₂ content of less than 2.0% by volume.

Preferably, the offgas on entry into the offgas treatment system has an O₂ content of more than 4.0% by volume.

In step (d) of the method of the invention, the N₂O content in the offgas is reduced. This can be effected in various ways, namely by (d₁) decomposition of N₂O over an N₂O decomposition catalyst and/or by (d₂) chemical reduction of N₂O with reducing agent over an N₂O reduction catalyst. Step (d) of the method of the invention is performed in the offgas treatment system.

In preferred embodiments, step (d) comprises reducing the N₂O content in the offgas by (d₁) decomposition of N₂O over an N₂O decomposition catalyst.

In preferred embodiments, the N₂O decomposition catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

In other preferred embodiments, the N₂O decomposition catalyst is an NO_{X}-sensitive N₂O decomposition catalyst within the context of the invention, which has already been described in detail above. In this case, the offgas preferably first passes through step (e), i.e. the NO_{X} content in the offgas is first reduced by chemical reduction of NO_{X} with reducing agent over an NO_{X} reduction catalyst, preferably quantitatively, before the offgas then comes into contact with the NO_{X}-sensitive N₂O decomposition catalyst.

Preferably, the N₂O decomposition catalyst is disposed in a radial basket through which the flow passes axially.

The N₂O decomposition catalyst is preferably particulate and comprises at least 50 particles.

In preferred embodiments, step (d) comprises reducing the N₂O content in the offgas by (d₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the N₂O reduction catalyst is disposed in a radial basket through which the flow passes axially.

The N₂O reduction catalyst is preferably particulate and comprises at least 50 particles.

In preferred embodiments, step (d) comprises reducing the N₂O content in the offgas
both by (d₁) decomposing N₂O over an N₂O decomposition catalyst; preferably wherein the N₂O decomposition catalyst is a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type;
and by (d₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the reducing agent in step (d₂) is selected from NH₃, hydrocarbons, CO, H₂ and mixtures thereof; preferably NH₃.

In preferred embodiments, the reducing agent in step (d₂) is NH₃, which is preferably used in an amount of 0.5 to 2.0 molar parts, preferably in an amount of 0.8 to 1.8 molar parts, based on a molar proportion of N₂O to be reduced chemically, i.e. based on the amount of N₂O at the inlet into the catalyst bed of the N₂O reduction catalyst.

In preferred embodiments, the reducing agent in step (d₂) is NH₃, which is preferably used in an amount of 0.5 to 2.0 molar parts, more preferably in an amount of 0.8 to 1.8 molar parts based on the molar amount of N₂O in the offgas at the inlet into the catalyst bed of the N₂O reduction catalyst. This amount is additive to any required amount of NH₃ for NO_{X} reduction if step (e) likewise proceeds in the catalyst bed of the N₂O reduction catalyst.

In other preferred embodiments, the reducing agent is a hydrocarbon or a mixture of two or more hydrocarbons, which are preferably used in an amount of 0.2 to 1.0 molar part, more preferably of 0.2 to 0.7 molar part, based on the molar amount of N₂O in the offgas at the inlet into the catalyst bed of the N₂O reduction catalyst. This amount is likewise additive to any required amount of NH₃ for NO_{X} reduction if step (e) likewise proceeds in the catalyst bed of the N₂O reduction catalyst.

The reducing agent may likewise already be present in the offgas, for example in the form of residual combustion gases and/or oxidation products thereof. In that case, the method of the invention not only reduces the content of nitrogen oxides (NO_{X} and N₂O) but also the content of these impurities (residual combustion gases and/or oxidation products thereof).

In step (e) of the method of the invention, the content of NO_{X} (i.e. NO and NO₂) in the offgas is reduced. This is effected by chemical reduction of NO_{X} with reducing agent over an NO_{X} reduction catalyst. Step (e) of the method of the invention is likewise conducted in the offgas treatment system.

The NO_{X} reduction catalyst preferably contains a zeolitic material; preferably a zeolite laden with transition metal (including lanthanide), in particular with iron, cobalt or copper; more preferably an iron-laden zeolite comprises; even more preferably an iron-laden zeolite of the MFI, BEA, FER, MOR, FAU and/or MEL structure type.

Preferably, the NO_{X} reduction catalyst is disposed in a radial basket through which the flow passes axially.

Preferably, the NO_{X} reduction catalyst is particulate and comprises at least 50 particles.

Preferably, the reducing agent in step (e) is selected from NH₃, hydrocarbons, CO, H₂ and mixtures thereof; preferably NH₃.

Preferably, the reducing agent in step (e) is NH₃, which is used in an amount of 0.9 to 2.5 molar parts, preferably 1.0 to 1.4 molar parts, preferably 1.0 to 1.2 molar parts, based on a molar proportion of NO_{X} to be chemically reduced.

In preferred embodiments, the reducing agent in step (d₂) is the same as the reducing agent in step (e); preferably NH₃.

In addition to NH₃, in steps (d₂) and/or (e) of the method of the invention, other nitrogen-containing reducing agents are also suitable in principle, for example hydrogen compounds of nitrogen, such as azanes, hydroxyl derivatives of azanes, and amines, oximes, carbamates, urea or urea derivatives. Examples of azanes are hydrazine and very particularly ammonia. Examples of hydroxyl derivatives of azanes are hydroxylamine. Examples of amines are primary aliphatic amines, such as methylamine. One example of carbamates is ammonium carbamate. Examples of urea derivatives are N,N′-substituted ureas, such as N,N′-dimethyl urea. Urea and urea derivatives are preferably used in the form of aqueous solutions. Particular preference is given to ammonia or substances that release ammonia on introduction, such as urea or ammonium carbamate.

Particularly preferred process regimes of the invention are elucidated in detail below:

DeNO_{X}-deN₂O—Variant 1

In preferred embodiments, the offgas treatment system comprises a first reaction zone and a second reaction zone beyond, through which the offgas passes successively;
wherein reducing agent is added to the offgas upstream of the first reaction zone;
wherein, in the first reaction zone, the NO_{X} content in the offgas is first reduced by chemical reduction of NO_{X} with reducing agent over an NO_{X} reduction catalyst (step (e)) (deNO_{X} stage); wherein the N₂O content in the offgas is optionally additionally reduced by decomposition of N₂O over an N₂O decomposition catalyst (step (d₁)) and/or by chemical reduction of N₂O with reducing agent over an N₂O reduction catalyst (step (d₂));
wherein further reducing agent is optionally added to the offgas upstream of the second reaction zone; and
wherein, in the second reaction zone, the N₂O content in the offgas is then reduced by decomposition of N₂O over an N₂O decomposition catalyst (step (d₁)) and/or by chemical reduction of N₂O with reducing agent over an N₂O reduction catalyst (step (d₂)) (deN₂O stage); wherein the NO_{X} content in the offgas is optionally additionally further reduced by chemical reduction of NO_{X} over an NO_{X} reduction catalyst (step (e)).

Preferably, the NO_{X} reduction catalyst in the first reaction zone comprises a conventional, preferably non-zeolitic SCR catalyst, for example based on V₂O₅—WO₃—/TiO₂.

Preferably, the temperature of the offgas on entry into the first reaction zone is at most 400° C., preferably at most 350° C.

Preferably, the N₂O decomposition catalyst in the second reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the temperature of the offgas on entry into the second reaction zone is in the range from 300 to 550° C., preferably 350 to 500° C.

Preferably, the offgas after leaving the first reaction zone and before entering the second reaction zone has an NO_{X} content in the range from 0 to 200 ppmv, preferably 1 to 200 ppmv, and an N₂O content in the range from 200 to 2000 ppmv.

DeNO_{X}-deN₂O—Variant 2

In other preferred embodiments, the offgas treatment system likewise comprises a first reaction zone and a second reaction zone beyond, through which the offgas passes successively;
wherein reducing agent is added to the offgas upstream of the first reaction zone;
wherein, in the first reaction zone, the NO_{X} content in the offgas is first reduced by chemical reduction of NO_{X} with reducing agent over an NO_{X} reduction catalyst (step (e)) (deNO_{X} stage); wherein the N₂O content in the offgas is optionally additionally reduced by decomposition of N₂O over an N₂O decomposition catalyst (step (d₁)) and/or by chemical reduction of N₂O with reducing agent over an N₂O reduction catalyst (step (d₂));
wherein further reducing agent is optionally added to the offgas upstream of the second reaction zone; and
wherein, in the second reaction zone, the N₂O content in the offgas is then reduced by decomposition of N₂O over an N2O decomposition catalyst (step (d₁)) and/or by chemical reduction of N₂O with reducing agent over an N2O reduction catalyst (step (d₂)) (deN₂O stage); wherein the NO_{X} content in the offgas is optionally additionally further reduced by chemical reduction of NO_{X} over an NO_{X} reduction catalyst (step (e)).

Preferably, the NO_{X} reduction catalyst in the first reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the temperature of the offgas on entry into the first reaction zone is at least 300° C., more preferably at least 350° C., even more preferably at least 400° C. Preferably, the temperature of the offgas on entry into the first reaction zone is at most 600° C., more preferably at most 550° C.

Preferably, the N₂O decomposition catalyst in the second reaction zone comprises an NO_{X}-sensitive N₂O decomposition catalyst within the context of the invention, which has already been described in detail above.

Preferably, the temperature of the offgas on entry into the second reaction zone is at least 300° C., more preferably at least 350° C., even more preferably at least 400° C. Preferably, the temperature of the offgas on entry into the second reaction zone is at most 600° C., more preferably at most 550° C.

Preferably, the offgas after leaving the first reaction zone and before entering the second reaction zone has an NO_{X} content of at most 20 ppmv, more preferably at most 10 ppmv, even more preferably at most 5 ppmv, and an N₂O content in the range from 200 to 2000 ppmv.

Particularly Preferred Embodiments of deNO_{X}-deN₂O—Variant 2

In particularly preferred embodiments, the offgas treatment system of the invention comprises a first catalyst bed and a spatially separated second catalyst bed; wherein the first catalyst bed is disposed upstream of the second catalyst bed in flow direction of the offgas; wherein a first apparatus with a first control valve for metered addition of NH₃ to the offgas is optionally and preferably disposed upstream of the first catalyst bed; wherein a second apparatus with a second control valve for metered addition of NH₃ to the offgas is disposed downstream of the first catalyst bed and upstream of the second catalyst bed, with which further NH₃ is metered into the offgas; wherein both the first catalyst bed and the second catalyst bed each contain an iron-laden zeolite catalyst; wherein (i) in the first catalyst bed (d₁), N₂O is decomposed; and (e) NO_{X} is incompletely chemically reduced with NH₃, where at least a portion of the NH₃ optionally and preferably comes from incomplete combustion of NH₃ in step (a) (NH₃ slip); and (ii) in the second catalyst bed (d₂), residual N₂O is chemically reduced with NH₃ and (d1*) residual N₂O is optionally decomposed; and (e*) residual NO_{X} is chemically reduced with NH₃.

Preferably, the catalytic decomposition of N₂O in the first catalyst bed is cocatalyzed by NO_{X} present in the offgas.

Preferably, the incomplete chemical reduction of NO_{X} with NH₃ in the first catalyst bed leads down to a predetermined residual NO_{X} content which is sufficient to bring about a cocatalytic effect on the decomposition of N₂O in the first catalyst bed. Since the chemical reduction of NO_{X} with NH₃ in the first catalyst bed typically proceeds much more quickly than the chemical reduction of N₂O with NH₃, and the amount of NO_{X} chemically reduced in the first catalyst bed is not the whole amount, the extent of any parallel chemical reduction of N₂O with NH₃ in the first catalyst bed is typically negligible.

Preferably, additional NH₃ for NO_{X} reduction is metered into the offgas by means of the first apparatus; preferably under feedback control, i.e. a particular value for the concentration of NO_{X} on departure from the first catalyst bed is defined as the target value (setpoint) and the actual concentration of NO_{X} on departure from the first catalyst bed is measured (actual value); and in the event of a difference between setpoint and actual value (control difference), the output of the first control valve is altered in order to minimize the difference. Preferably, the setpoint of the NO_{X} concentration on departure from the first catalyst bed and hence the amount of additional NH₃ is chosen such that the residual concentration of NO_{X} on departure from the first catalyst bed is at most 1000 ppmv, preferably at most 500 ppmv, more preferably at most 100 ppmv. Preferably, the setpoint of the NO_{X} concentration on departure from the first catalyst bed and hence the amount of additional NH₃ is chosen such that the residual concentration of NO_{X} on departure from the first catalyst bed is at least 10 ppmv, preferably at least 20 ppmv, more preferably at least 40 ppmv. The expected specific consumption of NH₃ for the chemical reduction of NO_{X} in the first catalyst bed is typically in the range from 0.9 to 1.1 mol of NH₃ per mole of reduced NO_{X} and is therefore significantly smaller than the expected specific (mol/mol) consumption of NH₃ in the second catalyst bed.

Preferably, the temperature of the offgas on departure from the first catalyst bed is in the range from 400 to 550° C.

Preferably, the offgas on departure from the first catalyst bed has a pressure greater than atmospheric pressure, i.e. ≥1.0 bara, but at most 1.2 bara, more preferably at most 1.1 bara.

Preferably, the offgas on departure from the first catalyst bed has a degree of oxidation of NO_{X} of at least 5.0%, preferably at least 7.5%, more preferably at least 10%, even more preferably at least 12.5%, most preferably at least 15%, and in particular at least 17.5%.

In preferred embodiments, the offgas on departure from the first catalyst bed has a degree of oxidation of NO_{X} in the range from 30% to 50%.

In other preferred embodiments, the offgas on departure from the first catalyst bed has a degree of oxidation of NO_{X} in the range from 15% to 35%, preferably 15% to 30%.

In further preferred embodiments, the offgas on departure from the first catalyst bed has a degree of oxidation of NO_{X} in the range from 10% to 20%.

In other preferred embodiments, the offgas on departure from the first catalyst bed has a degree of oxidation of NO_{X} in the range from 5% to 15%.

Preferably, residual N₂O is broken down in the second catalyst bed down to a residual concentration of N₂O on departure from the second catalyst bed of at most 20 ppmv, more preferably at most 10 ppmv, even more preferably at most 5 ppmv, most preferably at most 2 ppmv.

Preferably, residual NO_{X} is broken down in the second catalyst bed down to a residual concentration of NO_{X} on departure from the second catalyst bed of at most 20 ppmv, more preferably at most 10 ppmv, even more preferably at most 5 ppmv, most preferably at most 2 ppmv.

Preferably, the further NH₃ is metered in with the second apparatus under feed-forward control, i.e. the concentrations of NO_{X} and optionally preferably of N₂O are measured in each case on departure from the first catalyst bed or optionally in each case on entry into the second catalyst bed; the amount of offgas entering the second catalyst bed is taken into account to calculate the amount of NH₃ required for NO_{X} reduction and optionally preferably the sum total of that required for NO_{X} reduction and for N₂O reduction with the aid of stored ratios, i.e., for example, molar ratios (mol/mol) of NH₃/NO_{X} and optionally preferably of NH₃/N₂O or factors derived therefrom; and the calculated result (manipulated variable) is used to alter the output of the second control valve in order to meter in the required amount of NH₃.

Preferably in accordance with the invention, the molar NH₃ concentration [NH₃] of the offgas on entry into the second catalyst bed is in the range from the sum of 0.7×[N₂O] and 1.0×[NO_{X}] to the sum of 4.0×[N₂O] and 2.0×[NO_{X}], more preferably in the range from the sum of 1.0×[N₂O] and 1.1×[NO_{X}] to the sum of 3.0×[N₂O] and 1.6×[NO_{X}], even more preferably in the range from the sum of 1.5×[N₂O] and 1.2×[NO_{X}] to the sum of 2.5×[N₂O] and 1.4×[NO_{X}], where [N₂O] is the molar concentration of N₂O and [NO_{X}] is the molar concentration of NO_{X}, each in the offgas on entry into the second catalyst bed.

Preferably, for the feed-forward control of the metered addition of NH₃ into the second catalyst bed with regard to the NO_{X} reduction, a molar ratio of NH₃/NO_{X} in the range from 1.0 to 2.0; preferably 1.1 to 1.6; more preferably 1.2 to 1.4 is chosen.

Preferably, for the feed-forward control of the metered addition of NH₃ into the second catalyst bed with regard to the N₂O reduction, a molar ratio of NH₃/N₂O in the range from 0.7 to 4.0; preferably 1.0 to 3.0; more preferably 1.5 to 2.5 is chosen.

Preferably, the further NH₃ is not metered in with the second apparatus under feedback control, since the aim is maximum chemical reduction of NO_{X} in the second catalyst bed, meaning that the result is zero or only very small residual concentrations of NO_{X} and N₂O, which would be of limited utility as control variables.

Preferably, the amount of catalyst, i.e. the space velocity (=ratio of offgas volume flow rate under standard conditions to catalyst volume) is chosen in such a way that breakdown of N₂O is at least 50% in the first catalyst bed, preferably at least 70%, more preferably at least 80%, based on the concentration of N₂O on entry into the first catalyst bed.

Preferably, the catalyst amount and the amount of additional NH₃ are chosen such that, on departure from the first catalyst bed, the molar ratio of NO_{X}/N₂O is at least 5, more preferably at least 10, even more preferably at least 20.

The space velocity of the first catalyst bed is preferably in the range from 5000 h⁻¹ to 100 000 h⁻¹, more preferably 10 000 h⁻¹ to 50 000 h⁻¹, even more preferably 15 000 h⁻¹ to 45 000 h⁻¹.

If the molar ratio of NO_{X}/N₂O on departure from the first catalyst bed is at least 10, the metered addition of NH₃ to the second catalyst bed via the second apparatus can preferably be effected solely in relation to the amount of incoming NO_{X}.

Preferably, the temperature of the offgas on entry into the first catalyst bed is at least 400° C., more preferably at least 425° C., even more preferably at least 450° C. Preferably, the temperature of the offgas on entry into the first catalyst bed is at most 550 C, more preferably at most 525 C, even more preferably at most 500° C. The temperature can be adjusted by measures known to those skilled in the art, in particular design of heat exchangers and conditions for the combustion of NH₃.

Depending on the exothermicity of the chemical reactions that proceed in the first catalyst bed and in the second catalyst bed, the inlet temperature of the offgas into the first catalyst bed is preferably chosen such that the temperature of the offgas on departure from the second catalyst bed is at most 600° C., more preferably at most 550° C., even more preferably at most 520° C.

The space velocity of the second catalyst bed is preferably in the range from 5000 h⁻¹ to 100 000 h⁻¹, more preferably 10 000 h⁻¹ to 50 000 h⁻¹, even more preferably 15 000 h⁻¹ to 45 000 h⁻¹.

Preferably, the ratio of catalyst volumes (V1_{cat}/V2_{ca}t) of the first catalyst bed V1_{cat} to the second catalyst bed V2_{cat} is in the range from 1/2 to 20/1, preferably 1/2 to 10/1, more preferably 1/1 to 4/1.

In preferred embodiments, at least one, more than one or all of the following conditions are met:
the pressure of the offgas on entry into the first catalyst bed is at most 5 bara, preferably at most 4 bara, more preferably at most 1.3 bara, most preferably at most 1.2 bara and in particular at most 1.1 bara;
the H₂O content in the offgas on entry into the first catalyst bed is at least 5% by volume, preferably at least 10% by volume, more preferably at least 15% by volume, most preferably at least 20% by volume and in particular at least 25% by volume;
the NO_{X} content in the offgas on entry into the first catalyst bed is at least 500 ppmv, more preferably at least 1000 ppmv, even more preferably at least 1500 ppmv, most preferably at least 2000 ppmv, and in particular at least 2500 ppmv;
the N₂O content in the offgas on entry into the first catalyst bed is at most <500 ppmv, more preferably at most 200 ppmv, even more preferably at most 100 ppmv, but at least 5 ppmv, preferably at least 10 ppmv, more preferably at least 50 ppmv;
the offgas on entry into the first catalyst bed contains uncombusted residues of NH₃ from the combustion of NH₃;
the N₂O decomposition catalyst and/or the N₂O reduction catalyst takes the form of a honeycomb body;
the NO_{X} reduction catalyst take the form of a honeycomb body;
the first catalyst bed contains Fe zeolite;
the second catalyst bed contains Fe zeolite;
the offgas passes through a heat exchanger before entering the first catalyst bed and is heated therein;
the NO_{X} content on departure from the first catalyst bed is at most 1000 ppmv, preferably at most 500 ppmv, more preferably at most 300 ppmv, most preferably at most 100 ppmv; but preferably at least 10 ppmv, more preferably at least 20 ppm, more preferably at least 40 ppmv, most preferably at least 100 ppmv, and in particular at least 250 ppmv;
the N₂O content on departure from the first catalyst bed is at most 20 ppmv, more preferably at most 15 ppmv, even more preferably at most 10 ppmv, most preferably at most 5 ppmv and in particular at most 2 ppmv;
there is no intermediate cooling of the offgas after departure from the first catalyst bed up to entry into the second catalyst bed;
the molar ratio of N₂O:NO_{X} on entry into the first catalyst bed is at most 0.5, more preferably at most 0.2, even more preferably at most 0.1;
the molar ratio of N₂O:NO_{X} on departure from the first catalyst bed is at most 0.20, more preferably at most 0.1, even more preferably at most 0.05;
the feeding of NH₃ into the offgas upstream of the first catalyst bed in flow direction of the offgas is optional; if there is feeding, it is preferably substoichiometric with respect to the NO_{X} content on entry into the first catalyst bed;
the feeding of NH₃ into the offgas downstream of the first catalyst bed and upstream of the second catalyst bed in flow direction of the offgas is obligatory and preferably superstoichiometric with respect to the total content of NO_{X} and N₂O on entry into the second catalyst bed.

The above-described method using Fe zeolite catalysts in two catalyst beds, by comparison with conventional deNO_{X} methods using V₂O₅/TiO₂ catalysts, enables
complete or almost complete breakdown of large amounts of NO_{X} without the risk of NH₃ slip; and
simultaneous, complete or virtually complete breakdown of N₂O
   at comparatively low catalyst volumes, i.e. at comparatively high space velocities.

Aside from the operating method of the invention, this is achieved by the oxidative properties of the Fe zeolite catalysts used in accordance with the invention. Thus, in the first catalyst bed, the molar ratio of NO to NO₂, according to the invention, is brought as close as possible to the thermodynamic equilibrium position. For instance, the degree of oxidation of NO_{X} (molar ratio of NO₂/(NO+NO₂)) prior to entry into the first catalyst bed, because of the upstream NH₃ combustion at very high temperatures and the only slow establishment of the equilibrium in the gas phase when the offgas is cooled in any downstream heat exchanger(s), is less than 5% as expected, and hence well below the thermodynamic equilibrium applicable to the inlet temperature into the first catalyst bed. However, this is very disadvantageous for an efficient chemical reduction of NO_{X} since, as a result, only a small portion of the NO_{X} present in the offgas can be broken down by a fast SCR and a majority of the NO_{X} or of the remaining NO has to be broken down by significantly slower normal SCR.

The chosen mode of operation of the limited metered addition of NH₃ in the first catalyst bed and the ability of the Fe zeolite catalysts to oxidize NO or to catalytically accelerate the establishment of equilibrium results in achievement of a distinctly faster, i.e. more efficient, chemical reduction of NO_{X}, and at the same time establishment of the maximum possible degree of oxidation of NO_{X} in the exiting residual NO_{X}. This enables efficient chemical reduction of NO_{X} in the second catalyst bed too from the very start.

It has thus been found that large amounts of NH₃, as needed for complete chemical reduction of high concentrations of NO_{X}, similarly to water, inhibit the establishment of the NO_{X} equilibrium on the Fe zeolite catalyst.

In addition, the chemical reduction of NO_{X} as such is likewise inhibited by NH₃ itself in the case of a correspondingly high dosage of NH₃. As a result, depending on temperature, amount of catalyst and NO_{X} content, no further increase in NO_{X} breakdown occurs with rising addition of NH₃ over and above a particular amount of NH₃. In the case of a further increase in the addition of NH₃, it is then even possible under some circumstances that a decline in NO_{X} breakdown will be observed with a simultaneous NH₃ slip.

Chemical reduction of the NO_{X} previously in the first catalyst bed distinctly reduces the amount of NH₃ needed for chemical reduction of NO_{X} in the second catalyst bed.

In this way, together with the above-described establishment or permanent readjustment of the NO_{X} equilibrium, a very efficient chemical reduction of NO_{X} is also possible in the second catalyst bed, even with the superstoichiometric metered addition of NH₃ in accordance with the invention.

The fact that this is additionally effected in accordance with the invention with a zero or only insignificant NH₃ slip of preferably at most 10 ppmv, more preferably at most 5 ppmv, even more preferably at most 3 ppmv is likewise because of the oxidative properties of the Fe zeolite catalysts used in accordance with the invention. If the inlet temperature of the offgas into the second catalyst bed is preferably at least 400° C., more preferably at least 425° C., even more preferably at least 450° C., the NH₃ metered in in excess within the limits of the invention is selectively oxidized by the residual oxygen content of the offgas present to N₂ and H₂O.

All these advantages cannot be achieved in a single or multistage arrangement when using conventional V₂O₅/TiO₂-based SCR catalysts as typically also used for denoxing of offgases from natural gas-fired reformers. Thus, for reasons of stability, these conventional SCR catalysts typically cannot be operated at temperatures above 400° C., which limits the achievable speeds of the breakdown reaction. It is also the case that conventional SCR catalysts have only very limited oxidation activity, and so establishment or permanent readjustment of the NO_{X} equilibrium is not possible, nor do these catalysts enable effective and N₂-selective oxidation of NH₃ metered in in excess. Instead, there is then even a risk of unwanted formation of N₂O.

In a variant of the above-described embodiments which is preferred in accordance with the invention, the first catalyst bed and the second catalyst bed contain the same catalyst. In preferred embodiments, the second apparatus with a second control valve for metered addition of NH₃ to the offgas is omitted, while the spatial separation of the first catalyst bed from the second catalyst bed is preferably omitted—in that case, there is in fact only a single shared catalyst bed, with a first apparatus having a first control valve for metered addition of NH₃ to the offgas preferably disposed upstream of this shared catalyst bed. Additional NH₃ is preferably metered into the offgas via the first apparatus; preferably under feed-forward control, i.e. the concentration of NO_{X}, N₂O and NH₃ in the offgas upstream of the shared catalyst bed is measured; the amount of offgas entering the shared catalyst bed is taken into account to calculate the additional amount of NH₃ still required; and the calculated result (manipulated variable) is used to alter the output of the first control valve in order to meter in the amount of additional NH₃ still required. Preferably, in such embodiments, an NH₃ oxidation catalyst is disposed downstream of the shared catalyst bed in order to reduce possible NH₃ slip.

Simultaneous Firing of NH₃ and CH₄—Reduction of the Hydrogen Cyanide Content

In preferred embodiments, in step (a), a mixture of CH₄ and NH₃ with air and/or oxygen is combusted to produce an offgas additionally containing CO₂, CO and HCN as well as NO_{X} and N₂O.

In these cases, the first catalyst bed preferably assumes the additional function of catalytic cracking of HCN by hydrolysis with water present in the offgas to give the CO and NH₃ products as follows: HCN+H₂O↔CO+NH₃. The CO and NH₃ products formed can then, with regard to NH₃, preferably be utilized for NO_{X} reduction in the first catalyst bed, and, with regard to CO, preferably for N₂O reduction in the second catalyst bed as reducing agent for the elimination of N₂O and NO_{X} in the offgas.

The content of HCN in the offgas, as a pollutant and greenhouse gas, has to be limited or eliminated owing to its toxicity and longevity in the atmosphere and its absorption in the infrared. The fact that when HCN is broken down in accordance with the invention over zeolite catalysts in the first catalyst bed with CO and NH₃, cracking products are formed that are suitable as reducing agents for the further offgas aftertreatment of NO_{X} and N₂O in the second catalyst bed completes the singularity of the inventive offgas treatment over zeolite catalysts. Conventional SCR catalysts based on vanadium oxide show virtually no activity for HCN hydrolysis and are therefore unsuitable for elimination of HCN from offgases. In this case, a downstream oxidation catalyst would have to be used.

DeN₂O—deNO_{X}

In further preferred embodiments, the offgas treatment system comprises a first reaction zone and a second reaction zone beyond, through which the offgas passes successively;
wherein reducing agent is added to the offgas between the first reaction zone and the second reaction zone;
wherein, in the first reaction zone, the N₂O content in the offgas is first reduced by decomposition of N₂O over an N₂O decomposition catalyst (step (d₁)) (deN₂O stage); and
wherein, in the second reaction zone, the NO_{X} content in the offgas is then reduced by chemical reduction of NO_{X} with reducing agent over an NO_{X} reduction catalyst (step (e)) (deNO_{X} stage); wherein the N₂O content in the offgas is optionally additionally further reduced by further decomposition of N₂O over an N₂O decomposition catalyst (step (d₁)) and/or by chemical reduction of N₂O with reducing agent over an N₂O reduction catalyst (step (d₂)).

Preferably, no reducing agent is added to the offgas upstream of the first reaction zone.

Such a process regime is particularly preferred in accordance with the invention. It makes it possible first to adjust the relative content of NO_{X} and N₂O without consumption of reducing agents. While the absolute NO_{X} content in the first reaction zone remains virtually unchanged, the N₂O content in the offgas is selectively reduced by decomposition. This can be effected to an extent as required to establish the desired relative content of NO_{X} and N₂O. For economic reasons, the chosen amount of the N₂O decomposition catalyst is preferably not so great as to achieve quantitatively complete reduction of the N₂O content in the offgas by decomposition (0 ppmv); instead, a compromise is found between breakdown rate and dimensions of the N₂O decomposition catalyst.

In preferred embodiments, the N₂O decomposition catalyst in the first reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

In other preferred embodiments, the N₂O decomposition catalyst in the first reaction zone comprises an NO_{X}-sensitive N₂O decomposition catalyst within the context of the invention, which has already been described above.

In preferred embodiments, the NO_{X} reduction catalyst in the second reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the first reaction zone and the second reaction zone are operated here at different temperature levels.

Preferably,
the N₂O decomposition catalyst in the first reaction zone comprises an NO_{X}-sensitive N₂O decomposition catalyst; wherein the offgas temperature in the first reaction zone is preferably at least 450° C., more preferably at least 500° C., even more preferably at least 550° C., most preferably at least 600° C.; and
the NO_{X} reduction catalyst in the second reaction zone is a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type; where the offgas temperature in the second reaction zone is preferably at most 550° C., more preferably at most 500° C., even more preferably at most 450° C., most preferably at most 400° C.; and wherein, in addition to the chemical reduction of NO_{X}, the (residual) N₂O content is preferably further reduced in the second reaction zone by decomposition and/or chemical reduction.

Preferably, in the first reaction zone, the space velocity is set in such a way that the N₂O content in the offgas is reduced in the first reaction zone by at most 95%, preferably by at most 90%, preferably by at most 85%, based on the N₂O content in the offgas on entry into the first reaction zone.

In preferred embodiments, the N₂O content in the offgas after leaving the first reaction zone and before entering the second reaction zone is at least 20 ppmv, more preferably at least 40 ppmv, even more preferably at least 60 ppmv, most preferably at least 80 ppmv and in particular at least 100 ppmv.

In preferred embodiments, the N₂O content in the offgas after leaving the first reaction zone and before entering the second reaction zone is at most 400 ppmv, more preferably at most 300 ppmv, even more preferably at most 200 ppmv, most preferably at most 100 ppmv and in particular at most 50 ppmv.

Preferably, in the second reaction zone, the space velocity is set in such a way that the N₂O content in the offgas is further reduced in the second reaction zone by at least 30%, preferably by at least 40%, more preferably by at least 50%, based on the N₂O content in the offgas on entry into the second reaction zone. Since reducing agents are present in the second reaction zone, further reduction of the N₂O content in the second reaction zone can be achieved both by decomposition over an N₂O decomposition catalyst (step (d₁)) and by chemical reduction with reducing agent over an N₂O reduction catalyst (step (d₂)).

Preferably, in the second reaction zone, the N₂O content in the offgas is further reduced by chemical reduction of N₂O with reducing agent over an N₂O reduction catalyst (step (d₂)).

In addition, the NO_{X} content is reduced in the second reaction zone by chemical reduction with reducing agent over an NO_{X} reduction catalyst. This reduction typically has fast kinetics and preferably proceeds virtually quantitatively in accordance with the invention.

### Step (f):

In the optional and preferred step (f) of the method of the invention, the offgas is cooled in at least one heat exchanger disposed downstream of the offgas treatment system in flow direction of the offgas.

In preferred embodiments, the offgas is cooled in a single heat exchanger disposed downstream of the offgas treatment system in flow direction of the offgas.

In other preferred embodiments, the offgas is cooled successively in at least two heat exchangers disposed downstream of the offgas treatment system in flow direction of the offgas (cf. FIGS. 2, 3 and 4).

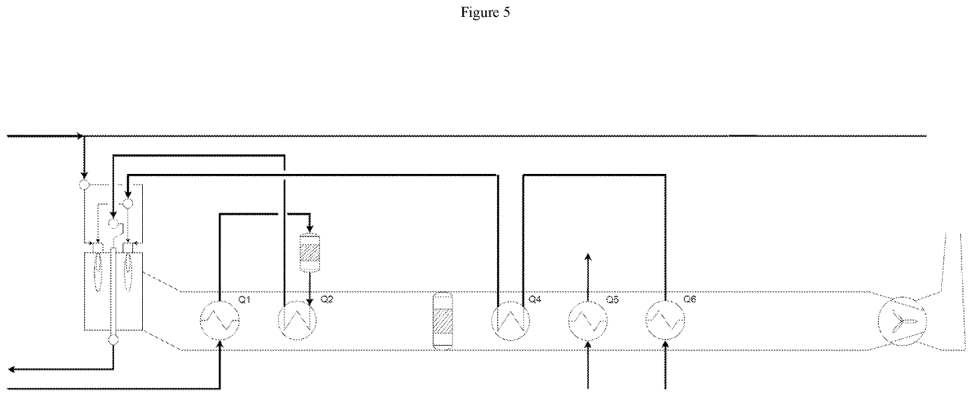

In further preferred embodiments, the offgas is cooled successively in at least three heat exchangers disposed downstream of the offgas treatment system in flow direction of the offgas (cf. FIG. 5).

In other preferred embodiments, the offgas is cooled successively in at least four heat exchangers disposed downstream of the offgas treatment system in flow direction of the offgas.

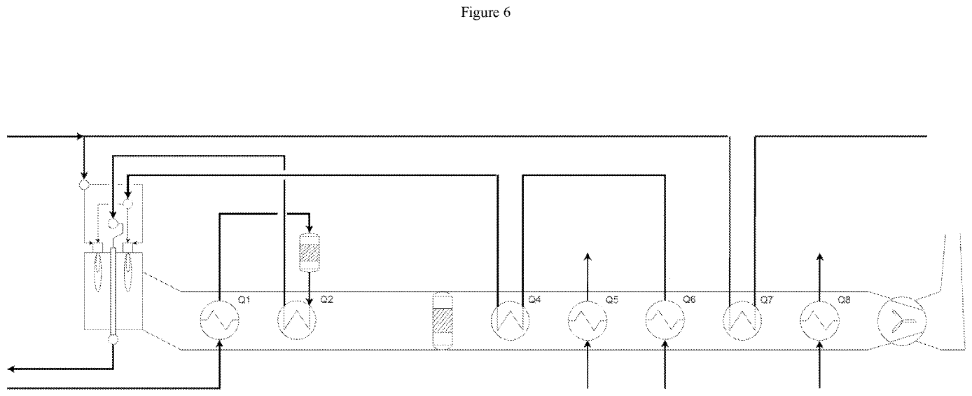

In further preferred embodiments, the offgas is cooled successively in at least five heat exchangers disposed downstream of the offgas treatment system in flow direction of the offgas (cf. FIG. 6).

The offgas is cooled in the at least one heat exchanger by release of heat from the offgas to a heat transfer medium.

Preferably in accordance with the invention, the heat transfer medium used is selected from the group consisting of water, water vapor, combustion air, NH₃ and combinations thereof. Water or water vapor is particularly preferred as heat transfer medium, for reasons of safety among others.

In preferred embodiments, in step (f) of the method of the invention, the offgas is cooled in a first offgas/H₂O heat exchanger disposed downstream of the offgas treatment system in flow direction of the offgas. The H₂O is heated in the first offgas/H₂O heat exchanger by absorption of heat from the offgas. Preferably, the heated H₂O, which may be in liquid form and/or in the form of water vapor, is used for heating of NH₃. Preferably, for this purpose, an H₂O/NH₃ heat exchanger is disposed downstream of the first offgas/H₂O heat exchanger in flow direction of the H₂O, in which NH₃ is heated by absorbing heat from the H₂O (cf FIGS. 2-6).

In preferred embodiments, in step (f) of the method of the invention, the offgas is cooled in a first offgas/combustion air heat exchanger disposed downstream of the offgas treatment system in flow direction of the offgas. The combustion air is heated in the first offgas/combustion air heat exchanger by absorbing heat from the offgas. Preferably, the heated combustion air is used for combustion of NH₃ and H₂ in the combustion device, which for this purpose is disposed downstream of the first offgas/combustion air heat exchanger in flow direction of the combustion air (cf. FIGS. 2-6).

In other preferred embodiments, the offgas is cooled in step (f) of the method of the invention
in an above-described first offgas/H₂O heat exchanger disposed downstream of the offgas treatment system in flow direction of the offgas, and
in an above-described first offgas/combustion air heat exchanger, also disposed downstream of the offgas treatment system in flow direction of the offgas; preferably downstream of the first offgas/H₂O heat exchanger (cf FIGS. 2-6).

In further preferred embodiments, the offgas is cooled in step (f) of the method of the invention
in a first offgas/combustion air heat exchanger disposed downstream of the offgas treatment system in flow direction of the offgas, and
in a second offgas/combustion air heat exchanger disposed downstream of the first offgas/combustion air heat exchanger in flow direction of the offgas.

The combustion air is heated in the first offgas/combustion air heat exchanger and in the second offgas/combustion air heat exchanger, in each case by absorbing heat from the offgas. Preferably, the offgas flows first through the first offgas/combustion air heat exchanger and then through the second offgas/combustion air heat exchanger. Preferably, the combustion air flows first through the second offgas/combustion air heat exchanger and then through the first offgas/combustion air heat exchanger, which is the reason why the first offgas/combustion air heat exchanger is preferably disposed downstream of the second offgas/combustion air heat exchanger in flow direction of the combustion gas.

Preferably, the heated combustion air is used for combustion of NH₃ and H₂ in the combustion device, which for this purpose is disposed downstream of the first offgas/combustion air heat exchanger in flow direction of the combustion air (cf. FIGS. 5 and 6).

In other preferred embodiments, the offgas is cooled in step (f) of the method of the invention
in an above-described first offgas/combustion air heat exchanger disposed downstream of the offgas treatment system in flow direction of the offgas,
in an above-described first offgas/H₂O heat exchanger disposed downstream of the first offgas/combustion air heat exchanger in flow direction of the offgas, and
in an above-described second offgas/combustion air heat exchanger disposed downstream of the first offgas/H₂O heat exchanger in flow direction of the offgas (cf. FIGS. 4-6).

The offgas then preferably flows first through the first offgas/combustion air heat exchanger, then through the first offgas/H₂O heat exchanger, and subsequently through the second offgas/combustion air heat exchanger.

In preferred embodiments, the offgas is cooled in step (f) of the method of the invention in at least one offgas/combustion gas heat exchanger disposed downstream of the offgas treatment system in flow direction of the offgas, preferably downstream of the above-described first offgas/combustion air heat exchanger, the above-described first offgas/H₂O heat exchanger, and/or the above-described second offgas/combustion air heat exchanger. The combustion gas is heated in the offgas/combustion gas heat exchanger by absorbing heat from the offgas. Preferably, the heated combustion gas is used for combustion in the combustion device, which for this purpose is disposed downstream of the offgas/combustion gas heat exchanger in flow direction of the combustion gas (cf. FIG. 6).

In preferred embodiments, the offgas is cooled in step (f) of the method of the invention in at least one second offgas/H₂O heat exchanger disposed downstream of the offgas treatment system in flow direction of the offgas, preferably downstream of the above-described first offgas/combustion air heat exchanger, the above-described first offgas/H₂O heat exchanger, and/or the above-described second offgas/combustion air heat exchanger. The H₂O is heated in the second offgas/H₂O heat exchanger by absorbing heat from the offgas (cf FIG. 6).

In other preferred embodiments, the offgas is cooled in step (f) of the method of the invention
in an above-described first offgas/combustion air heat exchanger disposed downstream of the offgas treatment system in flow direction of the offgas,
in an above-described first offgas/H₂O heat exchanger disposed downstream of the first offgas/combustion air heat exchanger in flow direction of the offgas,
in an above-described second offgas/combustion air heat exchanger disposed downstream of the first offgas/H₂O heat exchanger in flow direction of the offgas, and
in an above-described offgas/combustion gas heat exchanger disposed downstream of the second offgas/combustion air heat exchanger in flow direction of the offgas (cf. FIG. 6).

In further preferred embodiments, the offgas is cooled in step (f) of the method of the invention
in an above-described first offgas/combustion air heat exchanger disposed downstream of the offgas treatment system in flow direction of the offgas,
in an above-described first offgas/H₂O heat exchanger disposed downstream of the first offgas/combustion air heat exchanger in flow direction of the offgas,
in an above-described second offgas/combustion air heat exchanger disposed downstream of the first offgas/H₂O heat exchanger in flow direction of the offgas, and
in an above-described second offgas/H₂O heat exchanger disposed downstream of the second offgas/combustion air heat exchanger in flow direction of the offgas (cf. FIG. 6).

In other preferred embodiments, the offgas is cooled in step (f) of the method of the invention
in an above-described first offgas/combustion air heat exchanger disposed downstream of the offgas treatment system in flow direction of the offgas,
in an above-described first offgas/H₂O heat exchanger disposed downstream of the first offgas/combustion air heat exchanger in flow direction of the offgas,
in an above-described second offgas/combustion air heat exchanger disposed downstream of the first offgas/H₂O heat exchanger in flow direction of the offgas,
in an above-described offgas/combustion gas heat exchanger disposed downstream of the second offgas/combustion air heat exchanger in flow direction of the offgas, and
in an above-described second offgas/H₂O heat exchanger disposed downstream of the offgas/combustion gas heat exchanger in flow direction of the offgas (cf. FIG. 6).

High offgas temperatures lead to considerable stress on the material used as a result of establishment of high wall temperatures at least in the upstream heat exchangers in flow direction of the offgas in the offgas duct, which can lead to reduced service life or a change to a more complex and costlier material. Therefore, one factor in considering the effectiveness of an offgas duct configuration is the inlet temperature of the offgas into the duct. The NH₃ has to be preheated to a temperature defined by the requirements of the process. On the other hand, for example, the preheating temperature of the combustion air constitutes a degree of freedom in the design since it is not subject to any direct requirements other than efficient energy integration. The inlet temperature of the offgas into the offgas duct is therefore limited at the lower end by the preheating temperatures imposed by the requirements of the process in the tubular reactors of analogous design to a primary reformer or possible preliminary reactors (preferably adiabatic fixed bed reactors).

Heterogeneous catalysts achieve higher reaction rates at higher temperatures by acceleration of diffusion and kinetics. However, their operation is often limited by their falling stability against deactivation at high temperatures. For the offgas treatment system, there is therefore an optimal operating window in which it achieves high reaction rates, which is in turn manifested in high permissible space velocities of the gas supplied, which in turn reduces the required catalyst volume. However, this window is below the region in which operation leads to deactivation and loss of catalytic effectiveness. A further criterion for the assessment of efficient energy integration is therefore whether the inlet temperature of the offgas into the offgas treatment system is within this optimum window.

The third factor in assessing the effectiveness of an offgas duct configuration is the inlet temperature of the offgas into the chimney. Together with the mass flow of the offgas, this determines the loss of energy via the stream compared to the theoretical optimum, attained at the dewpoint of water plus the required safety margin of 25 K.

The yield of H₂ should be as high as possible in order to increase the economic viability of operation of the plant. A high yield is typically directly associated with a low inlet temperature of the offgas into the chimney. However, if this aim cannot be achieved without minimizing the required inlet temperature of the offgas into the chimney, or providing a suitable inlet temperature for the offgas treatment system, the chosen design of the offgas duct will not be very successful.

### Closed-Loop Control

Regardless of the respective process regime, the method of the invention is preferably under closed-loop control.

In preferred embodiments, depending on the mode of construction of the firing system, preferably of the combustion device, for closed-loop control of the method of the invention, the first measured variable measured is at least one parameter which is characteristic of the current operating state of the firing system, preferably of the combustion device. Preferably, this first measured variable or the parameter is selected from the group consisting of combustion temperature and NH₃ consumption of the firing system, preferably the combustion device.

Depending on the characteristics of the offgas that leaves the firing system, preferably the combustion device, in particular
NO_{X} content in the offgas;
degree of oxidation of NO_{X} in the offgas;
N₂O content in the offgas;
content of other constituents in the offgas, for example H₂O, O₂, and N₂;
offgas temperature;
offgas pressure; and
offgas volume flow rate;
the method conditions can be optimized in order to achieve an efficient and economically viable reduction of the content of NO_{X} and N₂O in the offgas.

In preferred embodiments, therefore, for control of the method of the invention, at least one parameter characteristic of the current state of the offgas prior to entry into the offgas treatment system is measured on departure from the firing system, preferably the combustion device; and/or on entry into the offgas treatment system as a second measured variable, either in addition to the first measured variable or instead of the first measured variable. Preferably, this second measured variable or parameter is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.

In preferred embodiments, therefore, for control of the method of the invention, at least one parameter characteristic of the current state of the offgas on departure from the offgas treatment system is measured on departure from the offgas treatment system as a third measured variable, either in addition to the first measured variable or instead of the first measured variable, and either in addition to the second measured variable or instead of the second measured variable. Preferably, this third measured variable or parameter is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.

In preferred embodiments, especially when the offgas treatment system comprises a first reaction zone and a second reaction zone through which the offgas passes successively, wherein reducing agent is fed in between the first reaction zone and the second reaction zone, for control of the method of the invention, at least one parameter characteristic of the current state of the offgas after leaving the first reaction zone and before entering the second reaction zone is measured on departure from the first reaction zone and before entry into the second reaction zone as a fourth measured variable, either in addition to the first measured variable or instead of the first measured variable, and either in addition to the second measured variable or instead of the second measured variable, and either in addition to the third measured variable or instead of the third measured variable. Preferably, this fourth measured variable or parameter is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.

Depending on the first measured variable and/or second measured variable and/or the third measured variable and/or the fourth measured variable, at least one manipulated variable is preferably modified for open-loop or closed-loop control of the method of the invention. Preferably, therefore, the open-loop or closed-loop control of the method is based on the first measured variable and/or on the second measured variable and/or on the third measured variable and/or on the fourth measured variable by means of a controlled change in the manipulated variable (control variable), preferably by a controlled change in the amount of reducing agent metered in.

In terms of preferred manipulated variables, a distinction is necessary between
process conditions that can be changed at short notice only with a relatively high apparatus complexity, if at all, and
process conditions that can be changed at short notice and are therefore of better suitability for control of the method.

Preferably in accordance with the invention,
the dimensions of the offgas treatment apparatus;
the nature, amount and flow direction of the N₂O decomposition catalyst and/or N₂O reduction catalyst;
the nature, amount and flow direction of the NO_{X} reduction catalyst;
the type of reducing agent;
the offgas pressure;
the feed-in position of reducing agents; and
the relative arrangement of the first reaction zone and the second reaction zone are not manipulated variables, i.e. these parameters remain preferably constant during the performance of the method of the invention.

However, these parameters may be chosen or adjusted in the planning and design of the offgas treatment system such that control of the method of the invention is possible within wide limits. In this way, it also is possible to react to changes at short notice, for instance with regard to the offgas to be treated. An efficient and economically viable reduction of the content of NO_{X} and N₂O in the offgas remains assured without unwanted breakthrough of reducing agents (called slippage).

Manipulated variables (control variables) that are preferred in accordance with the invention are:
the amount of reducing agent;
if appropriate the offgas temperature; and
if appropriate the temperature of the catalysts.

Preferably, the offgas leaving the offgas treatment system has a residual NO_{X} content of at most 20 ppmv, preferably at most 15 ppmv, more preferably at most 10 ppmv, even more preferably at most 7.5 ppmv, most preferably at most 5.0 ppmv, and in particular at most 2.5 ppmv.

Preferably, the offgas leaving the offgas treatment system has a residual N₂O content of at most 20 ppmv, preferably at most 15 ppmv, more preferably at most 10 ppmv, even more preferably at most 7.5 ppmv, most preferably at most 5.0 ppmv, and in particular at most 2.5 ppmv.

A further aspect of the invention relates to an apparatus comprising
(i) a with NH₃ firing system, preferably comprising a combustion device for combustion of NH₃ and an NH₃ decomposition device for cracking of NH₃ to N₂ and H₂, and
(ii) an offgas treatment system;
   wherein the device is configured to perform the above-described method of the invention.

The apparatus of the invention is preferably a plant complex for production of pure hydrogen, comprising
one (or more) NH₃ decomposition device(s) for catalytic decomposition of NH₃ to N₂ and H₂, preferably a catalyst-filled reactor;
a combustion device for direct or indirect heating of the NH₃ decomposition device(s), preferably comprising a combustion chamber and at least one burner for combustion of a fuel with (air) oxygen, wherein the fuel contains or consists essentially of NH₃;
a device for purifying a product stream from the NH₃ decomposition device, preferably by PSA;
an offgas treatment system for cleaning the offgases from the combustion device, comprising one or more catalyst beds for reducing NO_{X}, optionally for N₂O reduction and/or N₂O decomposition, and preferably for oxidation of unconverted reducing agents and/or incompletely oxidized reaction products thereof (preferably a downstream catalyst bed with NH₃ oxidation catalyst).

Preferred embodiments of the invention are summarized below as sentences:
Satz 1: A method of reducing the content of NO_{X} and N₂O in the offgas of an NH₃-operated firing system, the process comprising the following steps: (a) combusting NH₃ to operate the firing system, preferably a furnace, preferably comprising combustion device and NH₃ decomposition device, for catalytic decomposition of NH₃ to N₂ and H₂, to produce an offgas which comprises N₂, H₂O, NO_{X} and N₂O and which leaves the firing system; (b) optionally and preferably cooling the offgas in at least one heat exchanger disposed downstream of the firing system in flow direction of the offgas; (c) transferring the optionally cooled offgas into an offgas treatment system; (d) reducing the N₂O content in the offgas by (d₁) decomposing N₂O over an N₂O decomposition catalyst and/or (d₂) chemically reducing N₂O with reducing agent over an N₂O reduction catalyst; (e) reducing the NO_{X} content in the offgas by chemical reduction of NO_{X} with reducing agent over an NO_{X} reduction catalyst; and (f) optionally and preferably cooling the offgas in at least one heat exchanger disposed downstream of the offgas treatment system in flow direction of the offgas.
Satz 2: The method according to sentence 1 for reducing the content of NO_{X} and N₂O in the offgas of an NH₃- and H₂-operated firing system integrated into a system for catalytic decomposition of NH₃ to N₂ and H₂, the method comprising the following steps: (a) combusting NH₃ and H₂ to operate the firing system (preferably in a combustion device) to produce an offgas which comprises N₂, H₂O, NO_{X} and N₂O and leaves the firing system; (b) optionally and preferably cooling the offgas in at least one heat exchanger disposed downstream of the firing system in flow direction of the offgas; (c) transferring the optionally cooled offgas into an offgas treatment system disposed downstream of the firing system and optionally the at least one heat exchanger in flow direction of the offgas; (d) reducing the N₂O content in the offgas by (d₁) decomposing N₂O over an N₂O decomposition catalyst and/or (d₂) chemically reducing N₂O with reducing agent over an N₂O reduction catalyst; (e) reducing the NO_{X} content in the offgas by chemical reduction of NO_{X} with reducing agent over an NO_{X} reduction catalyst; and (f) optionally and preferably cooling the offgas in at least one heat exchanger disposed downstream of the offgas treatment system in flow direction of the offgas.
Satz 3: The method according to either of the preceding sentences, wherein the offgas is cooled in a single heat exchanger disposed downstream of the firing system in flow direction of the offgas.
Satz 4: The method according to any of the preceding sentences, wherein the offgas is cooled successively in at least two heat exchangers disposed downstream of the firing system in flow direction of the offgas.
Satz 5: The method according to any of the preceding sentences, wherein the offgas is cooled successively in at least three heat exchangers disposed downstream of the firing system in flow direction of the offgas.
Satz 6: The method according to any of the preceding sentences, wherein the offgas is cooled in step (b) in the at least one heat exchanger by releasing heat from the offgas to a heat transfer medium, wherein the heat transfer medium used is preferably NH₃ which is then supplied to the catalytic decomposition in an NH₃ decomposition device over an NH₃ decomposition catalyst.
Satz 7: The method according to any of the preceding sentences, wherein the offgas is cooled in step (b) in at least one first offgas/NH₃ heat exchanger disposed downstream of the firing system in flow direction of the offgas.
Satz 8: The method according to any of the preceding sentences, wherein the offgas is cooled in step (b)—in a first offgas/NH₃ heat exchanger disposed downstream of the firing system in flow direction of the offgas, and—in a second offgas/NH₃ heat exchanger disposed downstream of the first offgas/NH₃ heat exchanger in flow direction of the offgas.
Satz 9: The method according to any of the preceding sentences, wherein the offgas is cooled in step (b)—in a first offgas/NH₃ heat exchanger disposed downstream of the firing system in flow direction of the offgas,—in a second offgas/NH₃ heat exchanger disposed downstream of the first offgas/NH₃ heat exchanger in flow direction of the offgas, and—in a third offgas/NH₃ heat exchanger disposed downstream of the second offgas/NH₃ heat exchanger in flow direction of the offgas.
Satz 10: The method according to any of the preceding sentences, wherein the offgas is cooled in step (b) to a temperature T₂ in the range from 400 to 450° C., more preferably 400 to 420° C.
Satz 11: The method according to any of the preceding sentences, wherein the N₂O decomposition catalyst and/or the N₂O reduction catalyst and/or the NO_{X} reduction catalyst independently comprise a zeolitic material; preferably a zeolite laden with transition metal (including lanthanide), in particular with iron, cobalt or copper; more preferably an iron-laden zeolite; even more preferably independently an iron-laden zeolite of the MFI, BEA, FER, MOR, FAU and/or MEL structure type.
Satz 12: The method according to any of the preceding sentences, wherein the N₂O decomposition catalyst and the N₂O reduction catalyst are made from the same material.
Satz 13: The method according to any of the preceding sentences, wherein the N₂O decomposition catalyst and the NO_{X} reduction catalyst are made from the same material.
Satz 14: The method according to any of the preceding sentences, wherein the N₂O reduction catalyst and the NO_{X} reduction catalyst are made from the same material.
Satz 15: The method according to any of the preceding sentences, wherein the N₂O decomposition catalyst, the N₂O reduction catalyst and the NO_{X} reduction catalyst are made from the same material.
Satz 16: The method according to any of the preceding sentences, wherein the combustion of NH₃ in step (a) is not over a catalyst.
Satz 17: The method according to any of the preceding sentences, wherein the proportion of H₂ in the mixture with NH₃ is at most 80 mol %, more preferably at most 70 mol %, even more preferably at most 60 mol %, most preferably at most 50 mol %, and in particular at most 40 mol %.
Satz 18: The method according to any of the preceding sentences, wherein the proportion of H₂ in the mixture with NH₃ is at least 10 mol %, more preferably at least 20 mol %, even more preferably at least 30 mol %, most preferably at least 40 mol %, and in particular at least 50 mol %.
Satz 19: The method according to any of the preceding sentences, wherein the molar ratio of H₂:NH₃ in the mixture is in the range from 45:55 to 90:10, preferably 50:50 to 85:15, more preferably 55:45 to 80:20, even more preferably 60:40 to 75:25, most preferably 65:35 to 70:30.
Satz 20: The method according to any of the preceding sentences, wherein the air ratio, is in the range from 0.9 to 1.7, preferably 1.0 to 1.6, even more preferably 1.1 to 1.5, most preferably 1.2 to 1.4.
Satz 21: The method according to any of the preceding sentences, wherein the firing system, preferably the furnace (preferably comprising combustion device and NH₃ decomposition device), is integrated into a system for thermal and/or catalytic decomposition of NH₃ to N₂ and H₂.
Satz 22: The method according to any of the preceding sentences, wherein the offgas has an NO_{X} content greater than the N₂O content; preferably wherein the NO_{X} content is at least twice as high, more preferably at least three times as high, even more preferably at least four times as high, most preferably at least seven times as high and in particular at least ten times as high as the N₂O content.
Satz 23: The method according to any of the preceding sentences, wherein the offgas has an NO content greater than the N₂O content; preferably wherein the NO content is at least twice as high, more preferably at least three times as high, even more preferably at least four times as high, most preferably at least seven times as high and in particular at least ten times as high as the N₂O content.
Satz 24: The method according to any of the preceding sentences, wherein the offgas has an NO₂ content greater than the N₂O content; preferably wherein the NO₂ content is at least twice as high, more preferably at least three times as high, even more preferably at least four times as high, most preferably at least seven times as high and in particular at least ten times as high as the N₂O content.
Satz 25: The method according to any of the preceding sentences, wherein the offgas has an N₂O content greater than the NO_{X} content; preferably wherein the N₂O content is at least twice as high, more preferably at least three times as high, even more preferably at least four times as high, most preferably at least seven times as high and in particular at least ten times as high as the NO_{X} content.
Satz 26: The method according to any of the preceding sentences, wherein the offgas has an N₂O content greater than the NO content; preferably wherein the N₂O content is at least twice as high, more preferably at least three times as high, even more preferably at least four times as high, most preferably at least seven times as high and in particular at least ten times as high as the NO content.
Satz 27: The method according to any of the preceding sentences, wherein the offgas has an N₂O content greater than the NO₂ content; preferably wherein the N₂O content is at least twice as high, more preferably at least three times as high, even more preferably at least four times as high, most preferably at least seven times as high and in particular at least ten times as high as the NO₂ content.
Satz 28: The method according to any of the preceding sentences, wherein the offgas has an NO_{X} content of at least 10 ppmv, preferably at least 20 ppmv, more preferably at least 30 ppmv, even more preferably at least 40 ppmv, and in particular at least 50 ppmv.
Satz 29: The method according to any of the preceding sentences, wherein the offgas has an NO_{X} content of at least 75 ppmv, preferably at least 100 ppmv, more preferably at least 150 ppmv, even more preferably at least 200 ppmv, and in particular at least 250 ppmv.
Satz 30: The method according to any of the preceding sentences, wherein the offgas has an NO_{X} content of at least 500 ppmv, preferably at least 1000 ppmv, more preferably at least 2000 ppmv, even more preferably at least 3000 ppmv, and in particular at least 3500 ppmv.
Satz 31: The method according to any of the preceding sentences, wherein the offgas has an N₂O content of at least 10 ppmv, preferably at least 20 ppmv, more preferably at least 30 ppmv, even more preferably at least 40 ppmv, and in particular at least 50 ppmv.
Satz 32: The method according to any of the preceding sentences, wherein the offgas has an N₂O content of at least 75 ppmv, preferably at least 100 ppmv, more preferably at least 150 ppmv, even more preferably at least 200 ppmv, and in particular at least 250 ppmv.
Satz 33: The method according to any of the preceding sentences, wherein the offgas has an N₂O content of at least 500 ppmv, preferably at least 1000 ppmv, more preferably at least 2000 ppmv, even more preferably at least 3000 ppmv, and in particular at least 3500 ppmv.
Satz 34: The method according to any of the preceding sentences, wherein the offgas has an H₂O content of less than 2.0% by volume.
Satz 35: The method according to any of the preceding sentences, wherein the offgas has an H₂O content of more than 4.0% by volume; preferably at least 5.0% by volume, more preferably at least 6.0% by volume, even more preferably at least 7.0% by volume, most preferably at least 8.0% by volume, and in particular at least 9.0% by volume.
Satz 36: The method according to any of the preceding sentences, wherein the offgas has an H₂O content of at least 10% by volume; preferably at least 12% by volume, more preferably at least 14% by volume, even more preferably at least 16% by volume, most preferably at least 18% by volume, and in particular at least 20% by volume.
Satz 37: The method according to any of the preceding sentences, wherein the offgas has an H₂O content in the region of 10±8% by volume; preferably in the region of 10±7% by volume, more preferably in the region of 10±6% by volume, even more preferably in the region of 10±5% by volume, most preferably in the region of 10±4% by volume, and especially in the region of 10±3% by volume.
Satz 38: The method according to any of the preceding sentences, wherein the offgas has an H₂O content in the region of 15±8% by volume; preferably in the region of 15±7% by volume, more preferably in the region of 15±6% by volume, even more preferably in the region of 15±5% by volume, most preferably in the region of 15±4% by volume, and especially in the region of 15±3% by volume.
Satz 39: The method according to any of the preceding sentences, wherein the offgas has an H₂O content in the region of 20±8% by volume; preferably in the region of 20±7% by volume, more preferably in the region of 20±6% by volume, even more preferably in the region of 20±5% by volume, most preferably in the region of 20±4% by volume, and especially in the region of 20±3% by volume.
Satz 40: The method according to any of the preceding sentences, wherein the offgas has an H₂O content in the region of 25±8% by volume; preferably in the region of 25±7% by volume, more preferably in the region of 25±6% by volume, even more preferably in the region of 25±5% by volume, most preferably in the region of 25±4% by volume, and especially in the region of 25±3% by volume.
Satz 41: The method according to any of the preceding sentences, wherein the offgas has an H₂O content in the region of 30±8% by volume; preferably in the region of 30±7% by volume, more preferably in the region of 30±6% by volume, even more preferably in the region of 30±5% by volume, most preferably in the region of 30±4% by volume, and especially in the region of 30±3% by volume.
Satz 42: The method according to any of the preceding sentences, wherein the offgas has an N₂ content of at most 95% by volume, preferably at most 90% by volume, more preferably at most 85% by volume, even more preferably at most 80% by volume, most preferably at most 75% by volume, and in particular at most 70% by volume.
Satz 43: The method according to any of the preceding sentences, wherein the offgas has an N₂ content of at least 40% by volume, preferably at least 50% by volume, more preferably at least 60% by volume, even more preferably at least 70% by volume, most preferably at least 80% by volume, and in particular at least 90% by volume.
Satz 44: The method according to any of the preceding sentences, wherein the offgas comprises further gaseous constituents; preferably selected from the group consisting of O₂, CO, CO₂, NH₃, CH₄ and mixtures thereof.
Satz 45: The method according to any of the preceding sentences, wherein the offgas on departure from the firing system, preferably the furnace, more preferably the combustion device, is at a temperature of at least 500° C., more preferably at least 600° C., even more preferably at least 700° C., most preferably at least 800° C., and in particular at least 900° C.
Satz 46: The method according to any of the preceding sentences, wherein the offgas on departure from the firing system, preferably the furnace, more preferably the combustion device, is at a temperature of at most 1100° C., more preferably at most 1000° C., even more preferably at most 900° C., most preferably at most 800° C., and in particular at most 700° C.
Satz 47: The method according to any of the preceding sentences, wherein the offgas on departure from the firing system, preferably the furnace, more preferably the combustion device, is at a pressure of at most 1.5 bar; preferably atmospheric pressure.
Satz 48: The method according to any of the preceding sentences, wherein the offgas on departure from the firing system, preferably the furnace, more preferably the combustion device, has a degree of oxidation of NO_{X} of at least 10%, more preferably at least 20%, even more preferably at least 30%, most preferably at least 40%, and in particular at least 50%.
Satz 49: The method according to any of the preceding sentences, wherein the offgas on departure from the firing system, preferably the furnace, more preferably the combustion device, has a degree of oxidation of NO_{X} of at most 90%, more preferably at most 80%, even more preferably at most 70%, most preferably at most 60%, and in particular at most 50%.
Satz 50: The method according to any of the preceding sentences, wherein the offgas on departure from the firing system, preferably the furnace, more preferably the combustion device, has an O₂ content of less than 2.0% by volume.
Satz 51: The method according to any of the preceding sentences, wherein the offgas on departure from the firing system, preferably the furnace, more preferably the combustion device, has an O₂ content of more than 4.0% by volume.
Satz 52: The method according to any of the preceding sentences, wherein the offgas on entry into the offgas treatment system is at a temperature of at least 300° C., more preferably at least 350° C., even more preferably at least 400° C., most preferably at least 425° C., and in particular at least 450° C.
Satz 53: The method according to any of the preceding sentences, wherein the offgas on entry into the offgas treatment system is at a temperature of at least 500° C., more preferably at least 550° C., even more preferably at least 600° C., most preferably at least 625° C., and in particular at least 650° C.
Satz 54: The method according to any of the preceding sentences, wherein the offgas on entry into the offgas treatment system is at a temperature of at most 825° C., more preferably at most 800° C., even more preferably at most 775° C., most preferably at most 750° C., and in particular at most 725° C.
Satz 55: The method according to any of the preceding sentences, wherein the offgas on entry into the offgas treatment system is at a temperature of at most 700° C., more preferably at most 650° C., even more preferably at most 600° C., most preferably at most 550° C., and in particular at most 500° C.
Satz 56: The method according to any of the preceding sentences, wherein the offgas on entry into the offgas treatment system is at a temperature which, in relative terms, is at least 20° C., preferably at least 40° C., more preferably at least 60° C., even more preferably at least 80° C., most preferably at least 100° C., and in particular at least 120° C., below the temperature of the offgas on departure from the firing system, preferably the furnace, more preferably the combustion device.
Satz 57: The method according to any of the preceding sentences, wherein the offgas on entry into the offgas treatment system is at a pressure of at most 1.2 bar; preferably atmospheric pressure.
Satz 58: The method according to any of the preceding sentences, wherein the offgas on entry into the offgas treatment system has a degree of oxidation of NO_{X} of at least 10%, more preferably at least 20%, even more preferably at least 30%, most preferably at least 40%, and in particular at least 50%.
Satz 59: The method according to any of the preceding sentences, wherein the offgas on entry into the offgas treatment system has a degree of oxidation of NO_{X} of at most 90%, more preferably at most 80%, even more preferably at most 70%, most preferably at most 60%, and in particular at most 50%.
Satz 60: The method according to any of the preceding sentences, wherein the offgas on entry into the offgas treatment system has an O₂ content of less than 2.0% by volume.
Satz 61: The method according to any of the preceding sentences, wherein the offgas on entry into the offgas treatment system has an O₂ content of more than 4.0% by volume.
Satz 62: The method according to any of the preceding sentences, wherein step (d) comprises reducing the N₂O content in the offgas by (d₁) decomposition of N₂O over an N₂O decomposition catalyst; preferably wherein the N₂O decomposition catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Satz 63: The method according to any of the preceding sentences, wherein step (d) comprises reducing the N₂O content in the offgas by (d₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Satz 64: The method according to any of the preceding sentences, wherein the reducing agent in step (d₂) is selected from NH₃, hydrocarbons, CO, H₂ and mixtures thereof; preferably NH₃.
Satz 65: The method according to any of the preceding sentences, wherein the reducing agent in step (d₂) is NH₃, which is used in an amount of 0.5 to 2.0 molar parts, preferably 0.8 to 1.8 molar parts, based on a molar proportion of N₂O to be chemically reduced.
Satz 66: The method according to any of the preceding sentences, wherein the reducing agent in step (d₂) is a hydrocarbon or a mixture of several hydrocarbons, which are preferably used in an amount of 0.2 to 1.0 molar part, more preferably of 0.2 to 0.7 molar part, based on a molar proportion of N₂O to be broken down.
Satz 67: The method according to any of the preceding sentences, wherein the NO_{X} reduction catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Satz 68: The method according to any of the preceding sentences, wherein the reducing agent in step (e) is selected from NH₃, hydrocarbons, CO, H₂ and mixtures thereof; preferably NH₃.
Satz 69: The method according to any of the preceding sentences, wherein the reducing agent in step (e) is NH₃, which is used in an amount of 0.9 to 2.5 molar parts, preferably 1.0 to 1.4 molar parts, more preferably 1.0 to 1.2 molar parts, based on a molar proportion of NO_{X} to be chemically reduced.
Satz 70: The method according to any of the preceding sentences, wherein the reducing agent in step (d₂) is the same as the reducing agent in step (e); preferably NH₃.
Satz 71: The method according to any of the preceding sentences, wherein the offgas treatment system comprises a first reaction zone and a second reaction zone beyond, through which the offgas passes successively; wherein reducing agent is added to the offgas upstream of the first reaction zone; wherein, in the first reaction zone, the NO_{X} content in the offgas is first reduced by chemical reduction of NO_{X} with reducing agent over an NO_{X} reduction catalyst (step (e)); wherein the N₂O content in the offgas is optionally additionally reduced by decomposition of N₂O over an N₂O decomposition catalyst (step (d₁)) and/or by chemical reduction of N₂O with reducing agent over an N₂O reduction catalyst (step (d₂)); wherein further reducing agent is optionally added to the offgas upstream of the second reaction zone; and wherein, in the second reaction zone, the N₂O content in the offgas is then reduced by decomposition of N₂O over an N₂O decomposition catalyst (step (d₁)) and/or by chemical reduction of N₂O with reducing agent over an N₂O reduction catalyst (step (d₂)); wherein the NO_{X} content in the offgas is optionally additionally further reduced by chemical reduction of NO_{X} over an NO_{X} reduction catalyst (step (e)).
Satz 72: The method according to sentence 71, wherein the NO_{X} reduction catalyst in the first reaction zone comprises a conventional SCR catalyst, preferably based on V₂O₅—WO₃—/TiO₂.
Satz 73: The method according to sentence 71 or 72, wherein the offgas temperature on entry into the first reaction zone is not more than 400° C., more preferably not more than 350° C.
Satz 74: The method according to any of sentences 71 to 73, wherein the N₂O decomposition catalyst in the second reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Satz 75: The method according to any of sentences 71 to 74, wherein the offgas temperature on entry into the second reaction zone is in the range from 300 to 550° C., preferably 350 to 500° C.
Satz 76: The method according to any of sentences 71 to 75, wherein the NO_{X} reduction catalyst in the first reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Satz 77: The method according to any of sentences 71 to 76, wherein the offgas temperature on entry into the first reaction zone is at least 300° C., more preferably at least 350° C., even more preferably at least 400° C.
Satz 78: The method according to any of sentences 71 to 77, wherein the offgas temperature on entry into the first reaction zone is at most 600° C., preferably at most 550° C.
Satz 79: The method according to any of sentences 71 to 78, wherein the N₂O decomposition catalyst in the second reaction zone comprises an NO_{X}-sensitive N₂O decomposition catalyst.
Satz 80: The method according to any of sentences 71 to 79, wherein the offgas temperature on entry into the second reaction zone is at least 300° C., more preferably at least 350° C., even more preferably at least 400° C.
Satz 81: The method according to any of sentences 71 to 80, wherein the offgas temperature on entry into the second reaction zone is at most 600° C., preferably at most 550° C.
Satz 82: The method according to any of sentences 71 to 81, wherein the offgas after leaving the first reaction zone and before entering the second reaction zone has an NO_{X} content in the range from 0 to 200 ppmv, preferably 1 to 200 ppmv, and an N₂O content in the range from 200 to 2000 ppmv.
Satz 83: The method according to any of sentences 71 to 82, wherein the offgas after leaving the first reaction zone and before entering the second reaction zone has an NO_{X} content of at most 20 ppmv, more preferably at most 10 ppmv, even more preferably at most 5 ppmv, and an N₂O content in the range from 200 to 2000 ppmv.
Satz 84: The method according to any of the preceding sentences, wherein the offgas treatment system likewise comprises a first reaction zone and a second reaction zone beyond, through which the offgas passes successively; wherein reducing agent is added to the offgas between the first reaction zone and the second reaction zone; wherein, in the first reaction zone, the N₂O content in the offgas is first reduced by decomposition of N₂O over an N₂O decomposition catalyst (step (d₁)); and wherein, in the second reaction zone, the NO_{X} content in the offgas is then reduced by chemical reduction of NO_{X} with reducing agent over an NO_{X} reduction catalyst (step (e)); wherein the N₂O content in the offgas is optionally additionally further reduced by further decomposition of N₂O over an N₂O decomposition catalyst (step (d₁)) and/or by chemical reduction of N₂O with reducing agent over an N₂O reduction catalyst (step (d₂)).
Satz 85: The method according to sentence 84, wherein no reducing agent is added to the offgas upstream of the first reaction zone.
Satz 86: The method according to sentence 84 or 85, wherein the N₂O decomposition catalyst in the first reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Satz 87: The method according to any of sentences 84 to 86, wherein the N₂O decomposition catalyst in the first reaction zone comprises an NO_{X}-sensitive N₂O decomposition catalyst.
Satz 88: The method according to any of sentences 84 to 87, wherein the NO_{X} reduction catalyst in the second reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Satz 89: The method according to any of sentences 84 to 88, wherein, in the first reaction zone and in the second reaction zone, the space velocity is set in such a way that the N₂O content in the offgas is reduced in the first reaction zone by at most 95%, preferably at most 90%, based on the N₂O content in the offgas on entry into the first reaction zone.
Satz 90: The method according to any of sentences 84 to 89, wherein, in the second reaction zone, the N₂O content in the offgas is further reduced by at least 30%, preferably at least 40%, more preferably at least 50%, based on the N₂O content in the offgas on entry into the second reaction zone.
Satz 91: The method according to any of sentences 84 to 90, wherein, in the second reaction zone, the N₂O content in the offgas is further reduced by chemical reduction of N₂O with reducing agent over an N₂O reduction catalyst (step (d₂)).
Satz 92: The method according to any of sentences 71 to 91, wherein the first reaction zone and the second reaction zone are spatially separated.
Satz 93: The method according to any of sentences 71 to 92, wherein the first reaction zone and the second reaction zone are spatially connected to each other.
Satz 94: The method according to any of sentences 71 to 93, wherein the first reaction zone and the second reaction zone are disposed in a shared vessel.
Satz 95: The method according to any of sentences 71 to 94, wherein the offgas temperature in the first reaction zone and in the second reaction zone is at most 500° C., preferably in the range from 350 to 450° C.
Satz 96: The method according to any of sentences 71 to 95, wherein the space velocity in the first reaction zone is greater than in the second reaction zone; preferably at least by a factor of 1.2, more preferably at least a factor of 1.4, even more preferably at least a factor of 1.6, most preferably at least a factor of 1.8, and in particular at least a factor of 2.0.
Satz 97: The method according to any of sentences 71 to 96, wherein the space velocity in the first reaction zone is smaller than in the second reaction zone; preferably at least by a factor of 1.5, more preferably at least a factor of 2.0, even more preferably at least a factor of 3.0, most preferably at least a factor of 5.0, and in particular at least a factor of 10.0.
Satz 98: The method according to any of sentences 71 to 97, wherein the temperature in the first reaction zone is at least 450° C., more preferably at least 500° C., even more preferably at least 550° C., most preferably at least 600° C. and in particular at least 650° C.
Satz 99: The method according to any of sentences 71 to 98, wherein the temperature in the second reaction zone is at most 600° C., more preferably at most 550° C., even more preferably at most 500° C., most preferably at most 450° C. and in particular at most 400° C.
Satz 100: The method according to any of sentences 71 to 99, wherein the temperature in the first reaction zone, in relative terms, is at least 20° C., more preferably at least 40° C., even more preferably at least 60° C., most preferably at least 80° C. and in particular at least 100° C. higher than the temperature in the second reaction zone.
Satz 101: The method according to any of sentences 71 to 100, wherein the temperature in the first reaction zone, in relative terms, is at least 120° C., more preferably at least 140° C., even more preferably at least 160° C., most preferably at least 180° C. and in particular at least 200° C. higher than the temperature in the second reaction zone.
Satz 102: The method according to any of the preceding sentences, wherein the offgas leaves the offgas treatment system and has a residual NO_{X} content of at most 20 ppmv, preferably at most 15 ppmv, more preferably at most 10 ppmv, even more preferably at most 7.5 ppmv, most preferably at most 5.0 ppmv, and in particular at most 2.5 ppmv.
Satz 103: The method according to any of the preceding sentences, wherein the offgas leaves the offgas treatment system and has a residual N₂O content of at most 20 ppmv, preferably at most 15 ppmv, more preferably at most 10 ppmv, even more preferably at most 7.5 ppmv, most preferably at most 5.0 ppmv, and in particular at most 2.5 ppmv.
Satz 104: The method according to any of the preceding sentences, wherein the N₂O decomposition catalyst is disposed in a radial basket through which the flow passes axially.
Satz 105: The method according to any of the preceding sentences, wherein the N₂O decomposition catalyst is particulate and comprises at least 50 particles.
Satz 106: The method according to any of the preceding sentences, wherein the N₂O reduction catalyst is disposed in a radial basket through which the flow passes axially.
Satz 107: The method according to any of the preceding sentences, wherein the N₂O reduction catalyst is particulate and comprises at least 50 particles.
Satz 108: The method according to any of the preceding sentences, wherein the NO_{X} reduction catalyst is disposed in a radial basket through which the flow passes axially.
Satz 109: The method according to any of the preceding sentences, wherein the NO_{X} reduction catalyst is particulate and comprises at least 50 particles.
Satz 110: The method according to any of the preceding sentences, wherein at least one parameter characteristic of the current operating state of the firing system is measured in the firing system as a first measured variable.
Satz 111: The method according to sentence 110, wherein the first measured variable is selected from the group consisting of combustion temperature, NH₃ consumption, if appropriate speed of rotation, and the volume of the firing system.
Satz 112: The method according to any of the preceding sentences, wherein at least one parameter characteristic of the current state of the offgas before entry into the offgas treatment system is measured as a second measured variable before entry into the offgas treatment system.
Satz 113: The method according to sentence 112, wherein the second measured variable is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.
Satz 114: The method according to any of the preceding sentences, wherein at least one parameter characteristic of the current state of the offgas on departure from the exhaust gas treatment system is measured as a third measured variable on departure from the exhaust gas treatment system.
Satz 115: The method according to sentence 114, wherein the third measured variable is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.
Satz 116: The method according to any of the preceding sentences, wherein the offgas treatment system comprises a first reaction zone and a second reaction zone, through which the offgas flows successively, wherein reducing agent is fed in between the first reaction zone and the second reaction zone, and wherein, after leaving the first reaction zone and before entering the second reaction zone, at least one parameter characteristic of the current state of the offgas after leaving the first reaction zone and before entering the second reaction zone is measured as a fourth measured variable.
Satz 117: The method according to sentence 116, wherein the fourth measured variable is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.
Satz 118: The method according to any of sentences 110 to 117, wherein the control of the method is based on the first measured variable and/or on the second measured variable and/or on the third measured variable and/or on the fourth measured variable by means of a controlled change in a manipulated variable.
Satz 119: The method according to sentence 118, wherein the manipulated variable is the amount of reducing agent metered in.
Satz 120: The method according to any of the preceding sentences, wherein the offgas is cooled in a single heat exchanger disposed downstream of the offgas treatment system in flow direction of the offgas.
Satz 121: The method according to any of the preceding sentences, wherein the offgas is cooled successively in at least two heat exchangers disposed downstream of the offgas treatment system in flow direction of the offgas.
Satz 122: The method according to any of the preceding sentences, wherein the offgas is cooled successively in at least three heat exchangers disposed downstream of the offgas treatment system in flow direction of the offgas.
Satz 123: The method according to any of the preceding sentences, wherein the offgas is cooled successively in at least four heat exchangers disposed downstream of the offgas treatment system in flow direction of the offgas.
Satz 124: The method according to any of the preceding sentences, wherein the offgas is cooled successively in at least five heat exchangers disposed downstream of the offgas treatment system in flow direction of the offgas.
Satz 125: The method according to any of the preceding sentences, wherein offgas is cooled in step (f) in the at least one heat exchanger by release of heat from the offgas to a heat transfer medium; where the heat transfer medium is preferably selected from the group consisting of water, water vapor, combustion air, NH₃ and combinations thereof.
Satz 126: The method according to any of the preceding sentences, wherein the offgas is cooled in step (f) in a first offgas/H₂O heat exchanger disposed downstream of the offgas treatment system in flow direction of the offgas.
Satz 127: The method according to any of the preceding sentences, wherein the offgas is cooled in step (f) in a first offgas/combustion air heat exchanger disposed downstream of the offgas treatment system in flow direction of the offgas.
Satz 128: The method according to any of the preceding sentences, wherein the offgas is cooled in step (f)—in a first offgas/H₂O heat exchanger disposed downstream of the offgas treatment system in flow direction of the offgas, and—in a first offgas/combustion air heat exchanger likewise disposed downstream of the offgas treatment system in flow direction of the offgas; preferably downstream of the first offgas/H₂O heat exchanger.
Satz 129: The method according to any of the preceding sentences, wherein the offgas is cooled in step (f)—in a first offgas/combustion air heat exchanger disposed downstream of the offgas treatment system in flow direction of the offgas, and—in a second offgas/combustion air heat exchanger disposed downstream of the first offgas/combustion air heat exchanger in flow direction of the offgas.
Satz 130: The method according to any of the preceding sentences, wherein the offgas is cooled in step (f)—in a first offgas/combustion air heat exchanger disposed downstream of the offgas treatment system in flow direction of the offgas,—in a first offgas/H₂O heat exchanger disposed downstream of the first offgas/combustion air heat exchanger in flow direction of the offgas, and—in a second offgas/combustion air heat exchanger disposed downstream of the first offgas/H₂O heat exchanger in flow direction of the offgas.
Satz 131: The method according to any of the preceding sentences, wherein the offgas is cooled in step (f) in at least one offgas/combustion gas heat exchanger disposed downstream of the offgas treatment system in flow direction of the offgas, preferably downstream of the first offgas/combustion air heat exchanger, the first offgas/H₂O heat exchanger, and/or the second offgas/combustion air heat exchanger.
Satz 132: The method according to any of the preceding sentences, wherein the offgas is cooled in step (f) in at least one offgas/combustion gas heat exchanger disposed downstream of the offgas treatment system in flow direction of the offgas, preferably downstream of the first offgas/combustion air heat exchanger, the first offgas/H₂O heat exchanger, and/or the second offgas/combustion air heat exchanger.
Satz 133: The method according to any of the preceding sentences, wherein the offgas is cooled in step (f) in at least one second offgas/H₂O heat exchanger disposed downstream of the offgas treatment system in flow direction of the offgas, preferably downstream of the first offgas/combustion air heat exchanger, the first offgas/H₂O heat exchanger, and/or the second offgas/combustion air heat exchanger.
Satz 134: The method according to any of the preceding sentences, wherein the offgas is cooled in step (f) method—in a first offgas/combustion air heat exchanger disposed downstream of the offgas treatment system in flow direction of the offgas,—in a first offgas/H₂O heat exchanger disposed downstream of the first offgas/combustion air heat exchanger in flow direction of the offgas,—in a second offgas/combustion air heat exchanger disposed downstream of the first offgas/H₂O heat exchanger in flow direction of the offgas, and—in an offgas/combustion gas heat exchanger disposed downstream of the second offgas/combustion air heat exchanger in flow direction of the offgas.
Satz 135: The method according to any of the preceding sentences, wherein the offgas is cooled in step (f)—in a first offgas/combustion air heat exchanger disposed downstream of the offgas treatment system in flow direction of the offgas,—in a first offgas/H₂O heat exchanger disposed downstream of the first offgas/combustion air heat exchanger in flow direction of the offgas,—in a second offgas/combustion air heat exchanger disposed downstream of the first offgas/H₂O heat exchanger in flow direction of the offgas, and—in a second offgas/H₂O heat exchanger disposed downstream of the second offgas/combustion air heat exchanger in flow direction of the offgas.
Satz 136: The method according to any of the preceding sentences, wherein the offgas is cooled in step (f)—in a first offgas/combustion air heat exchanger disposed downstream of the offgas treatment system in flow direction of the offgas,—in a first offgas/H₂O heat exchanger disposed downstream of the first offgas/combustion air heat exchanger in flow direction of the offgas,—in a second offgas/combustion air heat exchanger disposed downstream of the first offgas/H₂O heat exchanger in flow direction of the offgas,—in an offgas/combustion gas heat exchanger disposed downstream of the second offgas/combustion air heat exchanger in flow direction of the offgas, and—in a second offgas/H₂O heat exchanger disposed downstream of the offgas/combustion gas heat exchanger in flow direction of the offgas.
Satz 137: An apparatus comprising (i) an NH₃-operated firing system; preferably a furnace (preferably comprising combustion device and NH₃ decomposition device) for catalytic decomposition of NH₃ to N₂ and H₂; and (ii) an offgas treatment system; wherein the apparatus is configured for performance of the method according to any of the preceding sentences.

Particularly preferred embodiments of the invention will be elucidated hereinafter with reference to the figures. In all of these embodiments, NH₃ is preferably preheated with water vapor and water vapor condensate, as appropriate exclusively or else additionally.

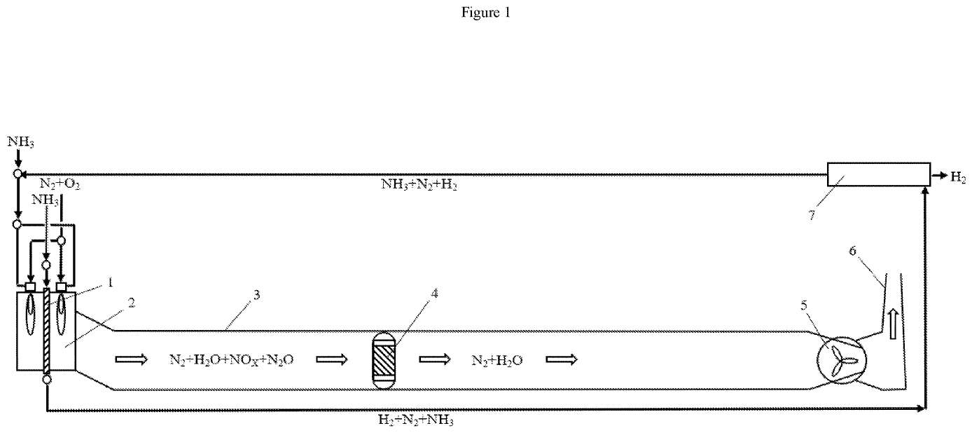

FIG. 1 shows a schematic of a preferred embodiment of the invention. NH₃ is fed into an NH₃ decomposition device (1) of analogous configuration to a primary reformer, and catalytically decomposed therein, over an NH₃ decomposition catalyst, to a product gas comprising H₂+N₂+NH₃. In parallel, a combustion gas comprising NH₃+N₂+H₂ is mixed and combusted in a combustion device (2) with combustion air comprising N₂+O₂. The heat of combustion generated therein fires the NH₃ decomposition device (1). The offgas produced in the combustion, comprising N₂+H₂O+NO_{X}+N₂O, enters an offgas duct (3) and is supplied to an offgas treatment system (4) in which the content of NO_{X} and N₂O is removed virtually completely. The offgas leaving the offgas treatment system, comprising N₂+H₂O, passes through a ventilator (5) and leaves the system through a chimney (6). The product gas formed in the catalytic decomposition, comprising H₂+N₂+NH₃, is separated in a pressure swing adsorption system (7) into H₂ as product and an offgas comprising NH₃+N₂+H₂, which is used as the combustion gas, if necessary after metered addition of additional NH₃.

FIG. 2 shows a schematic of a preferred embodiment of the invention (process variant #1). The offgas duct includes, in flow direction of the offgas, a first offgas/NH₃ heat exchanger (Q1) in which NH₃ absorbs heat from the offgas and is then supplied to the NH₃ decomposition device. The offgas treatment system is disposed downstream of the first offgas/NH₃ heat exchanger (Q1) in flow direction of the offgas. Disposed downstream of the offgas treatment system in flow direction of the offgas is a first offgas/H₂O heat exchanger (Q5) in which water absorbs heat from the offgas. Disposed downstream of the first offgas/H₂O heat exchanger (Q5) in flow direction of the offgas is a second offgas/combustion air heat exchanger (Q6) in which combustion air absorbs heat from the offgas and is then supplied to the combustion device.

FIG. 3 shows a schematic of a preferred embodiment of the invention (process variant #2). The offgas duct includes, in flow direction of the offgas, a first offgas/NH₃ heat exchanger (Q1) in which NH₃ absorbs heat from the offgas and is then fed to a first preliminary reactor (NH₃ decomposition device) for partial catalytic decomposition of NH₃. This preferably cools down the intermediate product gas, for example from 650° C. at the inlet of the first preliminary reactor to 360° C. on departure from the first preliminary reactor. Disposed downstream of the first offgas/NH₃ heat exchanger (Q1) in flow d₁-rection of the offgas is a second offgas/NH₃ heat exchanger (Q2) in which intermediate product gas absorbs heat from the offgas and is then fed to the NH₃ decomposition device for catalytic decomposition of NH₃. The offgas treatment system is disposed downstream of the second offgas/NH₃ heat exchanger (Q2) in flow direction of the offgas. In a first offgas/H₂O heat exchanger (Q5) disposed downstream of the offgas treatment system in flow direction of the offgas, water absorbs heat from the offgas. Disposed downstream of the first offgas/H₂O heat exchanger (Q5) in flow direction of the offgas is a second offgas/combustion air heat exchanger (Q6) in which combustion air absorbs heat from the offgas and is then supplied to the combustion device.

FIG. 4 shows a schematic of a preferred embodiment of the invention (process variant #3). The offgas duct includes, in flow direction of the offgas, a first offgas/NH₃ heat exchanger (Q1) in which NH₃ absorbs heat from the offgas and is then fed to a first preliminary reactor (NH₃ decomposition device) for partial catalytic decomposition of NH₃. This preferably cools down the first intermediate product gas, for example from 650° C. at the inlet of the first preliminary reactor to 480° C. on departure from the first preliminary reactor. Disposed downstream of the first offgas/NH₃ heat exchanger (Q1) in flow direction of the offgas is a second offgas/NH₃ heat exchanger (Q2) in which intermediate product gas absorbs heat from the offgas and is then supplied to a second preliminary reactor (NH₃ decomposition device) for partial catalytic decomposition of NH₃. This preferably cools down the second intermediate product gas, for example from 630° C. at the inlet of the second preliminary reactor to 510° C. on departure from the second preliminary reactor. Disposed downstream of the second offgas/NH₃ heat exchanger (Q2) in flow direction of the offgas is a third offgas/NH₃ heat exchanger (Q3) in which intermediate product gas absorbs heat from the offgas and is then supplied to the NH₃ decomposition device for catalytic decomposition of NH₃. The offgas treatment system is disposed downstream of the third offgas/NH₃ heat exchanger (Q3) in flow direction of the offgas. In a first offgas/H₂O heat exchanger (Q5) disposed downstream of the offgas treatment system in flow direction of the offgas, water absorbs heat from the offgas. Disposed downstream of the first offgas/H₂O heat exchanger (Q5) in flow direction of the offgas is a second offgas/combustion air heat exchanger (Q6) in which combustion air absorbs heat from the offgas and is then supplied to the combustion device.

FIG. 5 shows a schematic of a preferred embodiment of the invention (process variant #4). The offgas duct includes, in flow direction of the offgas, a first offgas/NH₃ heat exchanger (Q1) in which NH₃ absorbs heat from the offgas and is then fed to a first preliminary reactor (NH₃ decomposition device) for partial catalytic decomposition of NH₃. This preferably cools down the intermediate product gas, for example from 650° C. at the inlet of the first preliminary reactor to 360° C. on departure from the first preliminary reactor. Disposed downstream of the first offgas/NH₃ heat exchanger (Q1) in flow d₁-rection of the offgas is a second offgas/NH₃ heat exchanger (Q2) in which intermediate product gas absorbs heat from the offgas and is then fed to the NH₃ decomposition device for catalytic decomposition of NH₃. The offgas treatment system is disposed downstream of the second offgas/NH₃ heat exchanger (Q2) in flow direction of the offgas. Disposed downstream of the offgas treatment system in flow direction of the offgas is a first offgas/combustion air heat exchanger (Q4) in which combustion air absorbs heat from the offgas. Disposed downstream of the first offgas/combustion air heat exchanger (Q4) in flow direction of the offgas is a first offgas/H₂O heat exchanger (Q5) in which water absorbs heat from the offgas. Disposed downstream of the first offgas/H₂O heat exchanger (Q5) in flow direction of the offgas is a second offgas/combustion air heat exchanger (Q6) in which combustion air absorbs heat from the offgas, then is supplied to the first offgas/combustion air heat exchanger (Q4) and then to the combustion device. The combustion air is thus heated in two stages, first in the second offgas/combustion air heat exchanger (Q6) and then in the first offgas/combustion air heat exchanger (Q4).

FIG. 6 shows a schematic of three preferred embodiments of the invention that are similar to one another (process variants #5, #6 and #7). In all three process variants, the offgas duct includes, in flow direction of the offgas, a first offgas/NH₃ heat exchanger (Q1) in which NH₃ absorbs heat from the offgas and is then supplied to a first preliminary reactor (NH₃ decomposition device) for partial catalytic decomposition of NH₃. This preferably cools down the intermediate product gas, for example from 650° C. at the inlet of the first preliminary reactor to 360° C. on departure from the first preliminary reactor. Disposed downstream of the first offgas/NH₃ heat exchanger (Q1) in flow direction of the offgas is a second offgas/NH₃ heat exchanger (Q2) in which intermediate product gas absorbs heat from the offgas and is then fed to the NH₃ decomposition device for catalytic decomposition of NH₃. The offgas treatment system is disposed downstream of the second offgas/NH₃ heat exchanger (Q2) in flow direction of the offgas. Disposed downstream of the offgas treatment system in flow direction of the offgas is a first offgas/combustion air heat exchanger (Q4) in which combustion air absorbs heat from the offgas. Disposed downstream of the first offgas/combustion air heat exchanger (Q4) in flow direction of the offgas is a first offgas/H₂O heat exchanger (Q5) in which water absorbs heat from the offgas. Disposed downstream of the first offgas/H₂O heat exchanger (Q5) in flow direction of the offgas is a second offgas/combustion air heat exchanger (Q6) in which combustion air absorbs heat from the offgas, then is supplied to the first offgas/combustion air heat exchanger (Q4) and then to the combustion device. The combustion air is thus heated in two stages, first in the second offgas/combustion air heat exchanger (Q6) and then in the first offgas/combustion air heat exchanger (Q4). Disposed downstream of the second offgas/combustion air heat exchanger (Q6) in flow direction of the offgas is an offgas/combustion gas heat exchanger (Q7) in which combustion gas, namely the offgas from the pressure swing adsorption apparatus, absorbs heat from the offgas and then is supplied to the combustion device. In a second offgas/H₂O heat exchanger (Q8) disposed downstream of one offgas/combustion gas heat exchanger (Q7) in flow direction of the offgas, water absorbs heat from the offgas.

In process variant #5, the residual heat remaining in the offgas is removed with water in the second offgas/H₂O heat exchanger (Q8) and released to NH₃, which is thus prewarmed from the liquid state (storage temperature −33.5° C.) to −8° C., for example.

In process variant #6, heat is removed with water in the first offgas/H₂O heat exchanger (Q5) and released to NH₃, which is thus prewarmed from the liquid state to 30° C., for example. The residual heat remaining in the offgas is removed with water in the second offgas/H₂O heat exchanger (Q8) and likewise released to NH₃, which is thus heated to 45° C., for example.

In process variant #7, heat is removed with water in the first offgas/H₂O heat exchanger (Q5) and released to NH₃, which is thus prewarmed from the liquid state to 30° C., for example. The residual heat remaining in the offgas is removed with water in the second offgas/H₂O heat exchanger (Q8) and likewise released to NH₃, which is thus heated to 39° C., for example. The amount of preheated boiler feed water is increased compared to the amount required for production of water vapor. The excess boiler feed water is fed into a stream of water vapor condensate beneath an NH₃ evaporator and serves as an additional heat transfer medium.

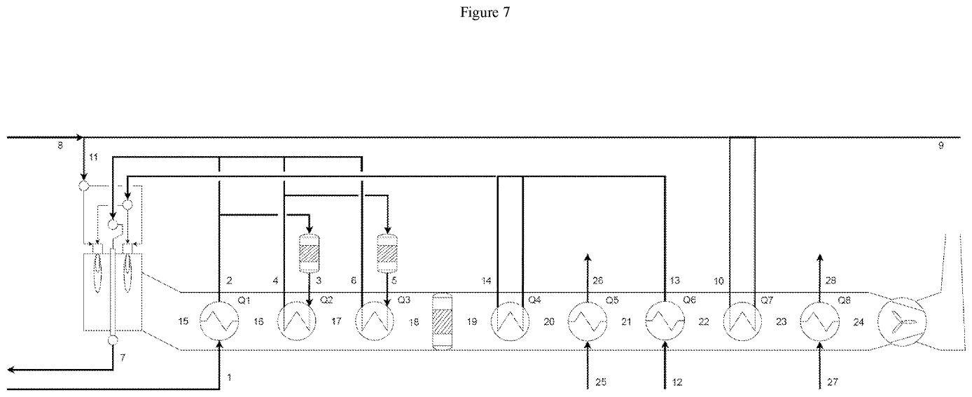

Mass balances and temperature profiles for process variants #1 to #7 are compiled in the tables below. All data is scaled for a plant capacity of 1000 mtpd NH₃. The numbers 1 to 28 in bold type refer to the correspondingly labelled positions in FIG. 7. A distinction is made in each case between two cases A and B in which the offgas contains a different content of nitrogen oxides. In case A, the offgas in each case contains a comparatively low content of nitrogen oxides of 500 ppmv NO, 10 ppmv NO₂ and 10 ppmv N₂O. In case B, the offgas in each case contains a comparatively high content of nitrogen oxides of 5000 ppmv NO, 10 ppmv NO₂ and 50 ppmv N₂O.

Process variant #1:

| Process variant 1A | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | |
| Ar | mol % | 0.00 | 0.00 | 0.00 | 0.00 | | | 0.00 | 0.00 | 0.00 | |
| H₂ | mol % | 0.00 | 0.00 | 0.00 | 0.00 | | | 74.29 | 0.00 | 28.81 | |
| N₂ | mol % | 0.00 | 0.00 | 0.00 | 0.00 | | | 24.76 | 0.00 | 68.55 | |
| NH₃ | mol % | 99.81 | 99.81 | 99.81 | 99.81 | | | 0.86 | 99.81 | 2.37 | |
| O₂ | mol % | 0.00 | 0.00 | 0.00 | 0.00 | | | 0.00 | 0.00 | 0.00 | |
| H₂O | mol % | 0.19 | 0.19 | 0.19 | 0.19 | | | 0.10 | 0.19 | 0.26 | |
| NO | ppmv | 0 | 0 | 0 | 0 | | | 0 | 0 | 0 | |
| NO₂ | ppmv | 0 | 0 | 0 | 0 | | | 0 | 0 | 0 | |
| N₂O | ppmv | 0 | 0 | 0 | 0 | | | 0 | 0 | 0 | |
| Mass flow rate | kg/h | 36856 | 36856 | 36856 | 36856 | | | 36856 | 4776 | 31312 | |
| Molar flow rate | kmol/h | 2164 | 2164 | 2164 | 2164 | | | 4287 | 280 | 1547 | |
| Temperature | ° C. | 272.0 | 580.0 | 579.9 | 580.0 | | | 680.0 | 22.8 | 27.0 | |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | | 0.02 | 0.02 | 0.00 | 0.00 | | |
| Ar | mol % | 0.00 | 0.90 | 0.90 | | 0.53 | 0.53 | 0.00 | 0.00 | | |
| H₂ | mol % | 24.39 | 0.00 | 0.00 | | 0.00 | 0.00 | 0.00 | 0.00 | | |
| N₂ | mol % | 58.03 | 75.30 | 75.30 | | 74.10 | 74.10 | 0.00 | 0.00 | | |
| NH₃ | mol % | 17.32 | 0.00 | 0.00 | | 0.00 | 0.00 | 0.00 | 0.00 | | |
| O₂ | mol % | 0.00 | 20.21 | 20.21 | | 1.00 | 0.99 | 0.00 | 0.00 | | |
| H₂O | mol % | 0.25 | 3.56 | 3.56 | | 24.30 | 24.36 | 100.00 | 100.00 | | |
| NO | ppmv | 0 | 0 | 0 | | 476 | 0 | 0 | 0 | | |
| NO₂ | ppmv | 0 | 0 | 0 | | 5 | 0 | 0 | 0 | | |
| N₂O | ppmv | 0 | 0 | 0 | | 10 | 0 | 0 | 0 | | |
| Mass flow rate | kg/h | 36088 | 71121 | 71121 | | 107209 | 107243 | 27237 | 27237 | | |
| Molar flow rate | kmol/h | 1828 | 2489 | 2489 | | 4173 | 4175 | 1512 | 1512 | | |
| Temperature | ° C. | 26.1 | 44.3 | 500.0 | | 870.0 | 310.2 | 130.5 | 230.0 | | |

| Process variant 1B | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | |
| Ar | mol % | 0.00 | 0.00 | 0.00 | 0.00 | | | 0.00 | 0.00 | 0.00 | |
| H₂ | mol % | 0.00 | 0.00 | 0.00 | 0.00 | | | 74.29 | 0.00 | 28.81 | |
| N₂ | mol % | 0.00 | 0.00 | 0.00 | 0.00 | | | 24.76 | 0.00 | 68.55 | |
| NH₃ | mol % | 99.81 | 99.81 | 99.81 | 99.81 | | | 0.86 | 99.81 | 2.37 | |
| O₂ | mol % | 0.00 | 0.00 | 0.00 | 0.00 | | | 0.00 | 0.00 | 0.00 | |
| H₂O | mol % | 0.19 | 0.19 | 0.19 | 0.19 | | | 0.10 | 0.19 | 0.26 | |
| NO | ppmv | 0 | 0 | 0 | 0 | | | 0 | 0 | 0 | |
| NO₂ | ppmv | 0 | 0 | 0 | 0 | | | 0 | 0 | 0 | |
| N₂O | ppmv | 0 | 0 | 0 | 0 | | | 0 | 0 | 0 | |
| Mass flow rate | kg/h | 36414 | 36414 | 36414 | 36414 | | | 36414 | 4895 | 30936 | |
| Molar flow rate | kmol/h | 2138 | 2138 | 2138 | 2138 | | | 4236 | 287 | 1529 | |
| Temperature | ° C. | 267.4 | 580.0 | 579.9 | 580.0 | | | 680.0 | 22.8 | 27.0 | |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | | 0.02 | 0.02 | 0.00 | 0.00 | | |
| Ar | mol % | 0.00 | 0.90 | 0.90 | | 0.54 | 0.54 | 0.00 | 0.00 | | |
| H₂ | mol % | 24.25 | 0.00 | 0.00 | | 0.00 | 0.00 | 0.00 | 0.00 | | |
| N₂ | mol % | 57.70 | 75.30 | 75.30 | | 73.80 | 73.84 | 0.00 | 0.00 | | |
| NH₃ | mol % | 17.79 | 0.00 | 0.00 | | 0.00 | 0.00 | 0.00 | 0.00 | | |
| O₂ | mol % | 0.00 | 20.21 | 20.21 | | 1.00 | 0.87 | 0.00 | 0.00 | | |
| H₂O | mol % | 0.25 | 3.56 | 3.56 | | 24.15 | 24.74 | 100.00 | 100.00 | | |
| NO | ppmv | 0 | 0 | 0 | | 4951 | 1 | 0 | 0 | | |
| NO₂ | ppmv | 0 | 0 | 0 | | 5 | 0 | 0 | 0 | | |
| N₂O | ppmv | 0 | 0 | 0 | | 10 | 0 | 0 | 0 | | |
| Mass flow rate | kg/h | 35831 | 72851 | 72851 | | 108682 | 109039 | 27237 | 27237 | | |
| Molar flow rate | kmol/h | 1816 | 2549 | 2549 | | 4226 | 4252 | 1512 | 1512 | | |
| Temperature | ° C. | 26.0 | 44.3 | 500.0 | | 870.2 | 366.4 | 130.5 | 230.0 | | |

Process variant #2:

| Process variant 2A | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | |
| Ar | mol % | 0.00 | 0.00 | 0.00 | 0.00 | | | 0.00 | 0.00 | 0.00 | |
| H₂ | mol % | 0.00 | 0.00 | 33.06 | 33.06 | | | 74.29 | 0.00 | 28.81 | |
| N₂ | mol % | 0.00 | 0.00 | 11.02 | 11.02 | | | 24.76 | 0.00 | 68.55 | |
| NH₃ | mol % | 99.81 | 99.81 | 55.77 | 55.77 | | | 0.86 | 99.81 | 2.37 | |
| O₂ | mol % | 0.00 | 0.00 | 0.00 | 0.00 | | | 0.00 | 0.00 | 0.00 | |
| H₂O | mol % | 0.19 | 0.19 | 0.15 | 0.15 | | | 0.10 | 0.19 | 0.26 | |
| NO | ppmv | 0 | 0 | 0 | 0 | | | 0 | 0 | 0 | |
| NO₂ | ppmv | 0 | 0 | 0 | 0 | | | 0 | 0 | 0 | |
| N₂O | ppmv | 0 | 0 | 0 | 0 | | | 0 | 0 | 0 | |
| Mass flow rate | kg/h | 37669 | 37669 | 37669 | 37669 | | | 37669 | 3963 | 32003 | |
| Molar flow rate | kmol/h | 2212 | 2212 | 2837 | 2837 | | | 4382 | 233 | 1582 | |
| Temperature | ° C. | 280.2 | 650.0 | 360.0 | 580.0 | 0.0 | 27.0 | 680.0 | 22.8 | 27.0 | |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | | 0.02 | 0.02 | 0.00 | 0.00 | | |
| Ar | mol % | 0.00 | 0.90 | 0.90 | | 0.52 | 0.52 | 0.00 | 0.00 | | |
| H₂ | mol % | 25.12 | 0.00 | 0.00 | | 0.00 | 0.00 | 0.00 | 0.00 | | |
| N₂ | mol % | 59.76 | 75.30 | 75.30 | | 74.61 | 74.62 | 0.00 | 0.00 | | |
| NH₃ | mol % | 14.87 | 0.00 | 0.00 | | 0.00 | 0.00 | 0.00 | 0.00 | | |
| O₂ | mol % | 0.00 | 20.21 | 20.21 | | 1.00 | 0.99 | 0.00 | 0.00 | | |
| H₂O | mol % | 0.25 | 3.56 | 3.56 | | 23.79 | 23.85 | 100.00 | 100.00 | | |
| NO | ppmv | 0 | 0 | 0 | | 499 | 0 | 0 | 0 | | |
| NO₂ | ppmv | 0 | 0 | 0 | | 5 | 0 | 0 | 0 | | |
| N₂O | ppmv | 0 | 0 | 0 | | 10 | 0 | 0 | 0 | | |
| Mass flow rate | kg/h | 35966 | 66586 | 66586 | | 102552 | 102586 | 27237 | 27237 | | |
| Molar flow rate | kmol/h | 1814 | 2330 | 2330 | | 3984 | 3987 | 1512 | 1512 | | |
| Temperature | ° C. | 26.2 | 44.3 | 296.7 | | 919.7 | 200.9 | 130.5 | 230.0 | | |

| Process variant 2B | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | |
| Ar | mol % | 0.00 | 0.00 | 0.00 | 0.00 | | | 0.00 | 0.00 | 0.00 | |
| H₂ | mol % | 0.00 | 0.00 | 33.06 | 33.06 | | | 74.29 | 0.00 | 28.81 | |
| N₂ | mol % | 0.00 | 0.00 | 11.02 | 11.02 | | | 24.76 | 0.00 | 68.55 | |
| NH₃ | mol % | 99.81 | 99.81 | 55.77 | 55.77 | | | 0.86 | 99.81 | 2.37 | |
| O₂ | mol % | 0.00 | 0.00 | 0.00 | 0.00 | | | 0.00 | 0.00 | 0.00 | |
| H₂O | mol % | 0.19 | 0.19 | 0.15 | 0.15 | | | 0.10 | 0.19 | 0.26 | |
| NO | ppmv | 0 | 0 | 0 | 0 | | | 0 | 0 | 0 | |
| NO₂ | ppmv | 0 | 0 | 0 | 0 | | | 0 | 0 | 0 | |
| N₂O | ppmv | 0 | 0 | 0 | 0 | | | 0 | 0 | 0 | |
| Mass flow rate | kg/h | 37500 | 37500 | 37500 | 37500 | | | 37500 | 3826 | 31859 | |
| Molar flow rate | kmol/h | 2202 | 2202 | 2824 | 2824 | | | 4362 | 225 | 1574 | |
| Temperature | ° C. | 278.5 | 650.0 | 360.0 | 580.0 | | | 680.0 | 22.8 | 27.0 | |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | | 0.02 | 0.02 | 0.00 | 0.00 | | |
| Ar | mol % | 0.00 | 0.90 | 0.90 | | 0.53 | 0.52 | 0.00 | 0.00 | | |
| H₂ | mol % | 25.22 | 0.00 | 0.00 | | 0.00 | 0.00 | 0.00 | 0.00 | | |
| N₂ | mol % | 59.99 | 75.30 | 75.30 | | 74.47 | 74.50 | 0.00 | 0.00 | | |
| NH₃ | mol % | 14.54 | 0.00 | 0.00 | | 0.00 | 0.00 | 0.00 | 0.00 | | |
| O₂ | mol % | 0.00 | 20.21 | 20.21 | | 1.00 | 0.87 | 0.00 | 0.00 | | |
| H₂O | mol % | 0.26 | 3.56 | 3.56 | | 23.48 | 24.09 | 100.00 | 100.00 | | |
| NO | ppmv | 0 | 0 | 0 | | 5019 | 1 | 0 | 0 | | |
| NO₂ | ppmv | 0 | 0 | 0 | | 5 | 0 | 0 | 0 | | |
| N₂O | ppmv | 0 | 0 | 0 | | 10 | 0 | 0 | 0 | | |
| Mass flow rate | kg/h | 35685 | 66830 | 66830 | | 102515 | 102856 | 27237 | 27237 | | |
| Molar flow rate | kmol/h | 1799 | 2339 | 2339 | | 3976 | 4001 | 1512 | 1512 | | |
| Temperature | ° C. | 26.2 | 44.3 | 351.5 | | 919.6 | 225.8 | 130.5 | 230.0 | | |

Process variant #3:

| Process variant 3A | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | 0.00 | 0.00 | 0.00 | 0.00 | 0.00 | |
| Ar | mol % | 0.00 | 0.00 | 0.00 | 0.00 | 0.00 | 0.00 | 0.00 | 0.00 | 0.00 | |
| H₂ | mol % | 0.00 | 0.00 | 21.45 | 21.45 | 33.48 | 33.48 | 74.28 | 0.00 | 28.81 | |
| N₂ | mol % | 0.00 | 0.00 | 7.15 | 7.15 | 11.16 | 11.16 | 24.76 | 0.00 | 68.54 | |
| NH₃ | mol % | 99.81 | 99.81 | 71.23 | 71.23 | 55.21 | 55.21 | 0.86 | 99.81 | 2.39 | |
| O₂ | mol % | 0.00 | 0.00 | 0.00 | 0.00 | 0.00 | 0.00 | 0.00 | 0.00 | 0.00 | |
| H₂O | mol % | 0.19 | 0.19 | 0.16 | 0.16 | 0.15 | 0.15 | 0.10 | 0.19 | 0.26 | |
| NO | ppmv | 0 | 0 | 0 | 0 | 0 | 0 | 0 | 0 | 0 | |
| NO₂ | ppmv | 0 | 0 | 0 | 0 | 0 | 0 | 0 | 0 | 0 | |
| N₂O | ppmv | 0 | 0 | 0 | 0 | 0 | 0 | 0 | 0 | 0 | |
| Mass flow rate | kg/h | 37228 | 37228 | 37228 | 37228 | 37228 | 37228 | 37228 | 4403 | 31630 | |
| Molar flow rate | kmol/h | 2186 | 2186 | 2551 | 2551 | 2814 | 2814 | 4330 | 259 | 1563 | |
| Temperature | ° C. | 276.3 | 650.0 | 480.0 | 630.0 | 510.0 | 580.0 | 680.0 | 22.8 | 27.0 | |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | | 0.02 | 0.02 | 0.00 | 0.00 | | |
| Ar | mol % | 0.00 | 0.90 | 0.90 | | 0.53 | 0.53 | 0.00 | 0.00 | | |
| H₂ | mol % | 24.72 | 0.00 | 0.00 | | 0.00 | 0.00 | 0.00 | 0.00 | | |
| N₂ | mol % | 58.81 | 75.30 | 75.30 | | 74.33 | 74.33 | 0.00 | 0.00 | | |
| NH₃ | mol % | 16.21 | 0.00 | 0.00 | | 0.00 | 0.00 | 0.00 | 0.00 | | |
| O₂ | mol % | 0.00 | 20.21 | 20.21 | | 1.00 | 0.99 | 0.00 | 0.00 | | |
| H₂O | mol % | 0.25 | 3.56 | 3.56 | | 24.07 | 24.13 | 100.00 | 100.00 | | |
| NO | ppmv | 0 | 0 | 0 | | 499 | 0 | 0 | 0 | | |
| NO₂ | ppmv | 0 | 0 | 0 | | 5 | 0 | 0 | 0 | | |
| N₂O | ppmv | 0 | 0 | 0 | | 10 | 0 | 0 | 0 | | |
| Mass flow rate | kg/h | 36033 | 69063 | 69063 | | 105096 | 105131 | 27237 | 27237 | | |
| Molar flow rate | kmol/h | 1822 | 2417 | 2417 | | 4087 | 4090 | 1512 | 1512 | | |
| Temperature | ° C. | 26.1 | 44.3 | 436.0 | | 1030.1 | 262.1 | 130.5 | 230.0 | | |

| Process variant 3B | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | 0.00 | 0.00 | 0.00 | 0.00 | 0.00 | |
| Ar | mol % | 0.00 | 0.00 | 0.00 | 0.00 | 0.00 | 0.00 | 0.00 | 0.00 | 0.00 | |
| H₂ | mol % | 0.00 | 0.00 | 21.45 | 21.45 | 33.48 | 33.48 | 74.28 | 0.00 | 28.81 | |
| N₂ | mol % | 0.00 | 0.00 | 7.15 | 7.15 | 11.16 | 11.16 | 24.76 | 0.00 | 68.54 | |
| NH₃ | mol % | 99.81 | 99.81 | 71.23 | 71.23 | 55.21 | 55.21 | 0.86 | 99.81 | 2.39 | |
| O₂ | mol % | 0.00 | 0.00 | 0.00 | 0.00 | 0.00 | 0.00 | 0.00 | 0.00 | 0.00 | |
| H₂O | mol % | 0.19 | 0.19 | 0.16 | 0.16 | 0.15 | 0.15 | 0.10 | 0.19 | 0.26 | |
| NO | ppmv | 0 | 0 | 0 | 0 | 0 | 0 | 0 | 0 | 0 | |
| NO₂ | ppmv | 0 | 0 | 0 | 0 | 0 | 0 | 0 | 0 | 0 | |
| N₂O | ppmv | 0 | 0 | 0 | 0 | 0 | 0 | 0 | 0 | 0 | |
| Mass flow rate | kg/h | 37058 | 37058 | 37058 | 37058 | 37058 | 37058 | 37058 | 4260 | 31484 | |
| Molar flow rate | kmol/h | 2176 | 2176 | 2539 | 2539 | 2801 | 2801 | 4310 | 250 | 1556 | |
| Temperature | ° C. | 274.6 | 650.0 | 480.0 | 630.0 | 510.0 | 580.0 | 680.0 | 22.8 | 27.0 | |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | | 0.02 | 0.02 | 0.00 | 0.00 | | |
| Ar | mol % | 0.00 | 0.90 | 0.90 | | 0.53 | 0.53 | 0.00 | 0.00 | | |
| H₂ | mol % | 24.82 | 0.00 | 0.00 | | 0.00 | 0.00 | 0.00 | 0.00 | | |
| N₂ | mol % | 59.05 | 75.30 | 75.30 | | 74.18 | 74.22 | 0.00 | 0.00 | | |
| NH₃ | mol % | 15.88 | 0.00 | 0.00 | | 0.00 | 0.00 | 0.00 | 0.00 | | |
| O₂ | mol % | 0.00 | 20.21 | 20.21 | | 1.00 | 0.87 | 0.00 | 0.00 | | |
| H₂O | mol % | 0.25 | 3.56 | 3.56 | | 23.76 | 24.36 | 100.00 | 100.00 | | |
| NO | ppmv | 0 | 0 | 0 | | 5013 | 1 | 0 | 0 | | |
| NO₂ | ppmv | 0 | 0 | 0 | | 5 | 0 | 0 | 0 | | |
| N₂O | ppmv | 0 | 0 | 0 | | 10 | 0 | 0 | 0 | | |
| Mass flow rate | kg/h | 35744 | 69301 | 69301 | | 105045 | 105395 | 27237 | 27237 | | |
| Molar flow rate | kmol/h | 1806 | 2425 | 2425 | | 4079 | 4104 | 1512 | 1512 | | |
| Temperature | ° C. | 26.2 | 44.3 | 487.9 | | 1030.1 | 286.1 | 130.5 | 230.0 | | |

Process variant #4:

| Process variant 4A | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | |
| Ar | mol % | 0.00 | 0.00 | 0.00 | 0.00 | | | 0.00 | 0.00 | 0.00 | |
| H₂ | mol % | 0.00 | 0.00 | 33.06 | 33.06 | | | 74.29 | 0.00 | 28.81 | |
| N₂ | mol % | 0.00 | 0.00 | 11.02 | 11.02 | | | 24.76 | 0.00 | 68.55 | |
| NH₃ | mol % | 99.81 | 99.81 | 55.77 | 55.77 | | | 0.86 | 99.81 | 2.37 | |
| O₂ | mol % | 0.00 | 0.00 | 0.00 | 0.00 | | | 0.00 | 0.00 | 0.00 | |
| H₂O | mol % | 0.19 | 0.19 | 0.15 | 0.15 | | | 0.10 | 0.19 | 0.26 | |
| NO | ppmv | 0 | 0 | 0 | 0 | | | 0 | 0 | 0 | |
| NO₂ | ppmv | 0 | 0 | 0 | 0 | | | 0 | 0 | 0 | |
| N₂O | ppmv | 0 | 0 | 0 | 0 | | | 0 | 0 | 0 | |
| Mass flow rate | kg/h | 38059 | 38059 | 38059 | 38059 | | | 38059 | 3573 | 32334 | |
| Molar flow rate | kmol/h | 2235 | 2235 | 2866 | 2866 | | | 4427 | 210 | 1598 | |
| Temperature | ° C. | 284.0 | 650.0 | 360.0 | 580.0 | | | 680.0 | 22.8 | 27.0 | |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | 0.03 | 0.02 | 0.02 | 0.00 | 0.00 | | |
| Ar | mol % | 0.00 | 0.90 | 0.90 | 0.90 | 0.52 | 0.52 | 0.00 | 0.00 | | |
| H₂ | mol % | 25.47 | 0.00 | 0.00 | 0.00 | 0.00 | 0.00 | 0.00 | 0.00 | | |
| N₂ | mol % | 60.59 | 75.30 | 75.30 | 75.30 | 74.88 | 74.88 | 0.00 | 0.00 | | |
| NH₃ | mol % | 13.68 | 0.00 | 0.00 | 0.00 | 0.00 | 0.00 | 0.00 | 0.00 | | |
| O₂ | mol % | 0.00 | 20.21 | 20.21 | 20.21 | 1.00 | 0.99 | 0.00 | 0.00 | | |
| H₂O | mol % | 0.26 | 3.56 | 3.56 | 3.56 | 23.53 | 23.60 | 100.00 | 100.00 | | |
| NO | ppmv | 0 | 0 | 0 | 0 | 511 | 0 | 0 | 0 | | |
| NO₂ | ppmv | 0 | 0 | 0 | 0 | 5 | 0 | 0 | 0 | | |
| N₂O | ppmv | 0 | 0 | 0 | 0 | 10 | 0 | 0 | 0 | | |
| Mass flow rate | kg/h | 35908 | 64408 | 64408 | 64408 | 100316 | 100351 | 27237 | 27237 | | |
| Molar flow rate | kmol/h | 1808 | 2254 | 2254 | 2254 | 3893 | 3896 | 1512 | 1512 | | |
| Temperature | ° C. | 26.3 | 44.3 | 167.2 | 386.6 | 929.4 | 143.8 | 130.5 | 230.0 | | |

| Process variant 4B | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | |
| Ar | mol % | 0.00 | 0.00 | 0.00 | 0.00 | | | 0.00 | 0.00 | 0.00 | |
| H₂ | mol % | 0.00 | 0.00 | 33.06 | 33.06 | | | 74.29 | 0.00 | 28.81 | |
| N₂ | mol % | 0.00 | 0.00 | 11.02 | 11.02 | | | 24.76 | 0.00 | 68.55 | |
| NH₃ | mol % | 99.81 | 99.81 | 55.77 | 55.77 | | | 0.86 | 99.81 | 2.37 | |
| O₂ | mol % | 0.00 | 0.00 | 0.00 | 0.00 | | | 0.00 | 0.00 | 0.00 | |
| H₂O | mol % | 0.19 | 0.19 | 0.15 | 0.15 | | | 0.10 | 0.19 | 0.26 | |
| NO | ppmv | 0 | 0 | 0 | 0 | | | 0 | 0 | 0 | |
| NO₂ | ppmv | 0 | 0 | 0 | 0 | | | 0 | 0 | 0 | |
| N₂O | ppmv | 0 | 0 | 0 | 0 | | | 0 | 0 | 0 | |
| Mass flow rate | kg/h | 37891 | 37891 | 37891 | 37891 | | | 37891 | 3442 | 32192 | |
| Molar flow rate | kmol/h | 2225 | 2225 | 2854 | 2854 | | | 4407 | 202 | 1591 | |
| Temperature | ° C. | 282.4 | 650.0 | 360.0 | 580.0 | | | 680.0 | 22.8 | 27.0 | |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | 0.03 | 0.02 | 0.02 | 0.00 | 0.00 | | |
| Ar | mol % | 0.00 | 0.90 | 0.90 | 0.90 | 0.52 | 0.52 | 0.00 | 0.00 | | |
| H₂ | mol % | 25.57 | 0.00 | 0.00 | 0.00 | 0.00 | 0.00 | 0.00 | 0.00 | | |
| N₂ | mol % | 60.82 | 75.30 | 75.30 | 75.30 | 74.73 | 74.76 | 0.00 | 0.00 | | |
| NH₃ | mol % | 13.36 | 0.00 | 0.00 | 0.00 | 0.00 | 0.00 | 0.00 | 0.00 | | |
| O₂ | mol % | 0.00 | 20.21 | 20.21 | 20.21 | 1.00 | 0.87 | 0.00 | 0.00 | | |
| H₂O | mol % | 0.26 | 3.56 | 3.56 | 3.56 | 23.23 | 23.83 | 100.00 | 100.00 | | |
| NO | ppmv | 0 | 0 | 0 | 0 | 5019 | 1 | 0 | 0 | | |
| NO₂ | ppmv | 0 | 0 | 0 | 0 | 5 | 0 | 0 | 0 | | |
| N₂O | ppmv | 0 | 0 | 0 | 0 | 10 | 0 | 0 | 0 | | |
| Mass flow rate | kg/h | 35634 | 64664 | 64664 | 64664 | 100298 | 100631 | 27237 | 27237 | | |
| Molar flow rate | kmol/h | 1793 | 2263 | 2263 | 2263 | 3887 | 3911 | 1512 | 1512 | | |
| Temperature | ° C. | 26.3 | 44.3 | 224.4 | 439.8 | 929.4 | 169.5 | 130.5 | 230.0 | | |

Process variant #5:

| Process variant 5A | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | 0.00 |
| Ar | mol % | 0.00 | 0.00 | 0.00 | 0.00 | | | 0.00 | 0.00 | 0.00 | 0.00 |
| H₂ | mol % | 0.00 | 0.00 | 33.06 | 33.06 | | | 74.29 | 0.00 | 28.81 | 28.81 |
| N₂ | mol % | 0.00 | 0.00 | 11.02 | 11.02 | | | 24.76 | 0.00 | 68.55 | 68.55 |
| NH₃ | mol % | 99.81 | 99.81 | 55.77 | 55.77 | | | 0.86 | 99.81 | 2.37 | 2.37 |
| O₂ | mol % | 0.00 | 0.00 | 0.00 | 0.00 | | | 0.00 | 0.00 | 0.00 | 0.00 |
| H₂O | mol % | 0.19 | 0.19 | 0.15 | 0.15 | | | 0.10 | 0.19 | 0.26 | 0.26 |
| NO | ppmv | 0 | 0 | 0 | 0 | | | 0 | 0 | 0 | 0 |
| NO₂ | ppmv | 0 | 0 | 0 | 0 | | | 0 | 0 | 0 | 0 |
| N₂O | ppmv | 0 | 0 | 0 | 0 | | | 0 | 0 | 0 | 0 |
| Mass flow rate | kg/h | 38355 | 38355 | 38355 | 38355 | | | 38355 | 3279 | 32586 | 32586 |
| Molar flow rate | kmol/h | 2252 | 2252 | 2889 | 2889 | | | 4461 | 193 | 1610 | 1610 |
| Temperature | ° C. | 321.2 | 650.0 | 360.0 | 580.0 | | | 680.0 | 22.8 | 27.0 | 81.4 |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | 0.03 | 0.02 | 0.02 | 0.00 | 0.00 | 0.00 | 0.00 |
| Ar | mol % | 0.00 | 0.90 | 0.90 | 0.90 | 0.52 | 0.51 | 0.00 | 0.00 | 0.00 | 0.00 |
| H₂ | mol % | 25.74 | 0.00 | 0.00 | 0.00 | 0.00 | 0.00 | 0.00 | 0.00 | 0.00 | 0.00 |
| N₂ | mol % | 61.23 | 75.30 | 75.30 | 75.30 | 75.09 | 75.09 | 0.00 | 0.00 | 0.00 | 0.00 |
| NH₃ | mol % | 12.78 | 0.00 | 0.00 | 0.00 | 0.00 | 0.00 | 0.00 | 0.00 | 0.00 | 0.00 |
| O₂ | mol % | 0.00 | 20.21 | 20.21 | 20.21 | 1.00 | 0.99 | 0.00 | 0.00 | 0.00 | 0.00 |
| H₂O | mol % | 0.26 | 3.56 | 3.56 | 3.56 | 23.33 | 23.39 | 100.00 | 100.00 | 100.00 | 100.00 |
| NO | ppmv | 0 | 0 | 0 | 0 | 496 | 0 | 0 | 0 | 0 | 0 |
| NO₂ | ppmv | 0 | 0 | 0 | 0 | 5 | 0 | 0 | 0 | 0 | 0 |
| N₂O | ppmv | 0 | 0 | 0 | 0 | 10 | 0 | 0 | 0 | 0 | 0 |
| Mass flow rate | kg/h | 35865 | 62767 | 62767 | 62767 | 98632 | 98665 | 25350 | 25350 | 24736 | 24736 |
| Molar flow rate | kmol/h | 1803 | 2197 | 2197 | 2197 | 3825 | 3827 | 1407 | 1407 | 1373 | 1373 |
| Temperature | ° C. | 73.8 | 44.3 | 175.4 | 381.3 | 909.2 | 88.0 | 130.5 | 230.0 | 76.1 | 30.0 |

| Process variant 5B | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | 0.00 |
| Ar | mol % | 0.00 | 0.00 | 0.00 | 0.00 | | | 0.00 | 0.00 | 0.00 | 0.00 |
| H₂ | mol % | 0.00 | 0.00 | 33.06 | 33.06 | | | 74.29 | 0.00 | 28.81 | 28.81 |
| N₂ | mol % | 0.00 | 0.00 | 11.02 | 11.02 | | | 24.76 | 0.00 | 68.55 | 68.55 |
| NH₃ | mol % | 99.81 | 99.81 | 55.77 | 55.77 | | | 0.86 | 99.81 | 2.37 | 2.37 |
| O₂ | mol % | 0.00 | 0.00 | 0.00 | 0.00 | | | 0.00 | 0.00 | 0.00 | 0.00 |
| H₂O | mol % | 0.19 | 0.19 | 0.15 | 0.15 | | | 0.10 | 0.19 | 0.26 | 0.26 |
| NO | ppmv | 0 | 0 | 0 | 0 | | | 0 | 0 | 0 | 0 |
| NO₂ | ppmv | 0 | 0 | 0 | 0 | | | 0 | 0 | 0 | 0 |
| N₂O | ppmv | 0 | 0 | 0 | 0 | | | 0 | 0 | 0 | 0 |
| Mass flow rate | kg/h | 38296 | 38296 | 38296 | 38296 | | | 38296 | 3046 | 32536 | 32536 |
| Molar flow rate | kmol/h | 2248 | 2248 | 2884 | 2884 | | | 4455 | 179 | 1608 | 1608 |
| Temperature | ° C. | 339.1 | 650.0 | 360.0 | 580.0 | | | 680.0 | 22.8 | 27.0 | 81.5 |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | 0.03 | 0.02 | 0.02 | 0.00 | 0.00 | 0.00 | 0.00 |
| Ar | mol % | 0.00 | 0.90 | 0.90 | 0.90 | 0.52 | 0.51 | 0.00 | 0.00 | 0.00 | 0.00 |
| H₂ | mol % | 25.93 | 0.00 | 0.00 | 0.00 | 0.00 | 0.00 | 0.00 | 0.00 | 0.00 | 0.00 |
| N₂ | mol % | 61.69 | 75.30 | 75.30 | 75.30 | 75.02 | 75.05 | 0.00 | 0.00 | 0.00 | 0.00 |
| NH₃ | mol % | 12.13 | 0.00 | 0.00 | 0.00 | 0.00 | 0.00 | 0.00 | 0.00 | 0.00 | 0.00 |
| O₂ | mol % | 0.00 | 20.21 | 20.21 | 20.21 | 1.00 | 0.87 | 0.00 | 0.00 | 0.00 | 0.00 |
| H₂O | mol % | 0.26 | 3.56 | 3.56 | 3.56 | 22.95 | 23.55 | 100.00 | 100.00 | 100.00 | 100.00 |
| NO | ppmv | 0 | 0 | 0 | 0 | 5001 | 1 | 0 | 0 | 0 | 0 |
| NO₂ | ppmv | 0 | 0 | 0 | 0 | 5 | 0 | 0 | 0 | 0 | 0 |
| N₂O | ppmv | 0 | 0 | 0 | 0 | 10 | 0 | 0 | 0 | 0 | 0 |
| Mass flow rate | kg/h | 35582 | 62422 | 62422 | 62422 | 98004 | 98329 | 23982 | 23982 | 23407 | 23407 |
| Molar flow rate | kmol/h | 1787 | 2185 | 2185 | 2185 | 3794 | 3818 | 1331 | 1331 | 1299 | 1299 |
| Temperature | ° C. | 74.3 | 44.3 | 243.6 | 435.1 | 899.1 | 88.0 | 130.5 | 230.0 | 114.3 | 30.0 |

Process variant #6:

| Process variant 6A | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | 0.00 |
| Ar | mol % | 0.00 | 0.00 | 0.00 | 0.00 | | | 0.00 | 0.00 | 0.00 | 0.00 |
| H₂ | mol % | 0.00 | 0.00 | 33.06 | 33.06 | | | 74.29 | 0.00 | 28.81 | 28.81 |
| N₂ | mol % | 0.00 | 0.00 | 11.02 | 11.02 | | | 24.76 | 0.00 | 68.55 | 68.55 |
| NH₃ | mol % | 99.81 | 99.81 | 55.77 | 55.77 | | | 0.86 | 99.81 | 2.37 | 2.37 |
| O₂ | mol % | 0.00 | 0.00 | 0.00 | 0.00 | | | 0.00 | 0.00 | 0.00 | 0.00 |
| H₂O | mol % | 0.19 | 0.19 | 0.15 | 0.15 | | | 0.10 | 0.19 | 0.26 | 0.26 |
| NO | ppmv | 0 | 0 | 0 | 0 | | | 0 | 0 | 0 | 0 |
| NO₂ | ppmv | 0 | 0 | 0 | 0 | | | 0 | 0 | 0 | 0 |
| N₂O | ppmv | 0 | 0 | 0 | 0 | | | 0 | 0 | 0 | 0 |
| Mass flow rate | kg/h | 38749 | 38749 | 38749 | 38749 | | | 38749 | 2885 | 32921 | 32921 |
| Molar flow rate | kmol/h | 2275 | 2275 | 2918 | 2918 | | | 4507 | 169 | 1627 | 1627 |
| Temperature | ° C. | 371.9 | 650.0 | 360.0 | 580.0 | | | 680.0 | 22.8 | 27.0 | 113.2 |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | 0.03 | 0.02 | 0.02 | 0.00 | 0.00 | 0.00 | 0.00 |
| Ar | mol % | 0.00 | 0.90 | 0.90 | 0.90 | 0.51 | 0.51 | 0.00 | 0.00 | 0.00 | 0.00 |
| H₂ | mol % | 26.10 | 0.00 | 0.00 | 0.00 | 0.00 | 0.00 | 0.00 | 0.00 | 0.00 | 0.00 |
| N₂ | mol % | 62.09 | 75.30 | 75.30 | 75.30 | 75.38 | 75.38 | 0.00 | 0.00 | 0.00 | 0.00 |
| NH₃ | mol % | 11.56 | 0.00 | 0.00 | 0.00 | 0.00 | 0.00 | 0.00 | 0.00 | 0.00 | 0.00 |
| O₂ | mol % | 0.00 | 20.21 | 20.21 | 20.21 | 1.00 | 0.99 | 0.00 | 0.00 | 0.00 | 0.00 |
| H₂O | mol % | 0.26 | 3.56 | 3.56 | 3.56 | 23.04 | 23.11 | 100.00 | 100.00 | 100.00 | 100.00 |
| NO | ppmv | 0 | 0 | 0 | 0 | 508 | 0 | 0 | 0 | 0 | 0 |
| NO₂ | ppmv | 0 | 0 | 0 | 0 | 5 | 0 | 0 | 0 | 0 | 0 |
| N₂O | ppmv | 0 | 0 | 0 | 0 | 10 | 0 | 0 | 0 | 0 | 0 |
| Mass flow rate | kg/h | 35806 | 60561 | 60561 | 60561 | 96366 | 96399 | 21782 | 21782 | 21270 | 21270 |
| Molar flow rate | kmol/h | 1796 | 2119 | 2119 | 2119 | 3733 | 3736 | 1209 | 1209 | 1181 | 1181 |
| Temperature | ° C. | 102.7 | 44.3 | 196.0 | 374.6 | 878.9 | 88.0 | 130.5 | 230.0 | 76.8 | 30.0 |

| Process variant 6B | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | 0.00 |
| Ar | mol % | 0.00 | 0.00 | 0.00 | 0.00 | | | 0.00 | 0.00 | 0.00 | 0.00 |
| H₂ | mol % | 0.00 | 0.00 | 33.06 | 33.06 | | | 74.29 | 0.00 | 28.81 | 0.00 |
| N₂ | mol % | 0.00 | 0.00 | 11.02 | 11.02 | | | 24.76 | 0.00 | 68.55 | 0.00 |
| NH₃ | mol % | 99.81 | 99.81 | 55.77 | 55.77 | | | 0.86 | 99.81 | 2.37 | 0.00 |
| O₂ | mol % | 0.00 | 0.00 | 0.00 | 0.00 | | | 0.00 | 0.00 | 0.00 | 0.00 |
| H₂O | mol % | 0.19 | 0.19 | 0.15 | 0.15 | | | 0.10 | 0.19 | 0.26 | 0.00 |
| NO | ppmv | 0 | 0 | 0 | 0 | | | 0 | 0 | 0 | 0 |
| NO₂ | ppmv | 0 | 0 | 0 | 0 | | | 0 | 0 | 0 | 0 |
| N₂O | ppmv | 0 | 0 | 0 | 0 | | | 0 | 0 | 0 | 0 |
| Mass flow rate | kg/h | 38932 | 38932 | 38932 | 38932 | | | 38932 | 2423 | 33076 | 0 |
| Molar flow rate | kmol/h | 2286 | 2286 | 2932 | 2932 | | | 4528 | 142 | 1635 | 0 |
| Temperature | ° C. | 419.3 | 650.0 | 360.0 | 580.0 | | | 680.0 | 22.8 | 27.0 | 0.0 |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | 0.03 | 0.02 | 0.02 | 0.00 | 0.00 | 0.00 | 0.00 |
| Ar | mol % | 0.00 | 0.90 | 0.90 | 0.90 | 0.51 | 0.50 | 0.00 | 0.00 | 0.00 | 0.00 |
| H₂ | mol % | 26.51 | 0.00 | 0.00 | 0.00 | 0.00 | 0.00 | 0.00 | 0.00 | 0.00 | 0.00 |
| N₂ | mol % | 63.06 | 75.30 | 75.30 | 75.30 | 75.49 | 75.52 | 0.00 | 0.00 | 0.00 | 0.00 |
| NH₃ | mol % | 10.17 | 0.00 | 0.00 | 0.00 | 0.00 | 0.00 | 0.00 | 0.00 | 0.00 | 0.00 |
| O₂ | mol % | 0.00 | 20.21 | 20.21 | 20.21 | 1.00 | 0.87 | 0.00 | 0.00 | 0.00 | 0.00 |
| H₂O | mol % | 0.26 | 3.56 | 3.56 | 3.56 | 22.48 | 23.09 | 100.00 | 100.00 | 100.00 | 100.00 |
| NO | ppmv | 0 | 0 | 0 | 0 | 4998 | 0 | 0 | 0 | 0 | 0 |
| NO₂ | ppmv | 0 | 0 | 0 | 0 | 5 | 0 | 0 | 0 | 0 | 0 |
| N₂O | ppmv | 0 | 0 | 0 | 0 | 10 | 0 | 0 | 0 | 0 | 0 |
| Mass flow rate | kg/h | 35499 | 58902 | 58902 | 58902 | 94400 | 94712 | 18268 | 18268 | 17857 | 17857 |
| Molar flow rate | kmol/h | 1777 | 2061 | 2061 | 2061 | 3648 | 3671 | 1014 | 1014 | 991 | 991 |
| Temperature | ° C. | 153.3 | 44.3 | 310.6 | 457.6 | 878.6 | 120.5 | 130.5 | 230.0 | 81.4 | 30.0 |

Process variant #7:

| Process variant 7A | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | 0.00 |
| Ar | mol % | 0.00 | 0.00 | 0.00 | 0.00 | | | 0.00 | 0.00 | 0.00 | 0.00 |
| H₂ | mol % | 0.00 | 0.00 | 33.06 | 33.06 | | | 74.29 | 0.00 | 28.81 | 28.81 |
| N₂ | mol % | 0.00 | 0.00 | 11.02 | 11.02 | | | 24.76 | 0.00 | 68.55 | 68.55 |
| NH₃ | mol % | 99.81 | 99.81 | 55.77 | 55.77 | | | 0.86 | 99.81 | 2.37 | 2.37 |
| O₂ | mol % | 0.00 | 0.00 | 0.00 | 0.00 | | | 0.00 | 0.00 | 0.00 | 0.00 |
| H₂O | mol % | 0.19 | 0.19 | 0.15 | 0.15 | | | 0.10 | 0.19 | 0.26 | 0.26 |
| NO | ppmv | 0 | 0 | 0 | 0 | | | 0 | 0 | 0 | 0 |
| NO₂ | ppmv | 0 | 0 | 0 | 0 | | | 0 | 0 | 0 | 0 |
| N₂O | ppmv | 0 | 0 | 0 | 0 | | | 0 | 0 | 0 | 0 |
| Mass flow rate | kg/h | 38355 | 38355 | 38355 | 38355 | | | 38355 | 3279 | 32586 | 32586 |
| Molar flow rate | kmol/h | 2252 | 2252 | 2889 | 2889 | | | 4461 | 193 | 1610 | 1610 |
| Temperature | ° C. | 321.2 | 650.0 | 360.0 | 580.0 | | | 680.0 | 22.8 | 27.0 | 81.4 |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | 0.03 | 0.02 | 0.02 | 0.00 | 0.00 | 0.00 | 0.00 |
| Ar | mol % | 0.00 | 0.90 | 0.90 | 0.90 | 0.52 | 0.51 | 0.00 | 0.00 | 0.00 | 0.00 |
| H₂ | mol % | 25.74 | 0.00 | 0.00 | 0.00 | 0.00 | 0.00 | 0.00 | 0.00 | 0.00 | 0.00 |
| N₂ | mol % | 61.23 | 75.30 | 75.30 | 75.30 | 75.09 | 75.09 | 0.00 | 0.00 | 0.00 | 0.00 |
| NH₃ | mol % | 12.78 | 0.00 | 0.00 | 0.00 | 0.00 | 0.00 | 0.00 | 0.00 | 0.00 | 0.00 |
| O₂ | mol % | 0.00 | 20.21 | 20.21 | 20.21 | 1.00 | 0.99 | 0.00 | 0.00 | 0.00 | 0.00 |
| H₂O | mol % | 0.26 | 3.56 | 3.56 | 3.56 | 23.33 | 23.39 | 100.00 | 100.00 | 100.00 | 100.00 |
| NO | ppmv | 0 | 0 | 0 | 0 | 496 | 0 | 0 | 0 | 0 | 0 |
| NO₂ | ppmv | 0 | 0 | 0 | 0 | 5 | 0 | 0 | 0 | 0 | 0 |
| N₂O | ppmv | 0 | 0 | 0 | 0 | 10 | 0 | 0 | 0 | 0 | 0 |
| Mass flow rate | kg/h | 35865 | 62767 | 62767 | 62767 | 98632 | 98665 | 25350 | 25350 | 24736 | 24736 |
| Molar flow rate | kmol/h | 1803 | 2197 | 2197 | 2197 | 3825 | 3827 | 1407 | 1407 | 1373 | 1373 |
| Temperature | ° C. | 73.8 | 44.3 | 175.4 | 381.3 | 909.2 | 88.0 | 130.5 | 230.0 | 76.1 | 30.0 |

| Process variant 7B | | 1 | 2 | 3 | 4 | 5 | 6 | 7 | 8 | 9 | 10 |
|---|---|---|---|---|---|---|---|---|---|---|---|
| CO₂ | mol % | 0.00 | 0.00 | 0.00 | 0.00 | | | 0.00 | 0.00 | 0.00 | 0.00 |
| Ar | mol % | 0.00 | 0.00 | 0.00 | 0.00 | | | 0.00 | 0.00 | 0.00 | 0.00 |
| H₂ | mol % | 0.00 | 0.00 | 33.06 | 33.06 | | | 74.29 | 0.00 | 28.81 | 28.81 |
| N₂ | mol % | 0.00 | 0.00 | 11.02 | 11.02 | | | 24.76 | 0.00 | 68.55 | 68.55 |
| NH₃ | mol % | 99.81 | 99.81 | 55.77 | 55.77 | | | 0.86 | 99.81 | 2.37 | 2.37 |
| O₂ | mol % | 0.00 | 0.00 | 0.00 | 0.00 | | | 0.00 | 0.00 | 0.00 | 0.00 |
| H₂O | mol % | 0.19 | 0.19 | 0.15 | 0.15 | | | 0.10 | 0.19 | 0.26 | 0.26 |
| NO | ppmv | 0 | 0 | 0 | 0 | | | 0 | 0 | 0 | 0 |
| NO₂ | ppmv | 0 | 0 | 0 | 0 | | | 0 | 0 | 0 | 0 |
| N₂O | ppmv | 0 | 0 | 0 | 0 | | | 0 | 0 | 0 | 0 |
| Mass flow rate | kg/h | 38781 | 38781 | 38781 | 38781 | | | 38781 | 2569 | 32948 | 32948 |
| Molar flow rate | kmol/h | 2277 | 2277 | 2921 | 2921 | | | 4511 | 151 | 1628 | 1628 |
| Temperature | ° C. | 405.5 | 650.0 | 360.0 | 580.0 | | | 680.0 | 22.8 | 27.0 | 123.7 |

| | | 11 | 12 | 13 | 14 | 15 | 24 | 25 | 26 | 27 | 28 |
|---|---|---|---|---|---|---|---|---|---|---|---|
| CO₂ | mol % | 0.00 | 0.03 | 0.03 | 0.03 | 0.02 | 0.02 | 0.00 | 0.00 | 0.00 | 0.00 |
| Ar | mol % | 0.00 | 0.90 | 0.90 | 0.90 | 0.51 | 0.51 | 0.00 | 0.00 | 0.00 | 0.00 |
| H₂ | mol % | 26.37 | 0.00 | 0.00 | 0.00 | 0.00 | 0.00 | 0.00 | 0.00 | 0.00 | 0.00 |
| N₂ | mol % | 62.74 | 75.30 | 75.30 | 75.30 | 75.38 | 75.41 | 0.00 | 0.00 | 0.00 | 0.00 |
| NH₃ | mol % | 10.63 | 0.00 | 0.00 | 0.00 | 0.00 | 0.00 | 0.00 | 0.00 | 0.00 | 0.00 |
| O₂ | mol % | 0.00 | 20.21 | 20.21 | 20.21 | 1.00 | 0.87 | 0.00 | 0.00 | 0.00 | 0.00 |
| H₂O | mol % | 0.26 | 3.56 | 3.56 | 3.56 | 22.59 | 23.20 | 100.00 | 100.00 | 100.00 | 100.00 |
| NO | ppmv | 0 | 0 | 0 | 0 | 5034 | 1 | 0 | 0 | 0 | 0 |
| NO₂ | ppmv | 0 | 0 | 0 | 0 | 5 | 0 | 0 | 0 | 0 | 0 |
| N₂O | ppmv | 0 | 0 | 0 | 0 | 10 | 0 | 0 | 0 | 0 | 0 |
| Mass flow rate | kg/h | 35516 | 59731 | 59731 | 59731 | 95248 | 95565 | 27473 | 27473 | 26799 | 26799 |
| Molar flow rate | kmol/h | 1779 | 2090 | 2090 | 2090 | 3682 | 3705 | 1525 | 1525 | 1488 | 1488 |
| Temperature | ° C. | 113.0 | 44.3 | 217.4 | 440.6 | 868.7 | 88.9 | 130.5 | 230.0 | 72.5 | 30.0 |

Mass balances and temperature profiles are collated in the following table:

| | | | Temperature | | | | |
|---|---|---|---|---|---|---|---|
| | | | Offgas | DeNO_{X} | | H₂ | Heat |
| Process | | cNO_{X} | inlet | inlet | | yield | recovery |
| variant | | [ppmv] | [° C.] | [° C.] | Offgas | [%] | [%] |
| 1 | A | 500 | 870.0 | 643.9 | 310.2 | 74.8 | 71.6 |
| | B | 5000 | 870.2 | 646.5 | 366.4 | 73.9 | 64.4 |
| 2 | A | 500 | 919.7 | 429.3 | 200.9 | 76.4 | 86.4 |
| | B | 5000 | 919.6 | 429.0 | 225.8 | 76.1 | 83.4 |
| 3 | A | 500 | 1030.1 | 563.4 | 262.1 | 75.5 | 81.5 |
| | B | 5000 | 1030.1 | 563.0 | 286.1 | 75.2 | 79.0 |
| 4 | A | 500 | 929.4 | 425.3 | 143.8 | 77.2 | 93.4 |
| | B | 5000 | 929.4 | 425.1 | 169.5 | 76.9 | 90.3 |
| 5 | A | 500 | 909.2 | 420.2 | 88.0 | 77.8 | 100.0 |
| | B | 5000 | 899.1 | 420.5 | 88.0 | 77.7 | 100.0 |
| 6 | A | 500 | 878.9 | 413.3 | 88.0 | 78.6 | 100.0 |
| | B | 5000 | 878.6 | 443.4 | 120.5 | 79.0 | 95.9 |
| 7 | A | 500 | 909.2 | 420.2 | 88.0 | 77.8 | 100.0 |
| | B | 5000 | 868.7 | 425.7 | 88.9 | 78.7 | 99.9 |

By choice of suitable heat exchangers in the offgas duct in a suitable arrangement, it is possible in accordance with the invention to conduct the recovery of heat from the offgas duct up to the theoretical maximum of the dewpoint of water plus safety margin. Heat recovery and H₂ yield show a clear correlation. A highly integrated heat recovery system can increase the H₂ yield by more than 4%.

The flat temperature profile which allows significant thermal integration also reduces the required inlet temperature of the offgas into the offgas duct. This reduces surface temperatures in the upstream heat exchangers and allows the use of simpler materials.

### LIST OF REFERENCE SYMBOLS

(Q1) first offgas/NH₃ heat exchanger
(Q2) second offgas/NH₃ heat exchanger
(Q3) third offgas/NH₃ heat exchanger
(Q4) first offgas/combustion air heat exchanger
(Q5) first offgas/H₂O heat exchanger
(Q6) second exhaust/combustion air heat exchanger
(Q7) offgas/combustion gas heat exchanger
(Q8) second offgas/H₂O heat exchanger
(1) NH₃ decomposition device
(2) combustion device
(3) offgas duct
(4) offgas treatment system
(5) ventilator
(6) chimney
(7) pressure swing adsorption apparatus

What is claimed is:

1. A method of reducing the content of NO_{X} and N₂O in the offgas of an NH₃-operated firing system, the process comprising the following steps:
(a) combusting NH₃ to operate the firing system, preferably comprising a combustion device and an NH₃ decomposition device, for catalytic decomposition of NH₃ to N₂ and H₂, producing an offgas which comprises N₂, H₂O, NO_{X} and N₂O and which leaves the firing system;
(b) optionally and preferably cooling the offgas in at least one heat exchanger disposed downstream of the firing system in flow direction of the offgas;
(c) transferring the optionally cooled offgas into an offgas treatment system;
(d) reducing the N₂O content in the offgas by;
(d₁) decomposing N₂O over an N₂O decomposition catalyst, and/or
(d₂) chemically reducing N₂O with reducing agent over an N₂O reduction catalyst;
(e) reducing the NO_{X} content in the offgas by chemical reduction of NO_{X} with reducing agent over an NO_{X} reduction catalyst; and
(f) optionally and preferably cooling the offgas in at least one heat exchanger disposed downstream of the offgas treatment system in flow direction of the offgas.

2. The method as claimed in claim 1, for reducing the content of NO_{X} and N₂O in the offgas of an NH₃- and H₂-operated firing system integrated into a system for catalytic decomposition of NH₃ to N₂ and H₂, the method comprising the following steps:
(a) combusting NH₃ and H₂ for operation of the firing system, preferably in a combustion device, producing an offgas which comprises N₂, H₂O, NO_{X} and N₂O and leaves the firing system;
(b) optionally and preferably cooling the offgas in at least one heat exchanger disposed downstream of the firing system in flow direction of the offgas;
(c) transferring the optionally cooled offgas to an offgas treatment system disposed downstream of the firing system and, if appropriate, of the at least one heat exchanger in flow direction of the offgas;
(d) reducing the N₂O content in the offgas by:
(d₁) decomposing N₂O over an N₂O decomposition catalyst, and/or
(d₂) chemically reducing N₂O with reducing agent over an N₂O reduction catalyst;
(e) reducing the NO_{X} content in the offgas by chemical reduction of NO_{X} with reducing agent over an NO_{X} reduction catalyst; and
(f) optionally and preferably cooling the offgas in at least one heat exchanger disposed downstream of the offgas treatment system in flow direction of the offgas.

3. The method as claimed in claim 1, wherein the offgas is cooled in step (b) in the at least one heat exchanger by releasing heat from the offgas to a heat transfer medium, wherein the heat transfer medium used is preferably NH₃ which is then supplied to the catalytic decomposition in an NH₃ decomposition device over an NH₃ decomposition catalyst.

4.-7. (canceled)

8. The method as claimed in claim 1, wherein the N₂O decomposition catalyst and/or the N₂O reduction catalyst and/or the NO_{X} reduction catalyst independently comprise a zeolitic material; preferably a zeolite laden with transition metal (including lanthanide), in particular with iron, cobalt or copper; more preferably an iron-laden zeolite; even more preferably independently an iron-laden zeolite of the MFI, BEA, FER, MOR, FAU and/or MEL structure type.

9.-17. (canceled)

18. The method as claimed in claim 1, wherein the air ratio λ is in the range from 0.9 to 1.7, more preferably 1.0 to 1.6, even more preferably 1.1 to 1.5, most preferably 1.2 to 1.4.

19. The method as claimed in claim 1, wherein the firing system comprises a combustion device for combustion of NH₃ and an NH₃ decomposition device for cracking of NH₃ to N₂ and H₂.

20.-40. (canceled)

41. The method as claimed in claim 1, wherein the offgas on departure from the firing system, preferably the combustion device, has a degree of oxidation of NO_{X} of at least 10%, more preferably at least 20%, even more preferably at least 30%, most preferably at least 40%, and in particular at least 50%.

42.-62. (canceled)

63. The method as claimed in claim 1, wherein the offgas treatment system comprises a first catalyst bed and a spatially separated second catalyst bed;
wherein the first catalyst bed is disposed upstream of the second catalyst bed in flow direction of the offgas;
optionally wherein a first device with a first control valve for metered addition of NH₃ to the offgas is preferably disposed upstream of the first catalyst bed;
wherein downstream of the first catalyst bed and upstream of the second catalyst bed is disposed a second device with a second control valve for metered addition of NH₃ to the offgas, with which further NH₃ is metered into the offgas;
wherein both the first catalyst bed and the second catalyst bed each contain an iron-laden zeolite catalyst;
wherein:
(i) in the first catalyst bed
(d₁) the N₂O content in the offgas is reduced by catalytic decomposition of N₂O; and
(e) the NO_{X} content in the offgas is incompletely reduced by catalytic chemical reduction of NO_{X} with NH₃, where at least some of the NH₃ comes from an incomplete combustion of NH₃ in step (a) (NH₃ slip); and
(ii) in the second catalyst bed
(d₂) the residual N₂O content is reduced by catalytic chemical reduction of N₂O with NH₃;
(d1*) the residual N₂O content is optionally reduced by catalytic decomposition of N₂O; and
(e*) the residual NO_{X} content is reduced by catalytic chemical reduction of NO_{X} with NH₃.

64. The method as claimed in claim 63, wherein the catalytic decomposition of N₂O in the first catalyst bed is cocatalyzed by NO_{X} present in the offgas.

65. (canceled)

66. The method as claimed in claim 63, wherein additional NH₃ is metered into the offgas by means of the first device; preferably under feedback control; wherein a particular value for the concentration of NO_{X} on departure from the first catalyst bed is preferably defined as the target value (setpoint) and the actual concentration of NO_{X} on departure from the first catalyst bed is measured (actual value); and wherein, in the event of a difference between setpoint and actual value (control difference), the output of the first control valve is altered in order to minimize the difference.

67.-70. (canceled)

71. The method as claimed in claim 63, wherein the further NH₃ is metered in with the second device under feed-forward control; wherein the concentration of NO_{X} and of N₂O is preferably measured on departure from the first catalyst bed; the amount of offgas entering the second catalyst bed is taken into account to calculate the required amount of NH₃; and the calculated result (manipulated variable) is used to alter the output of the second control valve in order to meter in the required amount of NH₃.

72.-85. (canceled)

86. The method as claimed in claim 1, wherein the N₂O decomposition catalyst and/or the N₂O reduction catalyst and the NO_{X} reduction catalyst independently take the form of monolithic catalyst elements permeated by parallel channels, preferably in the form of monolithic honeycomb bodies.

87.-89. (canceled)

90. The method as claimed in claim 1, wherein the offgas is cooled in step (f) in a first offgas/H₂O heat exchanger disposed downstream of the offgas treatment system in flow direction of the offgas.

91. (canceled)

92. The method as claimed in claim 1, wherein the offgas is cooled in step (f)
in a first offgas/H₂O heat exchanger disposed downstream of the offgas treatment system in flow direction of the offgas, and
in a first offgas/combustion air heat exchanger, also disposed downstream of the offgas treatment system in flow direction of the offgas; preferably downstream of the first offgas/H₂O heat exchanger.

93.-100. (canceled)

101. An apparatus comprising:
(i) an NH₃-operated firing system, preferably comprising a combustion device for combustion of NH₃ and an NH₃ decomposition device for cracking of NH₃ to N₂ and H₂; and
(ii) an offgas treatment system;
wherein the apparatus is configured for performance of the method as claimed in any of the preceding claims.
